(19) United States
(12) Patent Application Publication
(10) Pub. No.: US 2025/0377777 A1
(43) Pub. Date: Dec. 11, 2025

(54) DEVICES, METHODS, AND GRAPHICAL USER INTERFACES FOR THREE-DIMENSIONAL OBJECT MANIPULATION IN AN EXTENDED REALITY ENVIRONMENT

(71) Applicant: Apple Inc., Cupertino, CA (US)

(72) Inventors: Alexander T. WING, Fremont, CA (US); Jonathan RAVASZ, Sunnyvale, CA (US); Alexis H. PALANGIE, Palo Alto, CA (US); Yiyao NIE, Santa Clara, CA (US); Mark A. EBBOLE, San Francisco, CA (US); Christopher D. MCKENZIE, Burlingame, CA (US)

(21) Appl. No.: 19/222,736

(22) Filed: May 29, 2025

Related U.S. Application Data
(60) Provisional application No. 63/657,969, filed on Jun. 9, 2024.

(51) Int. Cl. G06F 3/0485; G06F 3/04815

(52) U.S. Cl. CPC G06F 3/0485; G06F 3/04815

(57) ABSTRACT

Some examples are directed to systems and methods for applying magnitude of object movement based on magnitude of input movement directed to virtual objects based on movement characteristics of input elements and of virtual objects. Some examples are directed to systems and methods for selectively applying translational movements and rotational movements to virtual objects corresponding to inputs directed thereto, based on: gating strategy, type of virtual object, and/or detected movements input elements after detection of inputs. Some examples are directed to systems and methods for selectively applying translational movements and rotational movements to virtual objects corresponding to inputs received from input elements based on: gating strategy, virtual object type, and/or detected movements of input elements after detecting inputs. Some examples are directed to systems and methods for disambiguating selection operations from scroll operations based on movement characteristics of input elements prior to and/or after detecting selection inputs with input elements.

### CROSS REFERENCE TO RELATED APPLICATIONS

This application claims the benefit of U.S. Provisional Application No. 63/657,969, filed Jun. 9, 2024, the content of which is herein incorporated by reference in its entirety for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system applies a magnitude of object movement corresponding to the magnitude of input movement of an input element following detection of an input directed to a virtual object, where the mapping of the input magnitude to the object movement is based on movement characteristics of the input element, and/or characteristics of the virtual object.

In some embodiments, a computer system selectively applies translational movements and rotational movements to a virtual object corresponding to an input received from an input element directed to the virtual object, where the application and/or magnitude of the movements to the virtual object are dependent upon a gating strategy, the type of virtual object, and/or detected movements of the input element after the detection of the input.

In some embodiments, a computer system resizes virtual objects corresponding to an input received from an input element directed to the virtual object, wherein the manner of resizing is dependent upon the type of input element, the direction in which the input element is detected as moving following detection of the input, and/or the attention of the user.

In some embodiments, a computer system disambiguates a selection input provided by an input element to either perform a selection operation on a selectable object or a scroll operation on a user interface based on movement characteristics of the input element prior to and/or after the selection input is detected.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIG. 7 illustrates a flow diagram illustrating a method in which a computer system applies a magnitude of object movement corresponding to the magnitude of input movement of an input element following detection of an input directed to a virtual object, where the mapping of the input magnitude to the object movement is based on movement characteristics of the input element, and/or characteristics of the virtual object in accordance with some embodiments of the disclosure.

FIGS. 8A-8Y illustrates exemplary ways in which a computer system selectively applies translational movements and rotational movements to a virtual object corresponding to an input received from an input element directed to the virtual object, where the application and/or magnitude of the movements to the virtual object are dependent upon a gating strategy, the type of virtual object, and/or detected movements of the input element after the detection of the input in accordance with some embodiments of the disclosure.

FIG. 9 illustrates a flow diagram illustrating a method in which a computer system selectively applies translational movements and rotational movements to a virtual object corresponding to an input received from an input element directed to the virtual object, where the application and/or magnitude of the movements to the virtual object are dependent upon a gating strategy, the type of virtual object, and/or detected movements of the input element after the detection of the input in accordance with some embodiments of the disclosure.

FIGS. 10A-10W illustrate exemplary ways in which a computer system resizes virtual objects corresponding to an input received from an input element directed to the virtual object, wherein the manner of resizing is dependent upon the type of input element, the direction in which the input element is detected as moving following detection of the input, and/or the attention of the user in accordance with some embodiments of the disclosure.

FIG. 11 illustrates a flow diagram illustrating a method in which a computer system resizes virtual objects corresponding to an input received from an input element directed to the virtual object, wherein the manner of resizing is dependent upon the type of input element, the direction in which the input element is detected as moving following detection of the input, and/or the attention of the user in accordance with some embodiments of the disclosure.

FIGS. 12A-12AA illustrate exemplary ways in which a computer system disambiguates selection operations and scroll operations based on movement characteristics of an input element prior to and/or after a selection input is performed in accordance with some embodiments of the disclosure.

FIG. 13 illustrates a flow diagram illustrating a method in which a computer system disambiguates selection operations and scroll operations based on movement characteristics of an input element prior to and/or after a selection input is performed in accordance with some embodiments of the disclosure.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system applies a magnitude of object movement corresponding to the magnitude of input movement of an input element following detection of an input directed to a virtual object, the mapping of the input magnitude to the object movement is based on movement characteristics of the input element, and/or characteristics of the virtual object in accordance with some embodiments of the disclosure.

In some embodiments, a computer system selectively applies translational movements and rotational movements to a virtual object corresponding to an input received from an input element directed to the virtual object, where the application and/or magnitude of the movements to the virtual object are dependent upon a gating strategy, the type of virtual object, and/or detected movements of the input element after the detection of the input in accordance with some embodiments of the disclosure.

In some embodiments, a computer system resizes virtual objects corresponding to an input received from an input element directed to the virtual object, wherein the manner of resizing is dependent upon the type of input element, the direction in which the input element is detected as moving following detection of the input, and/or the attention of the user in accordance with some embodiments of the disclosure.

In some embodiments, a computer system disambiguates selection operations and scroll operations based on movement characteristics of an input element prior to and/or after a selection input is performed in accordance with some embodiments of the disclosure.

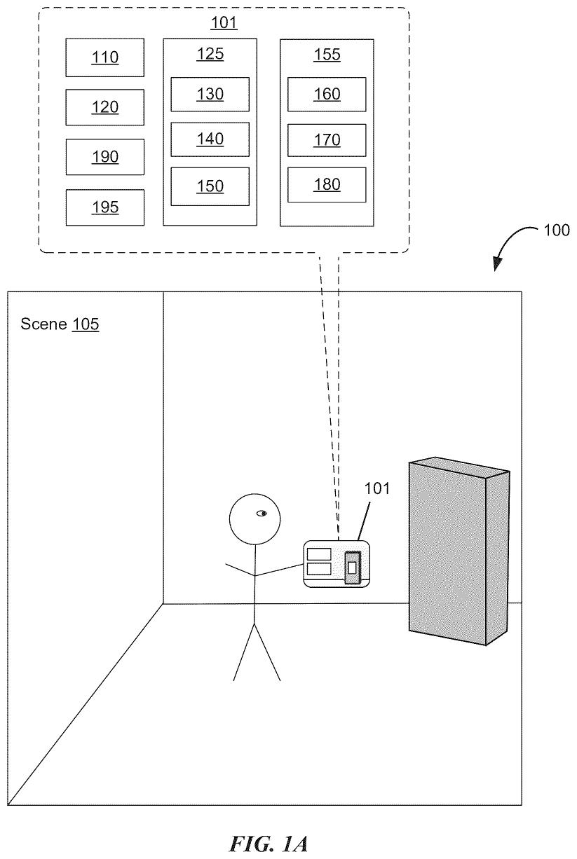

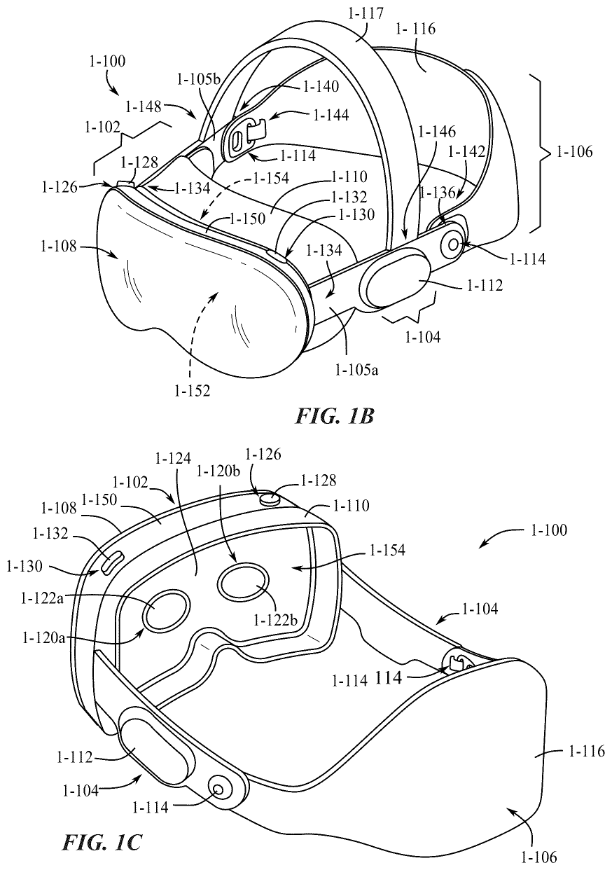

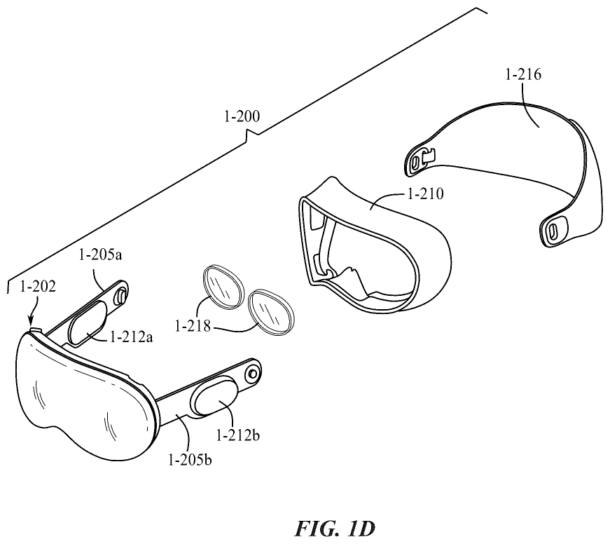

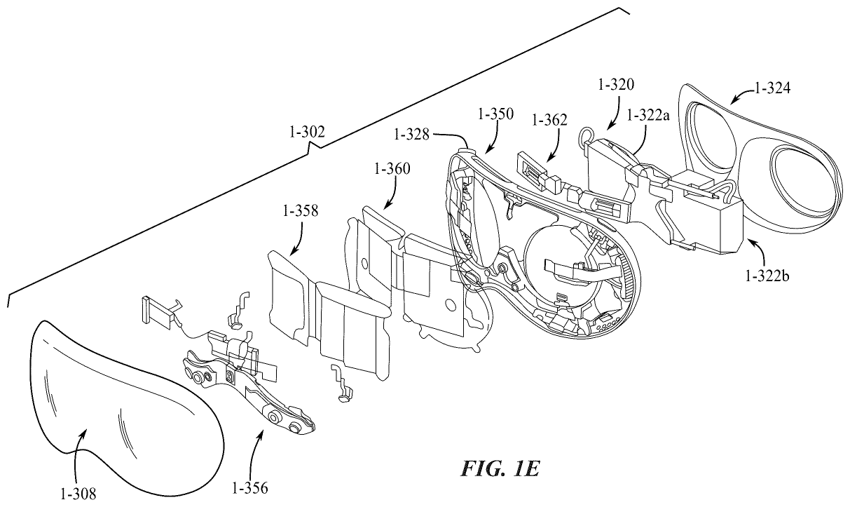

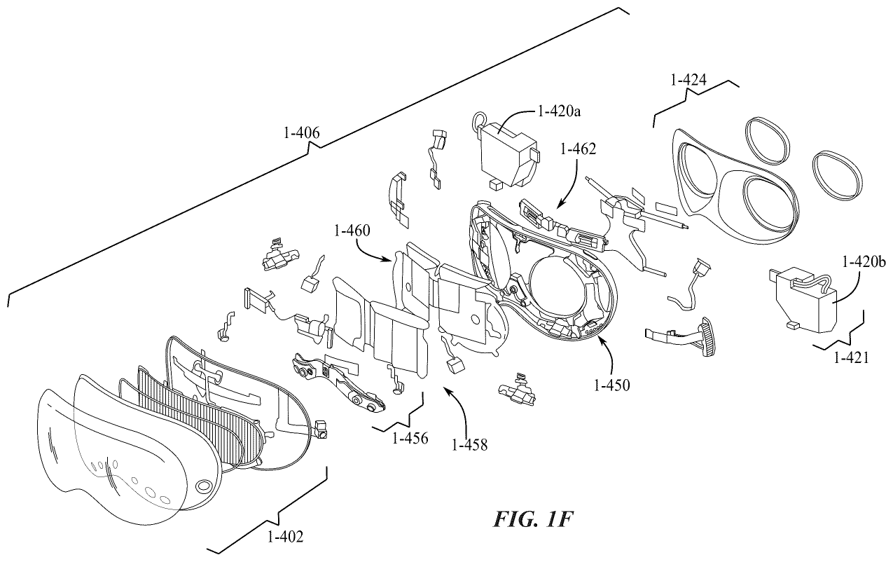

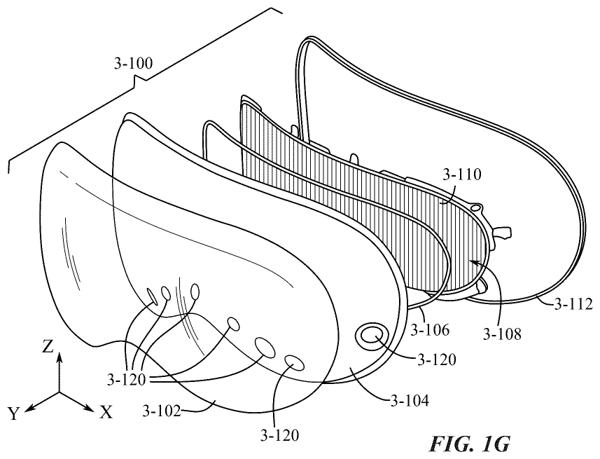

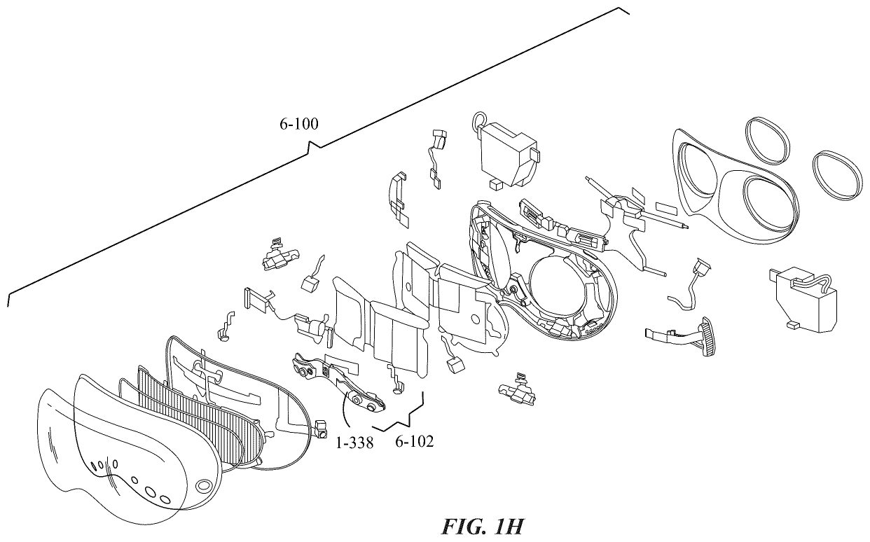

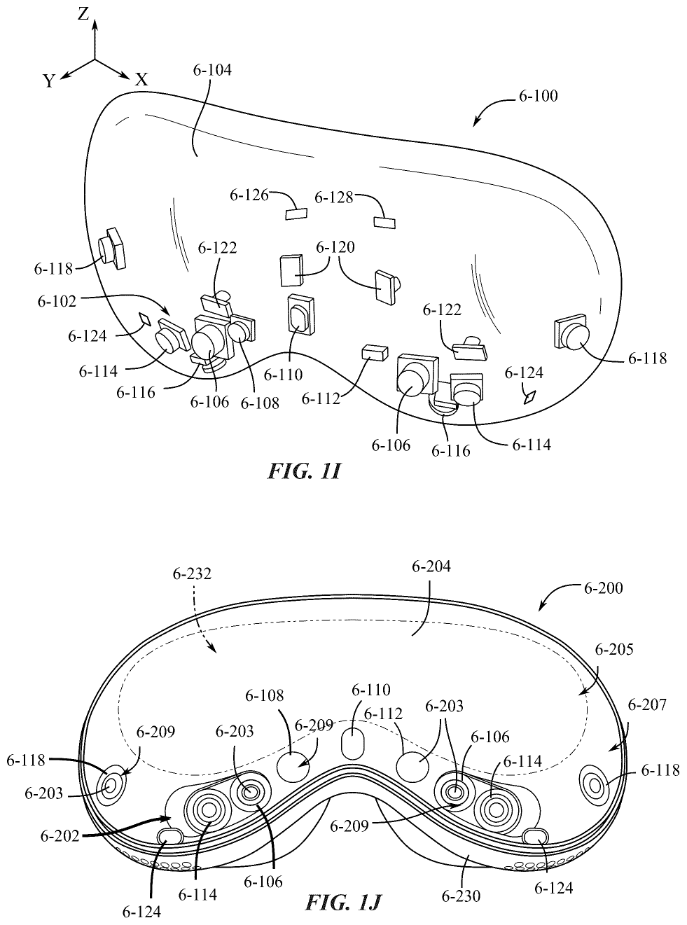

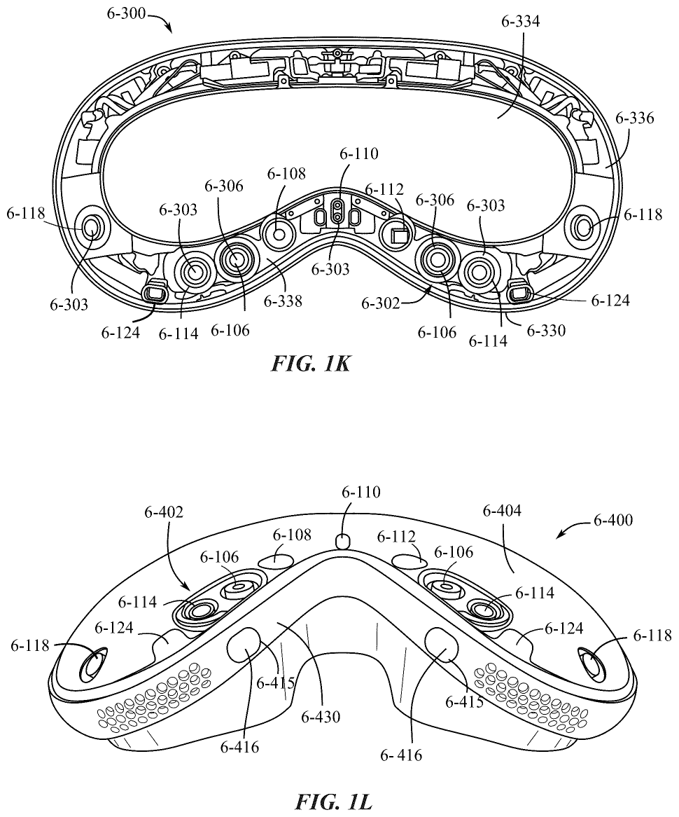

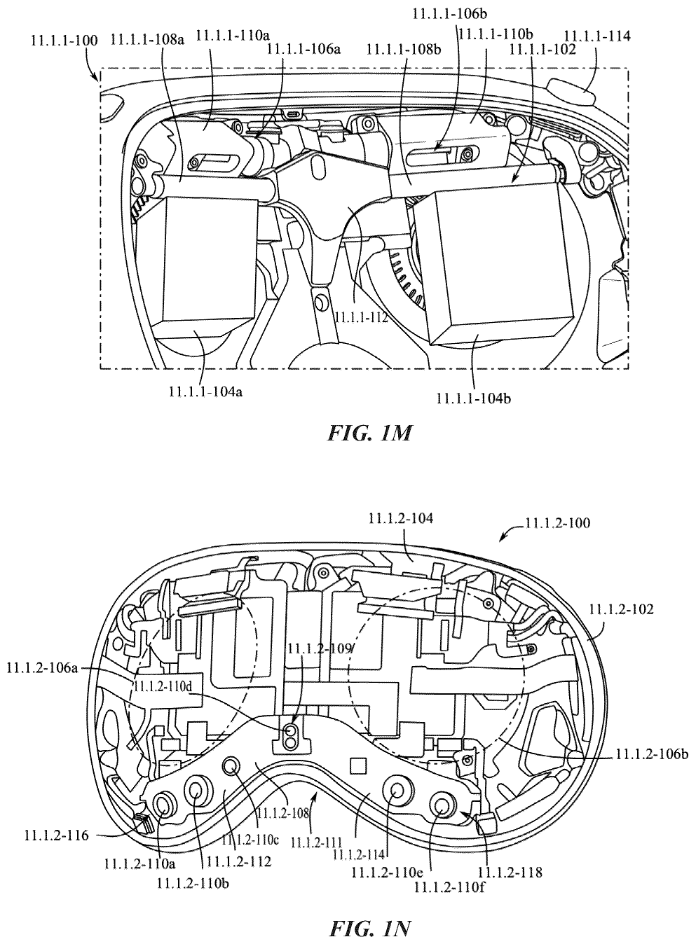

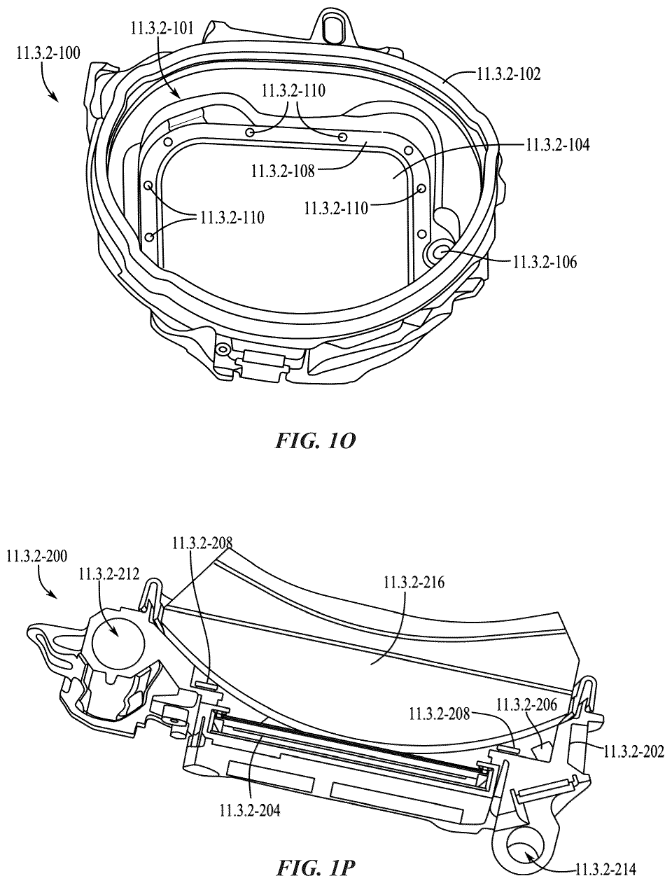

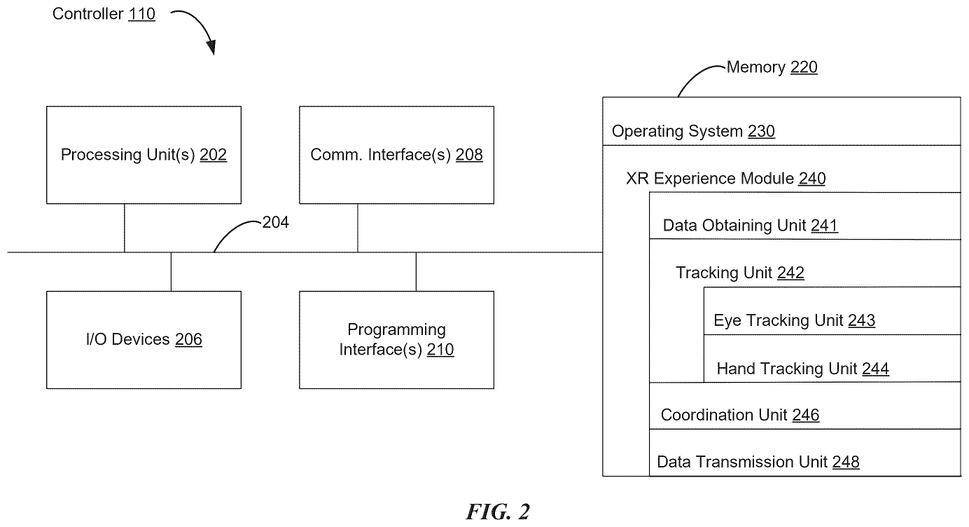

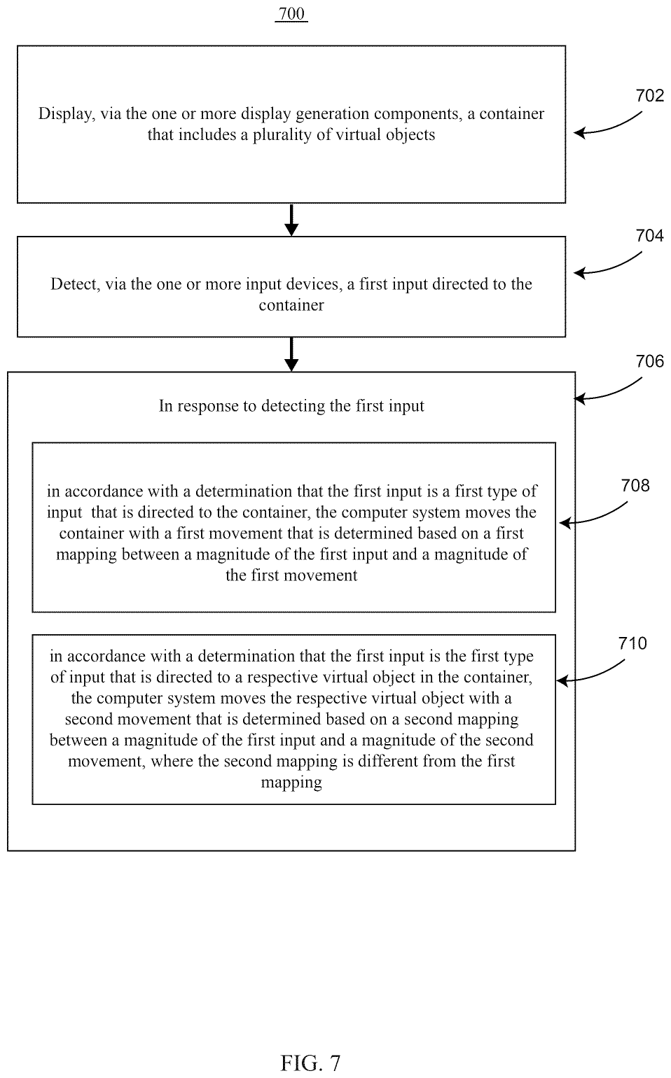

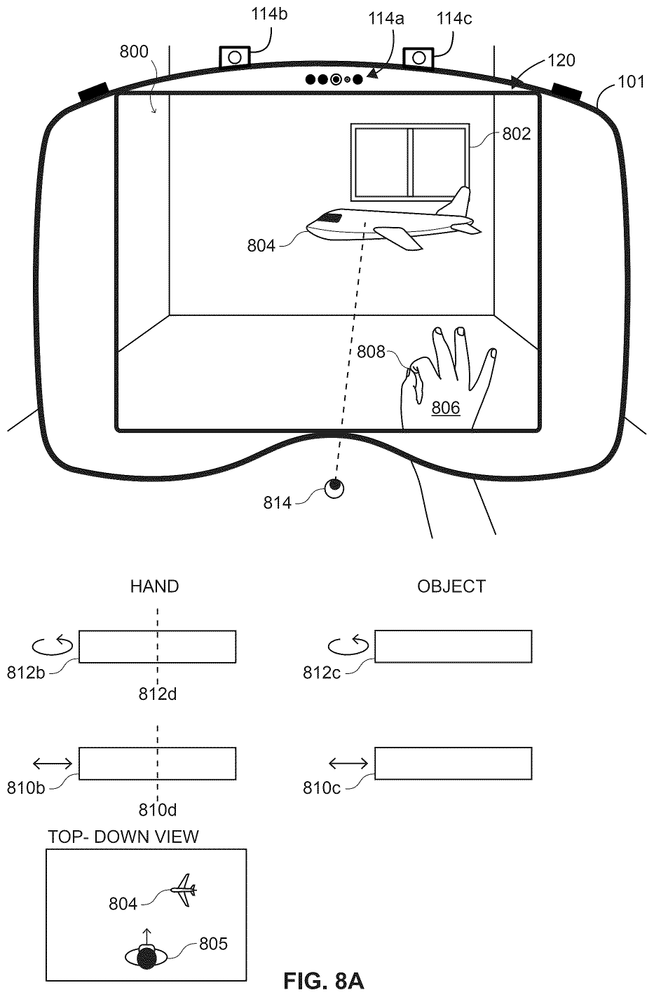

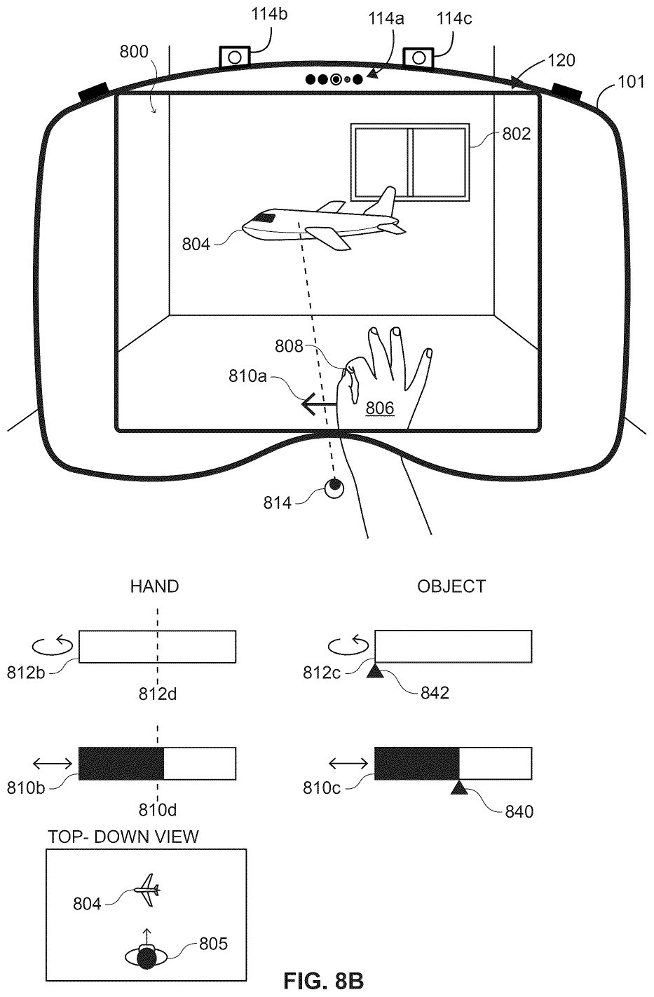

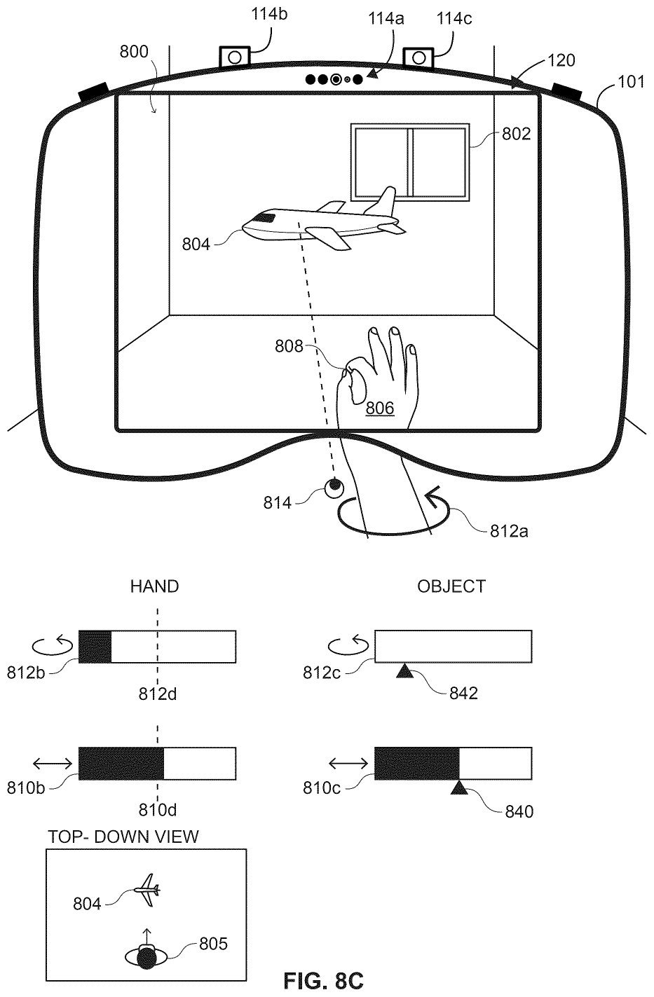

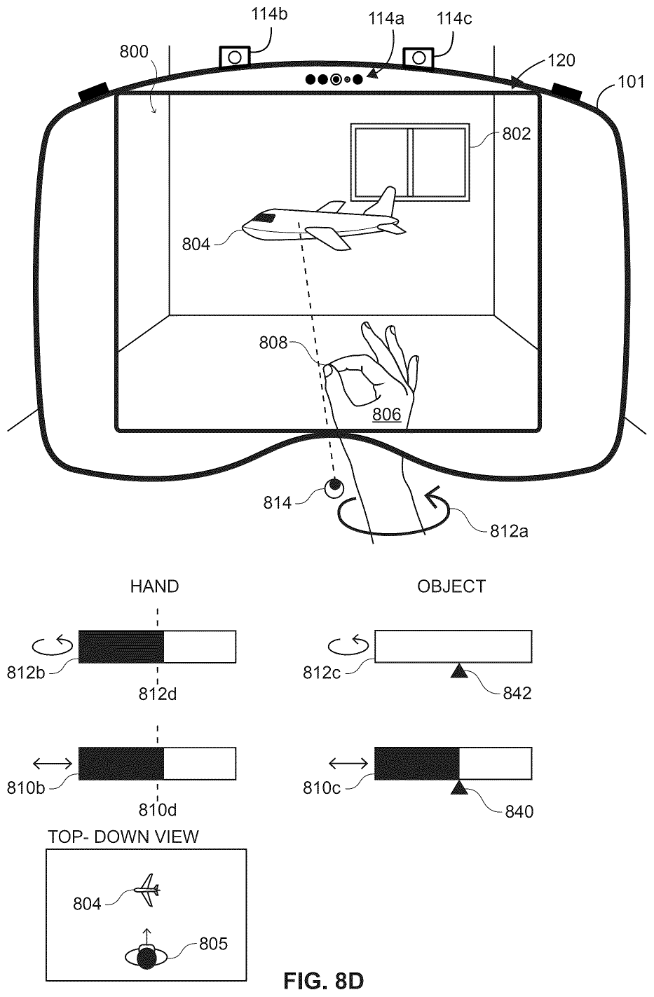

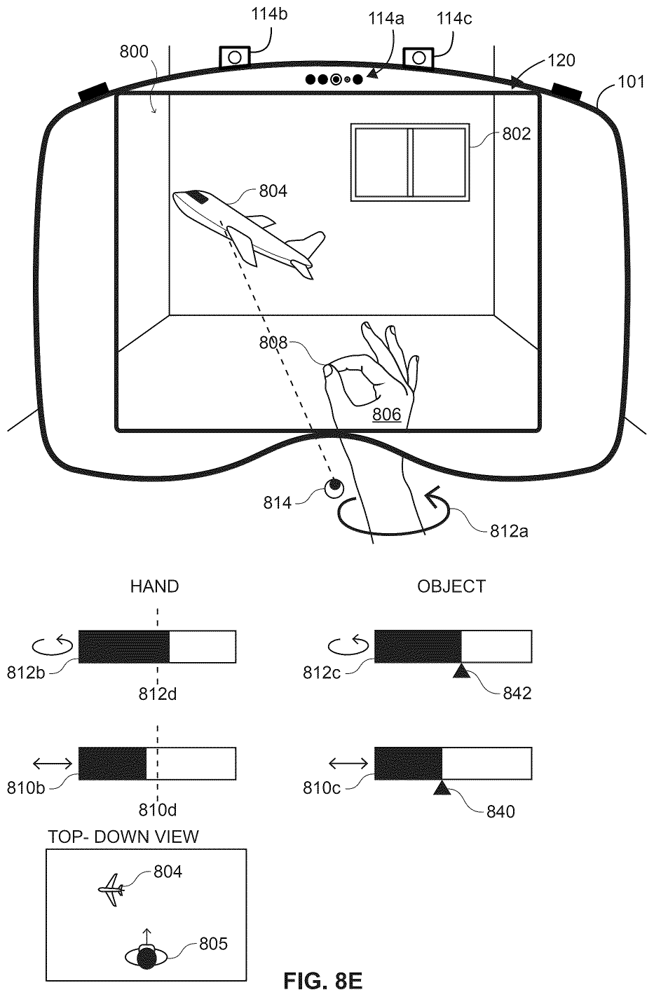

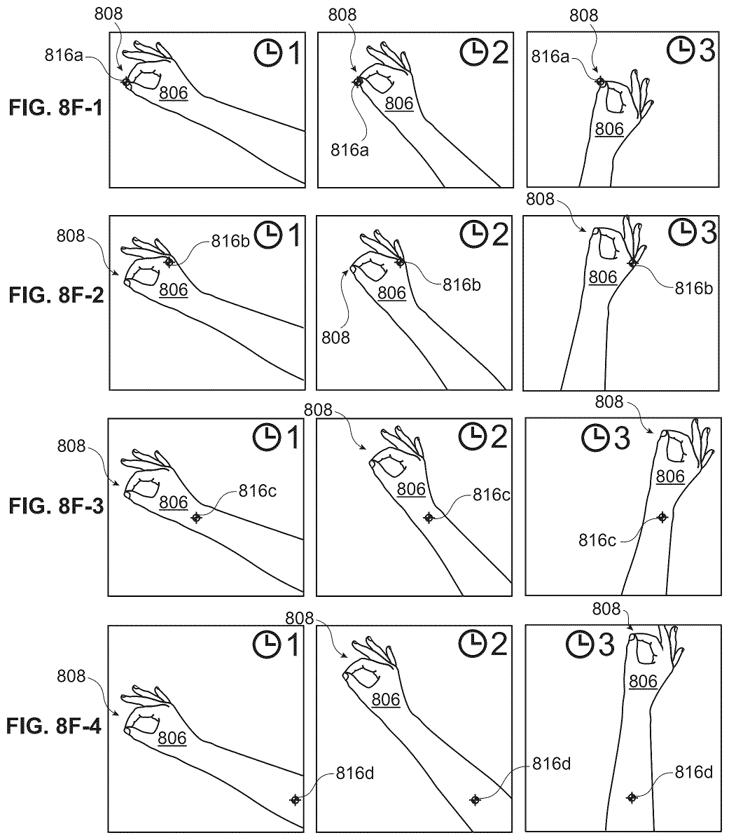

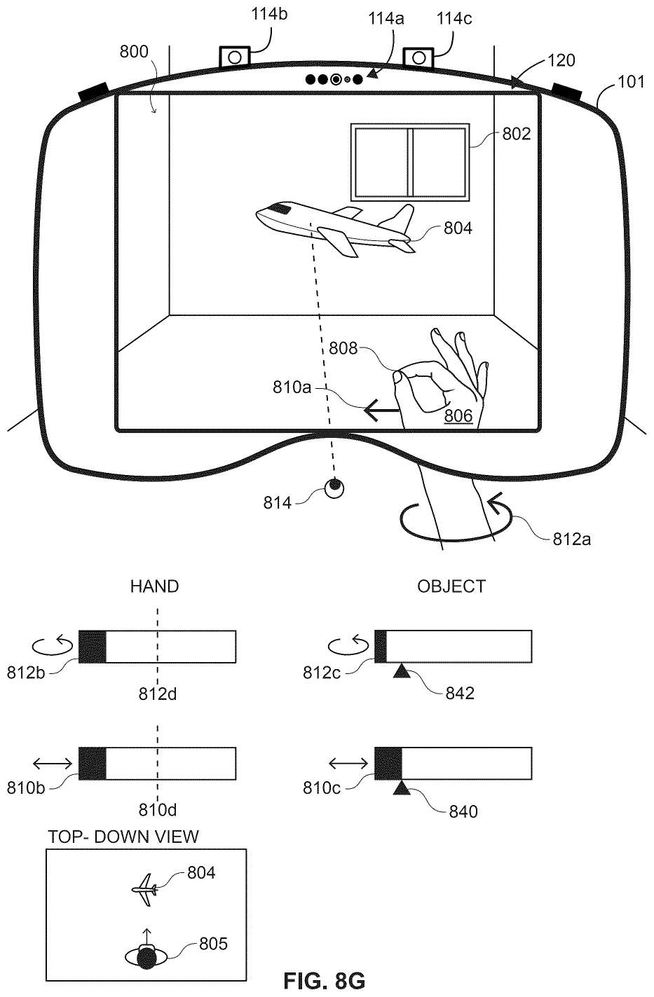

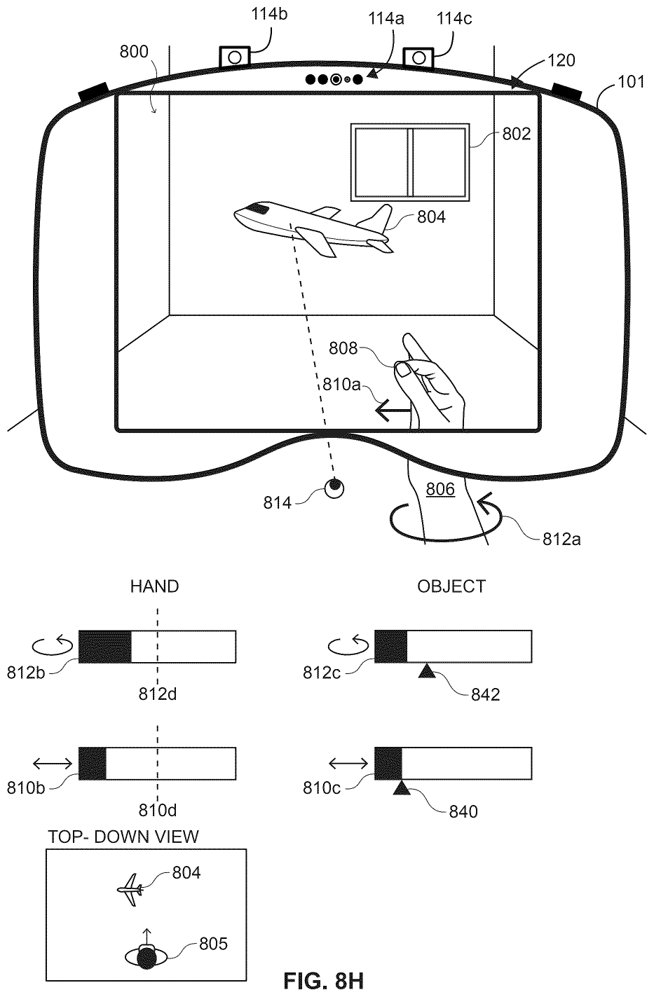

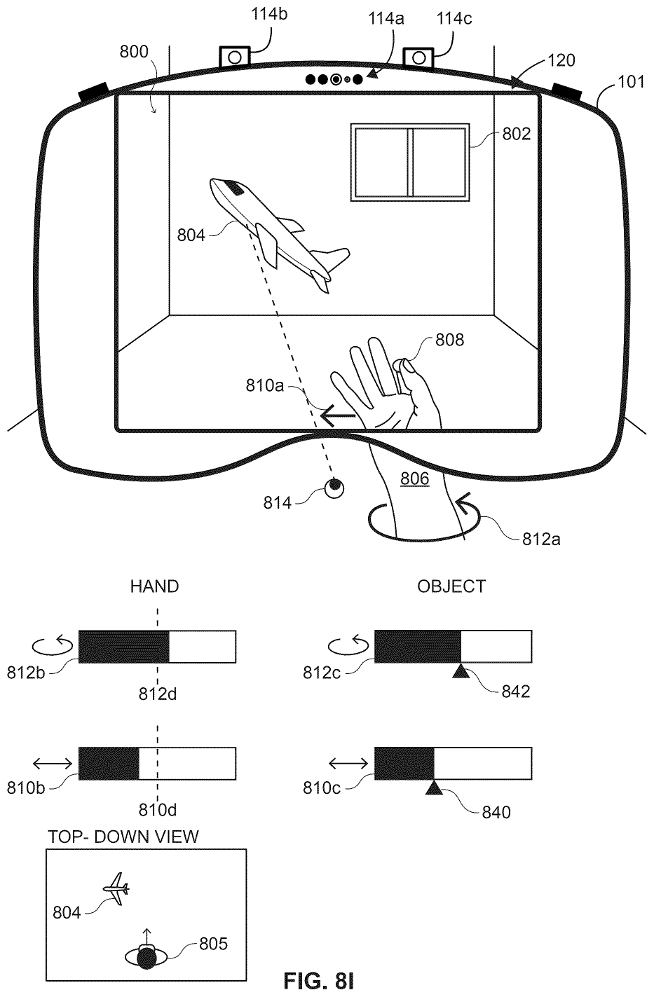

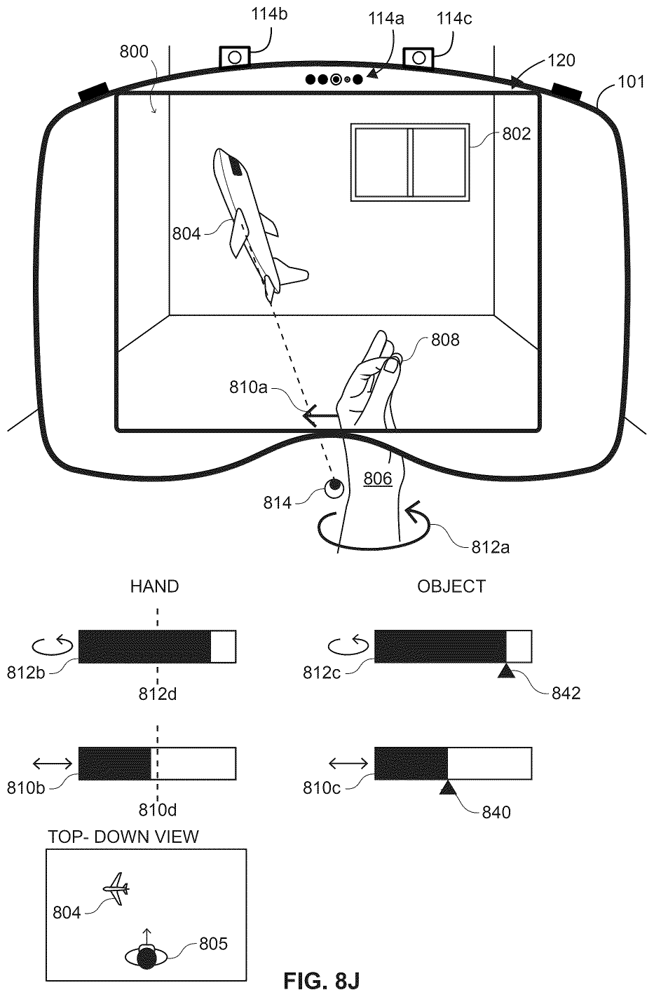

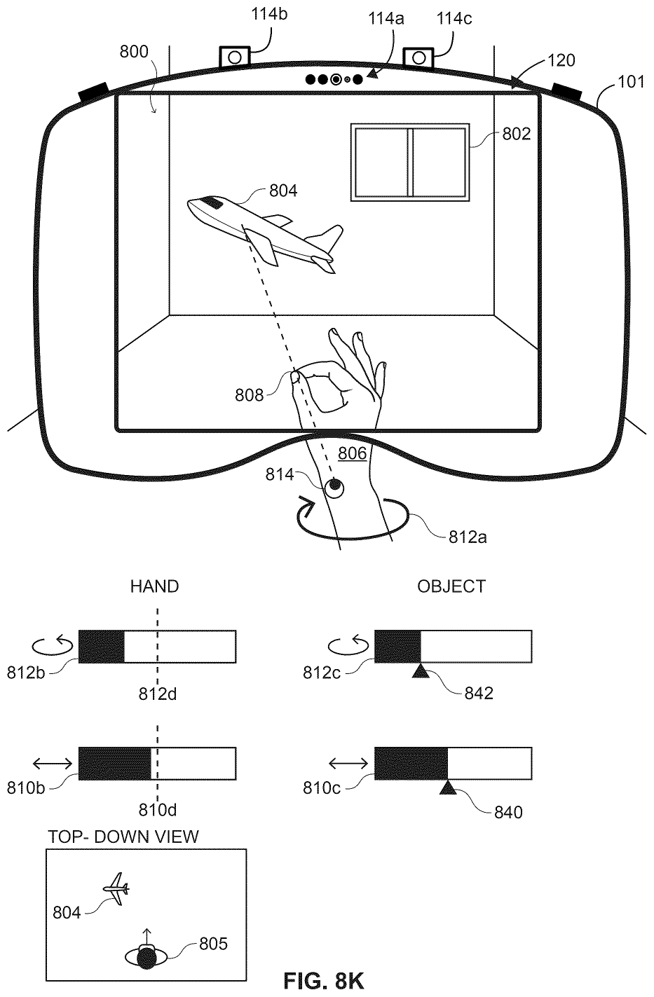

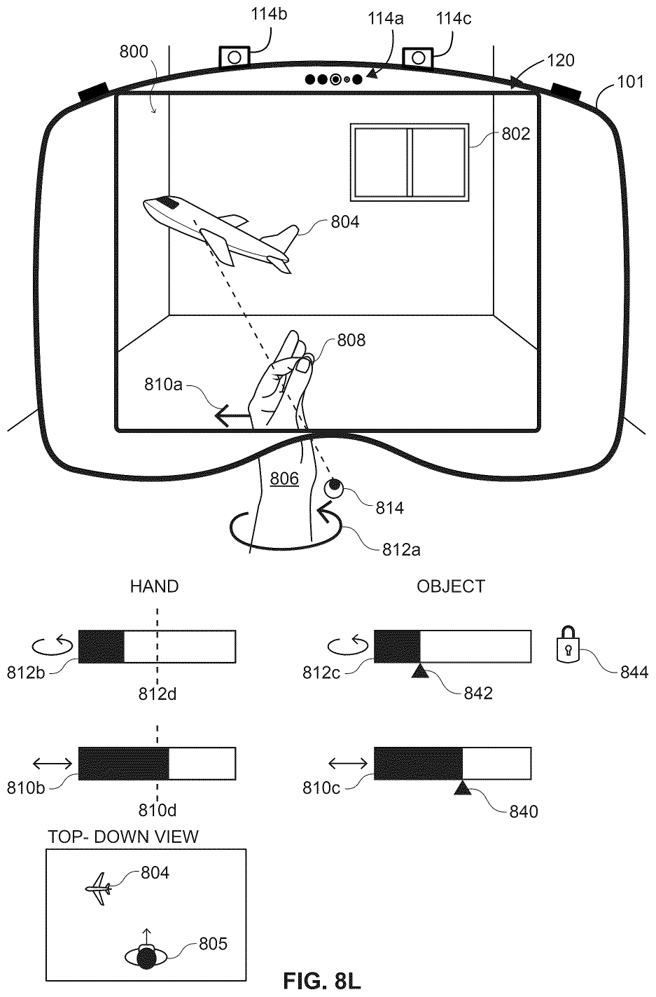

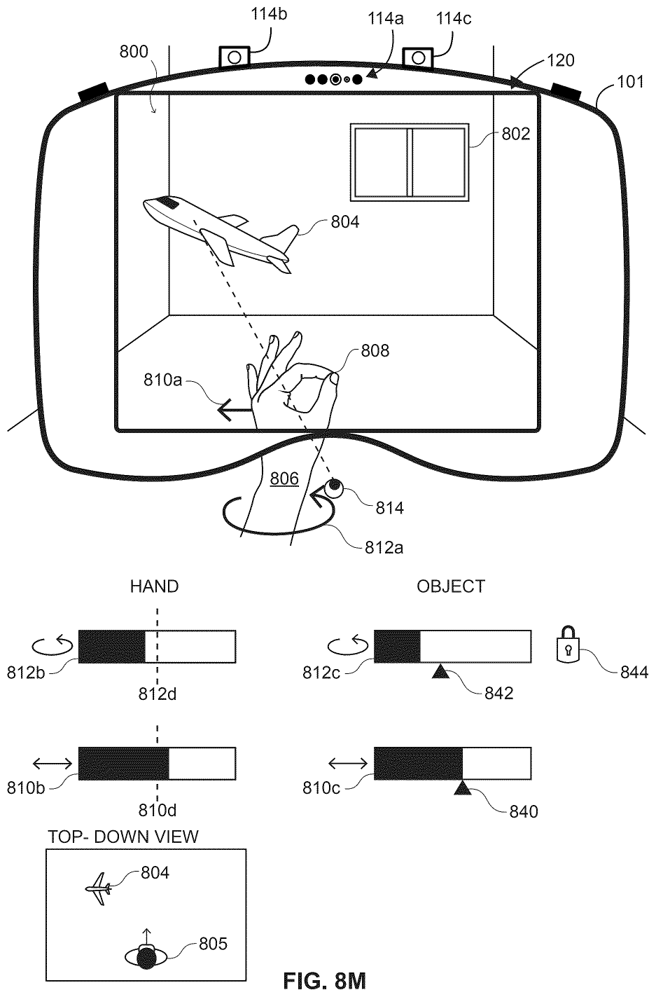

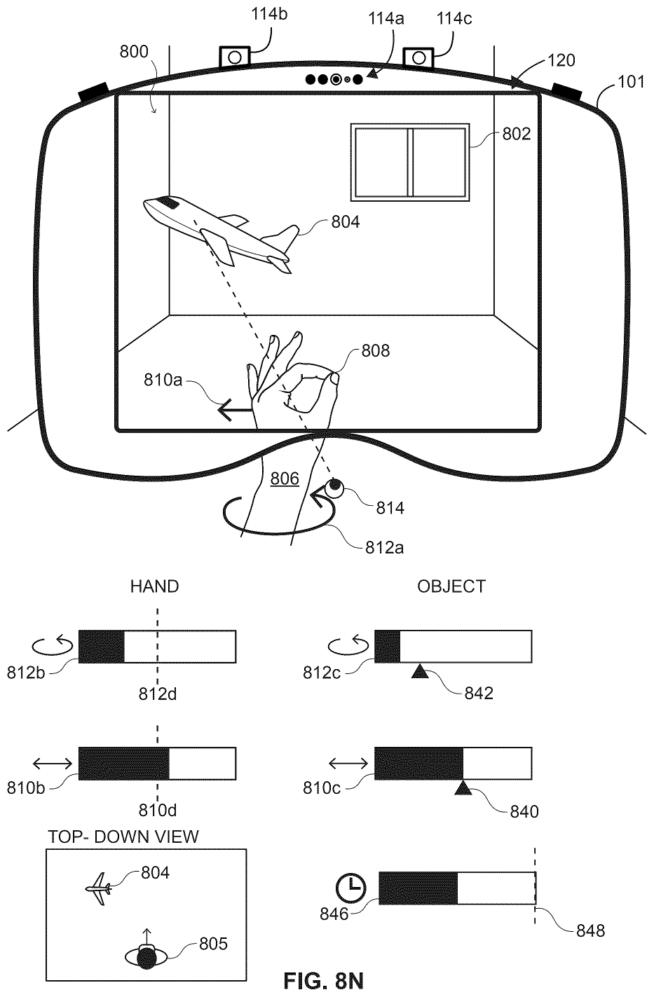

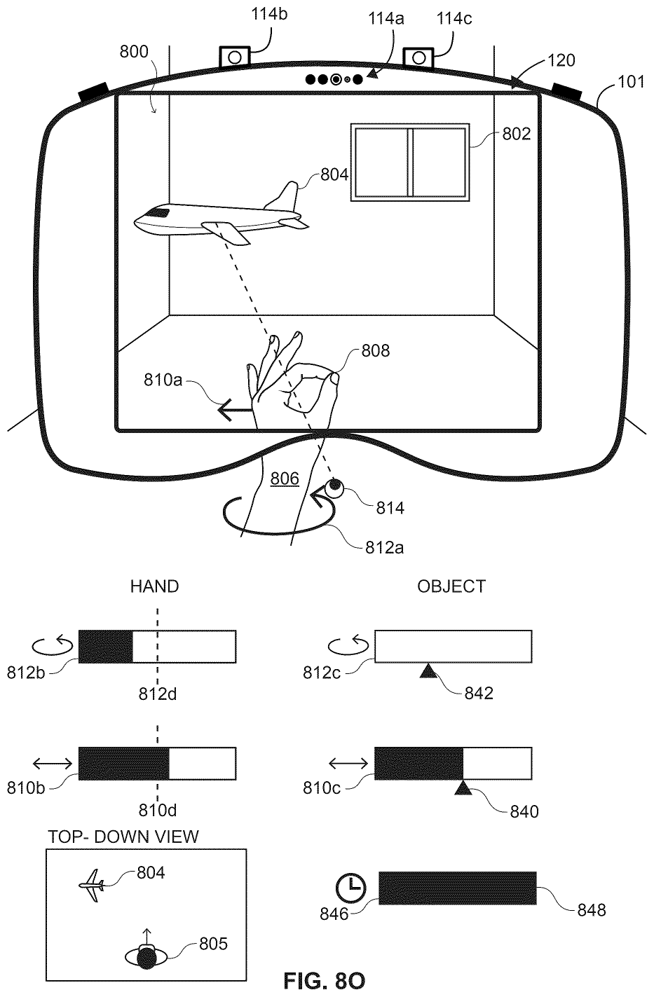

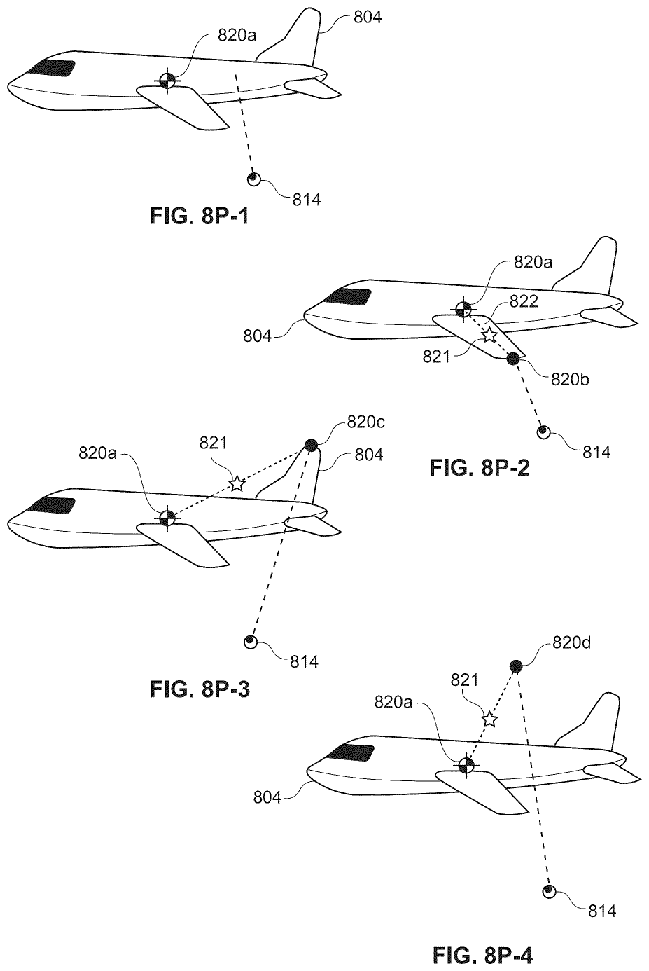

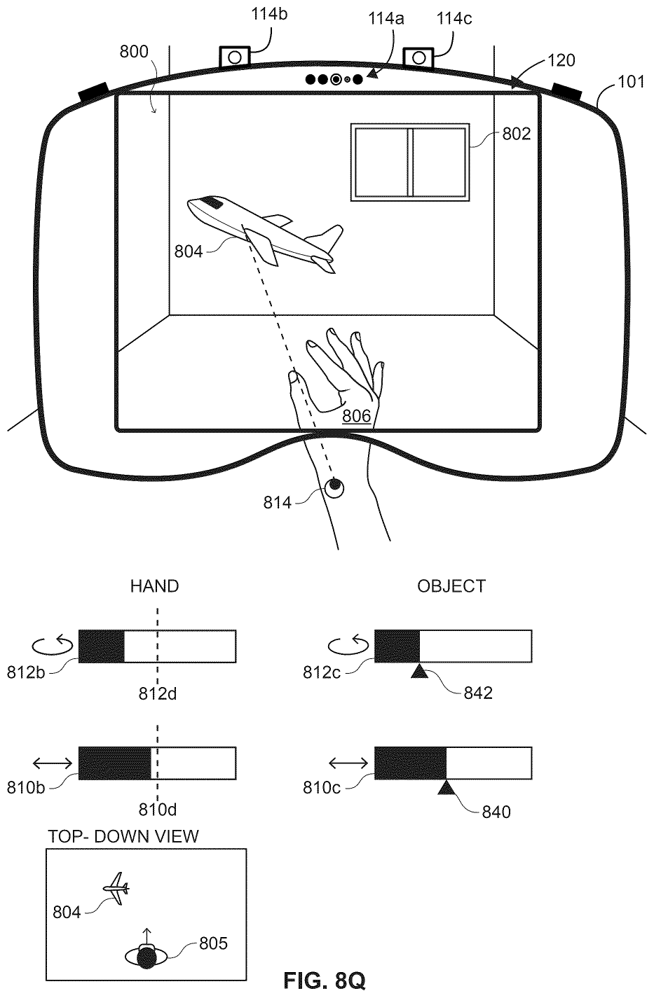

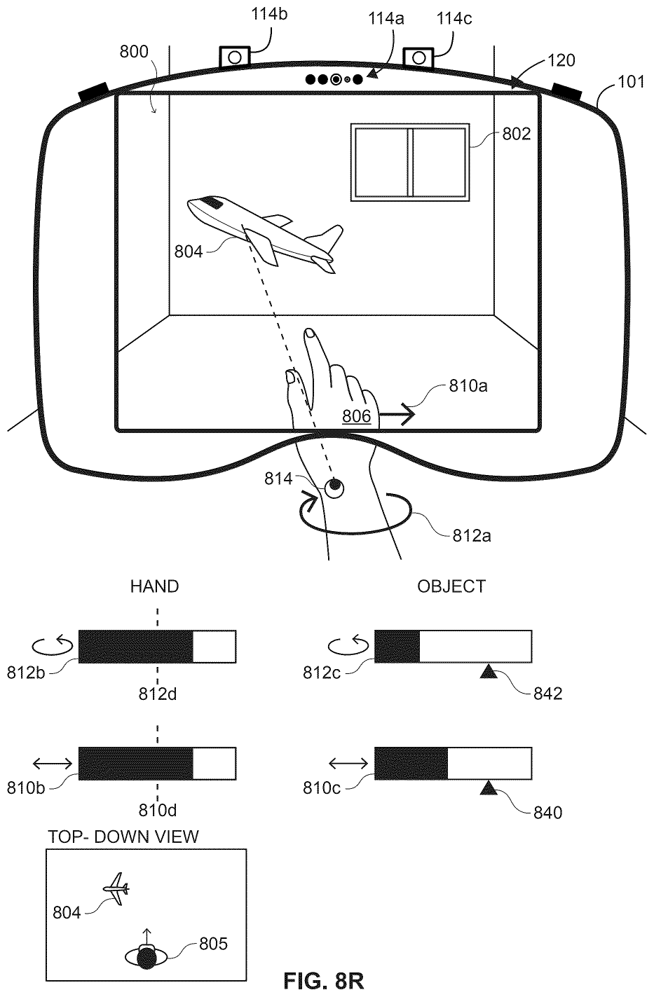

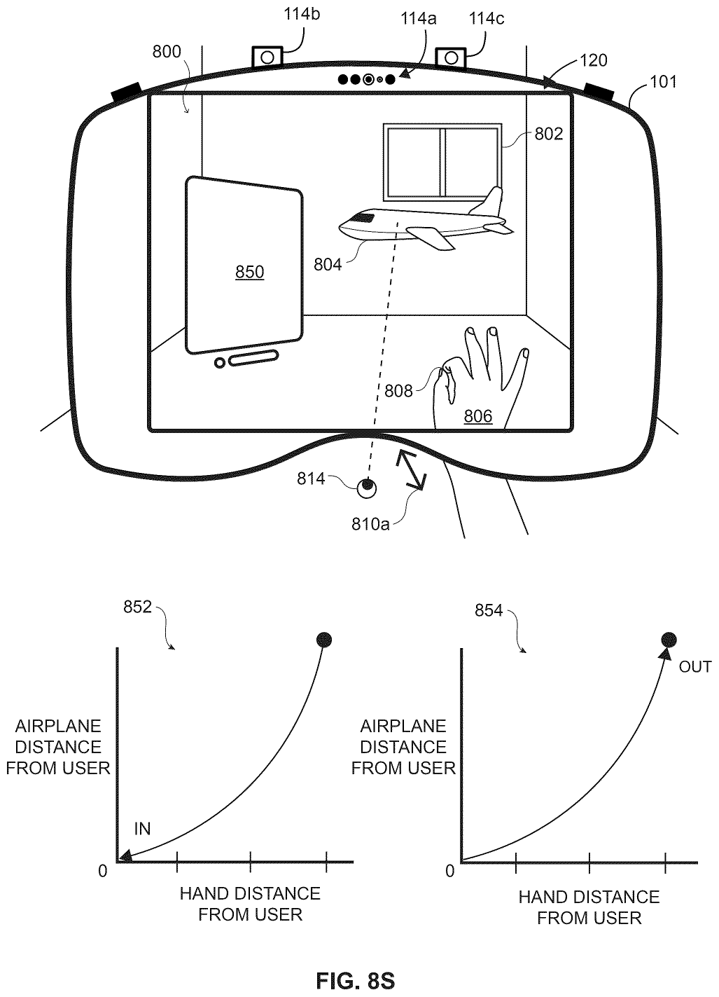

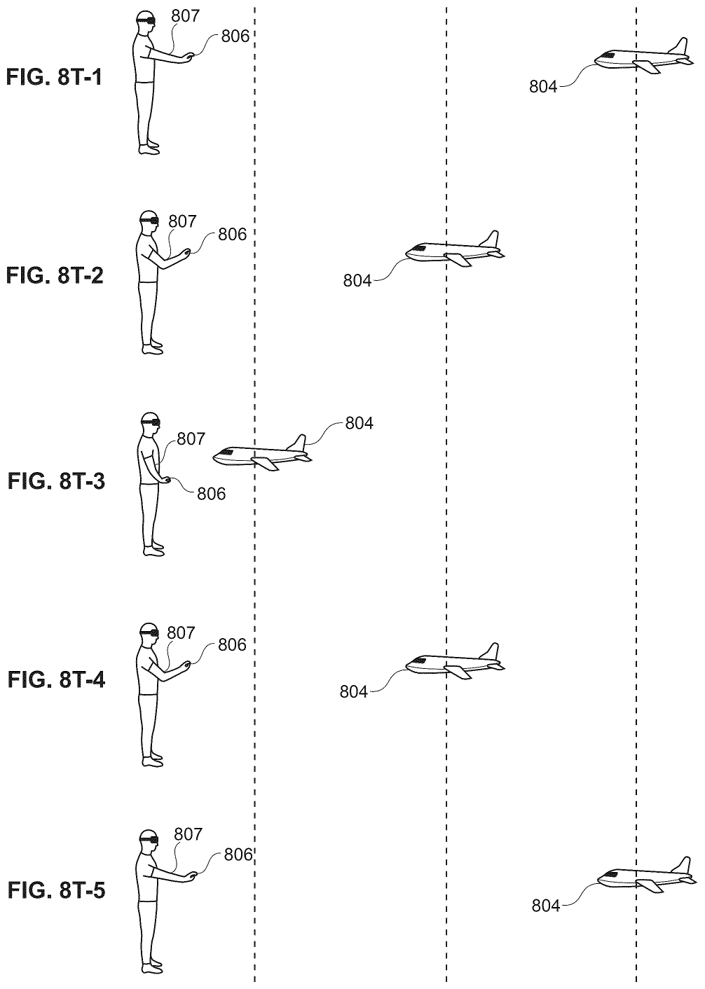

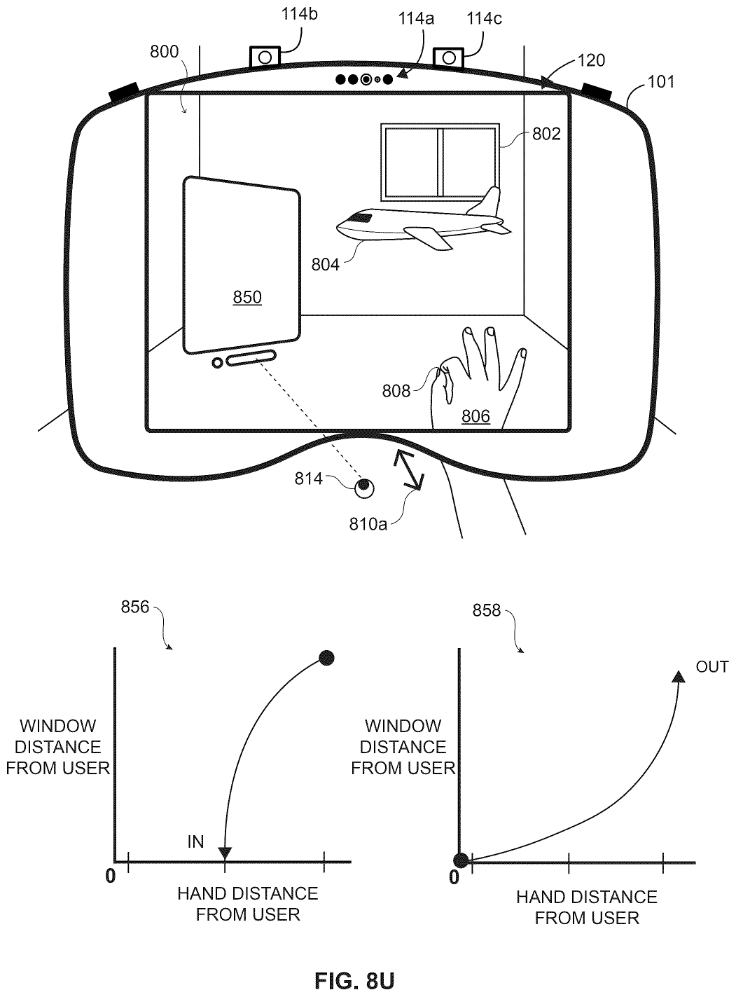

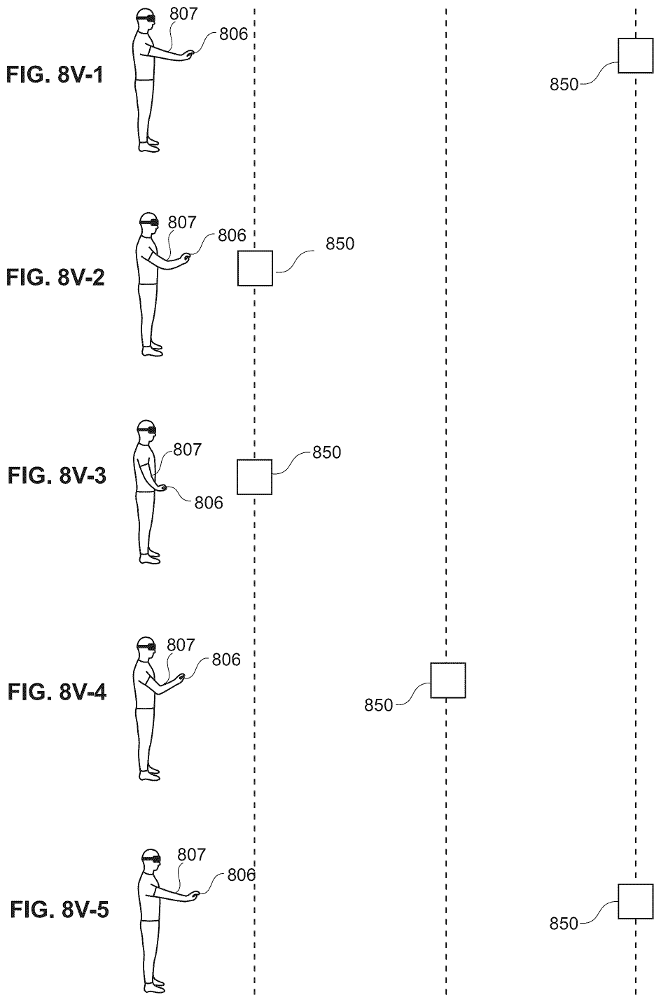

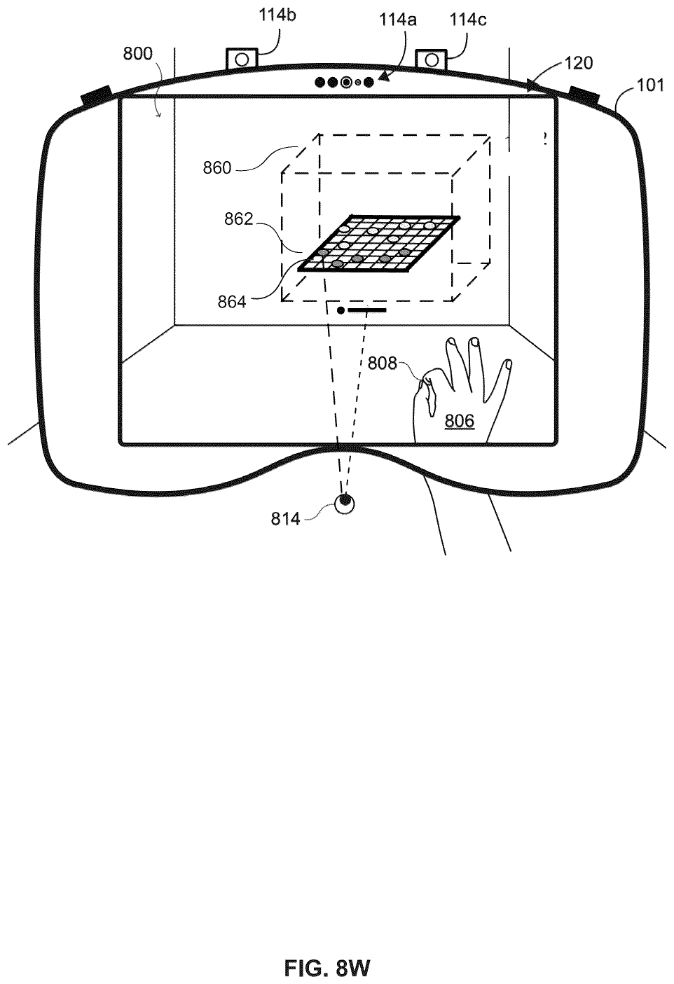

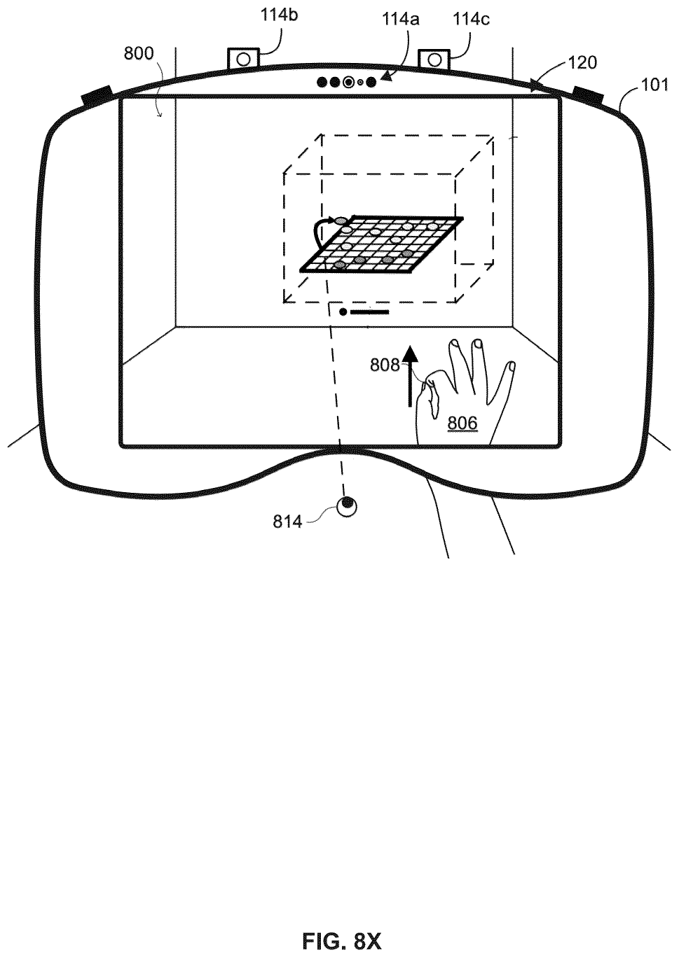

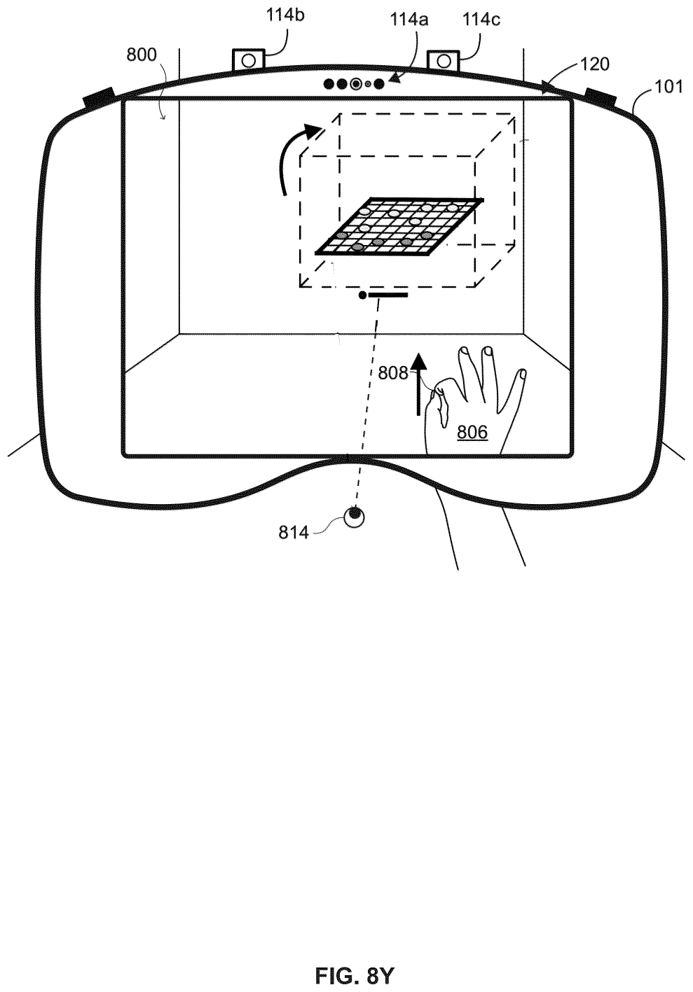

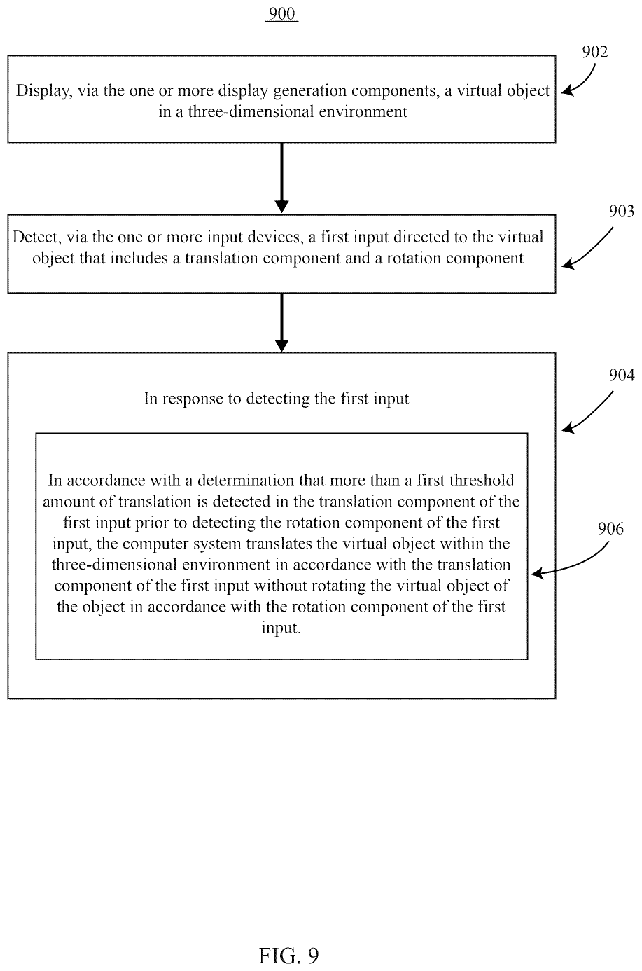

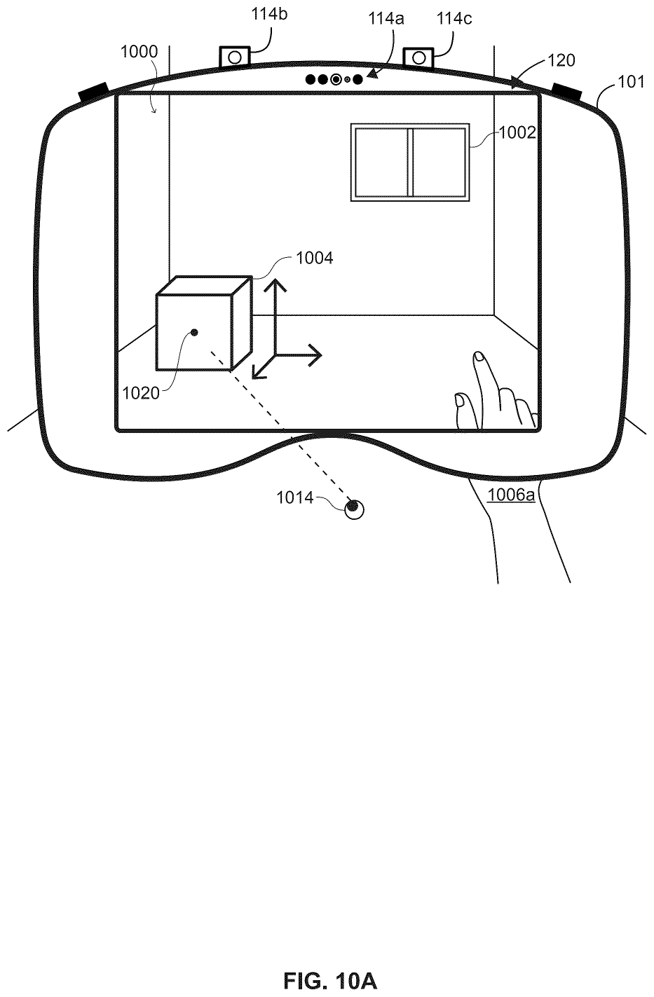

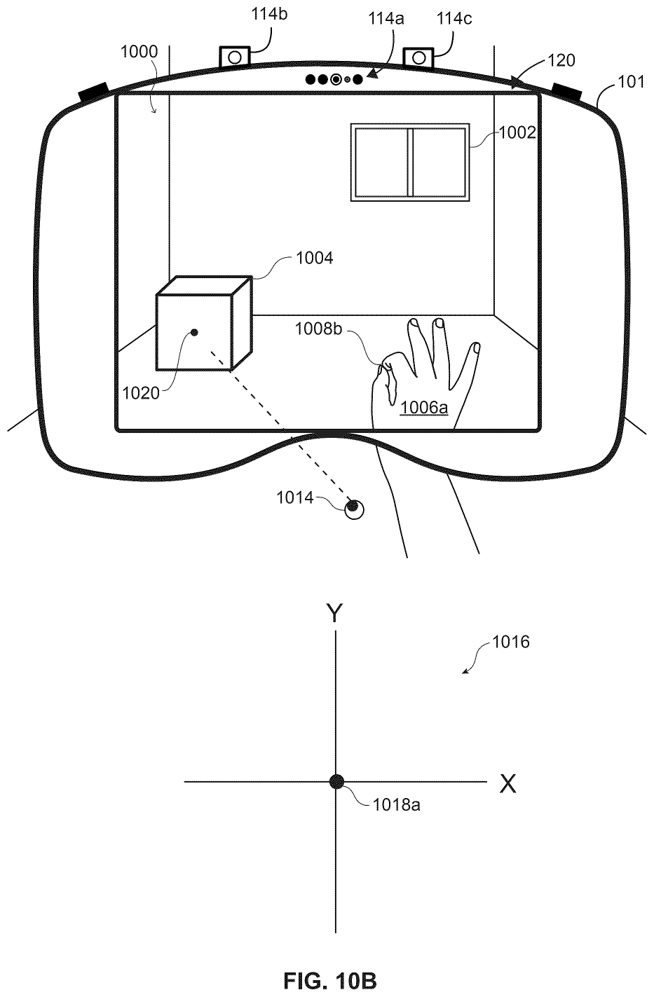

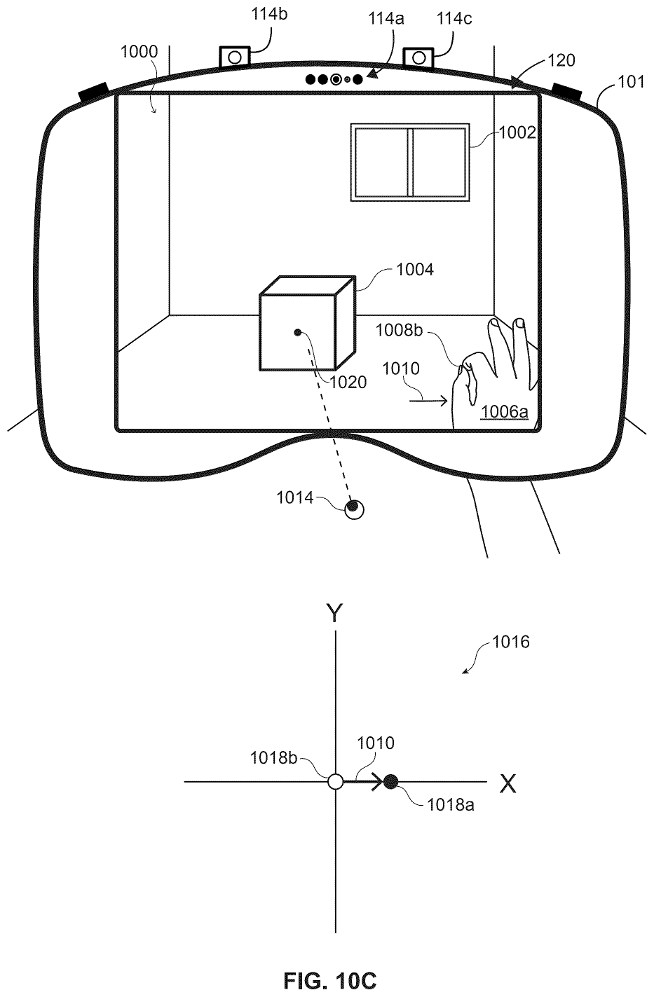

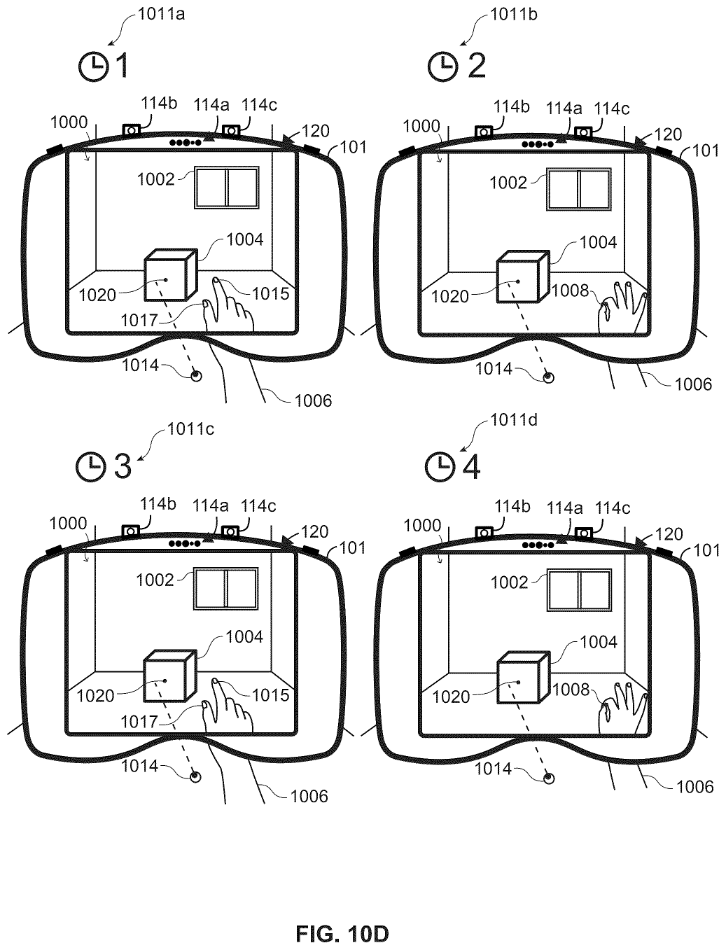

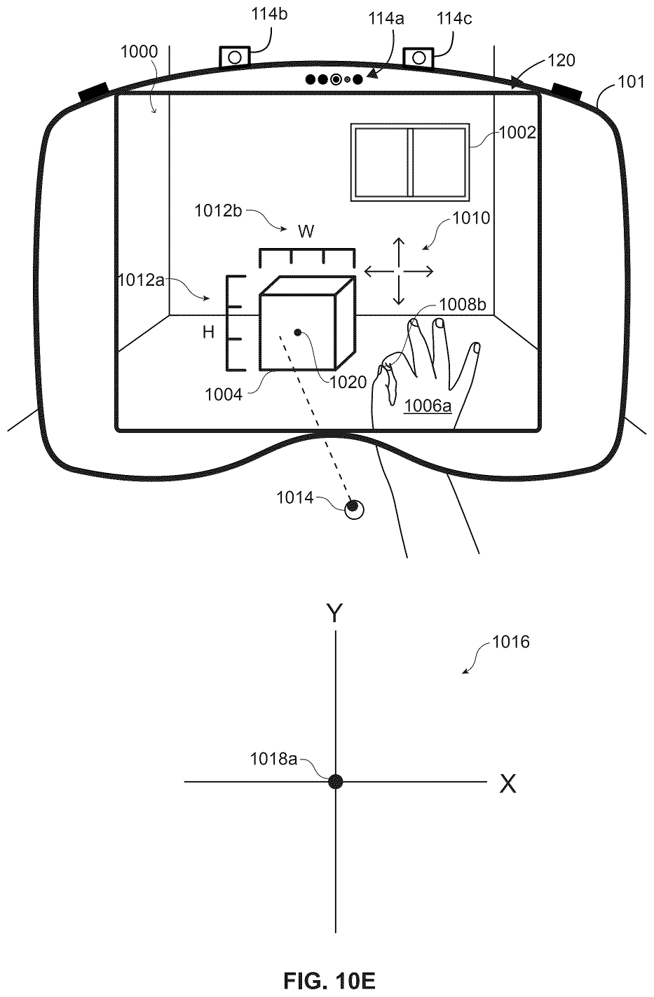

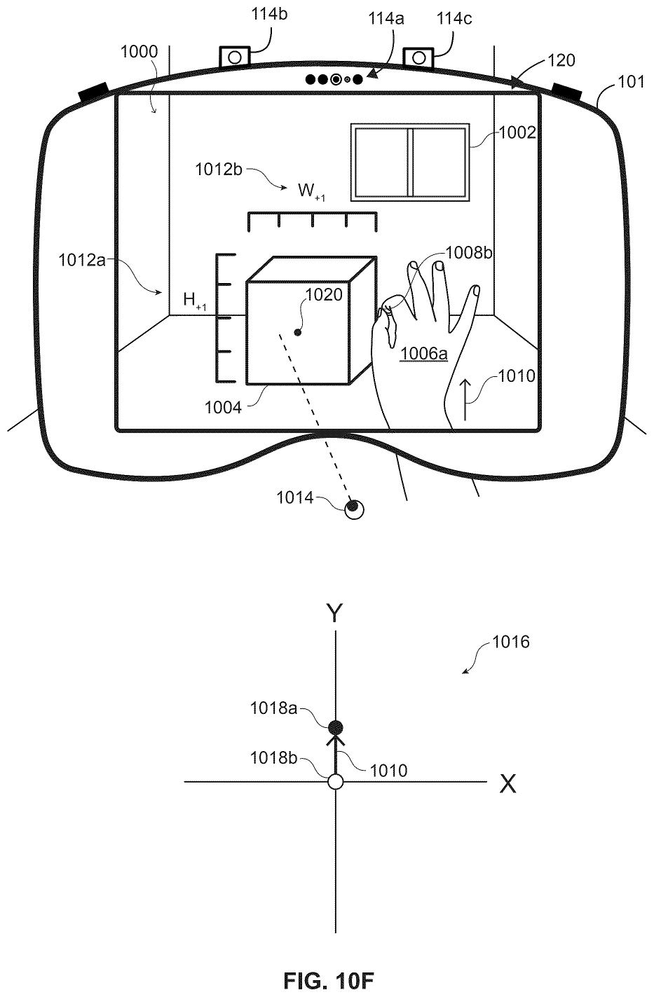

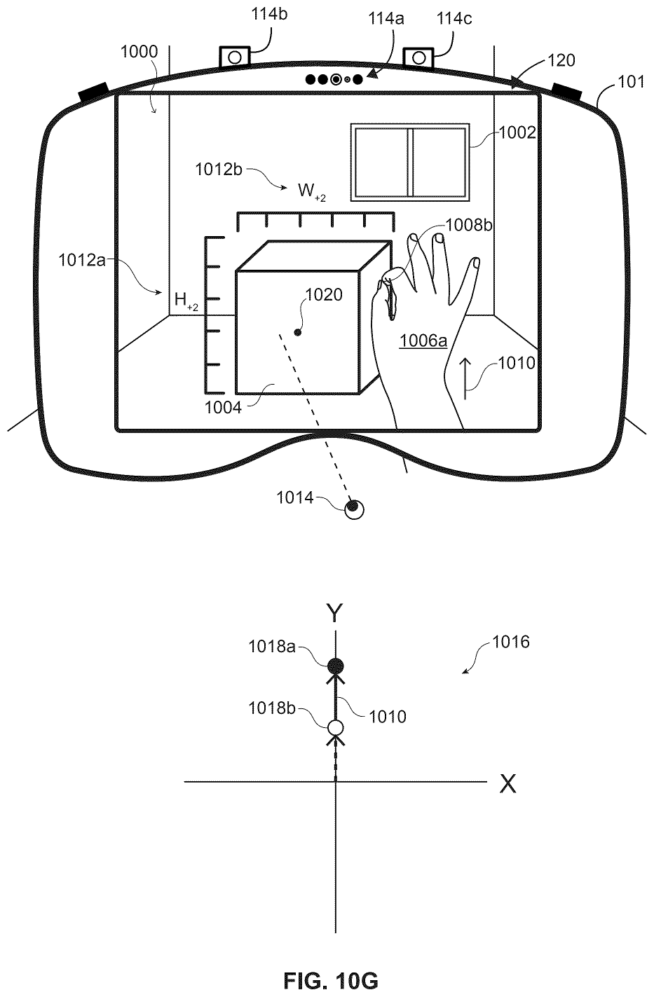

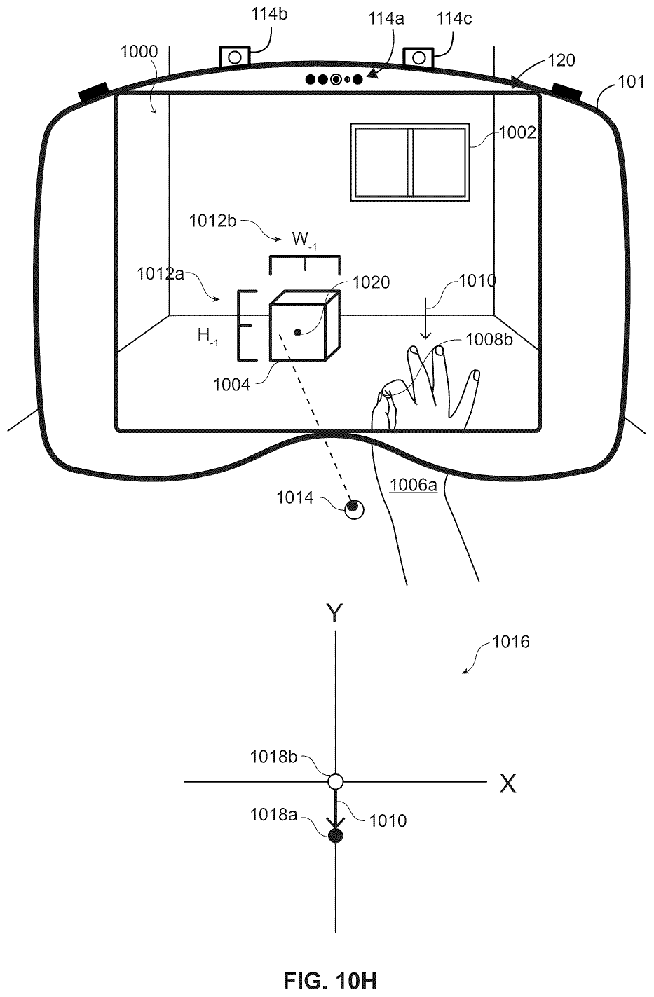

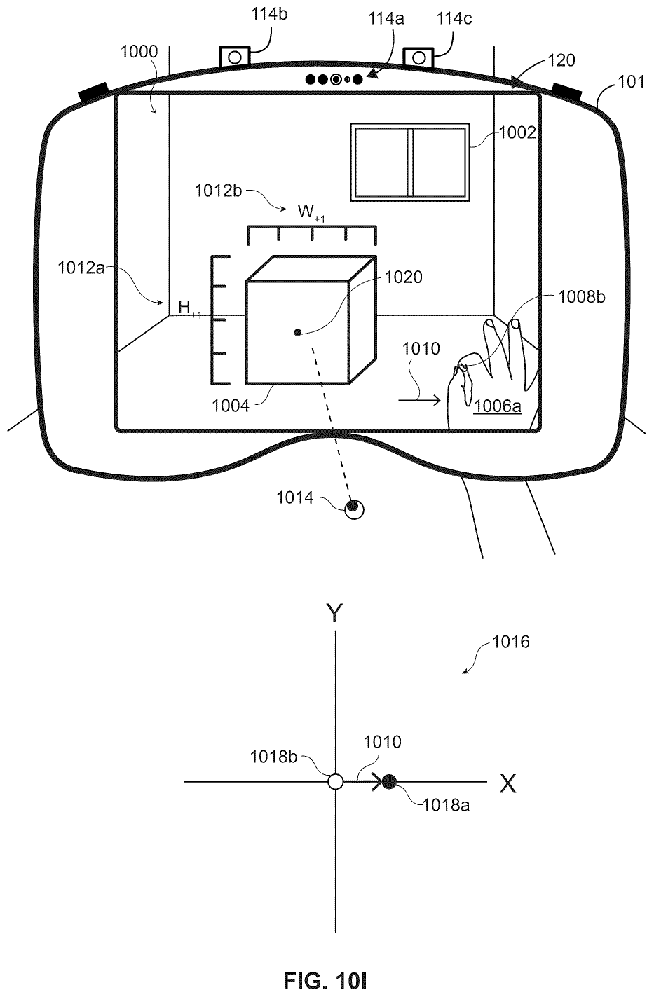

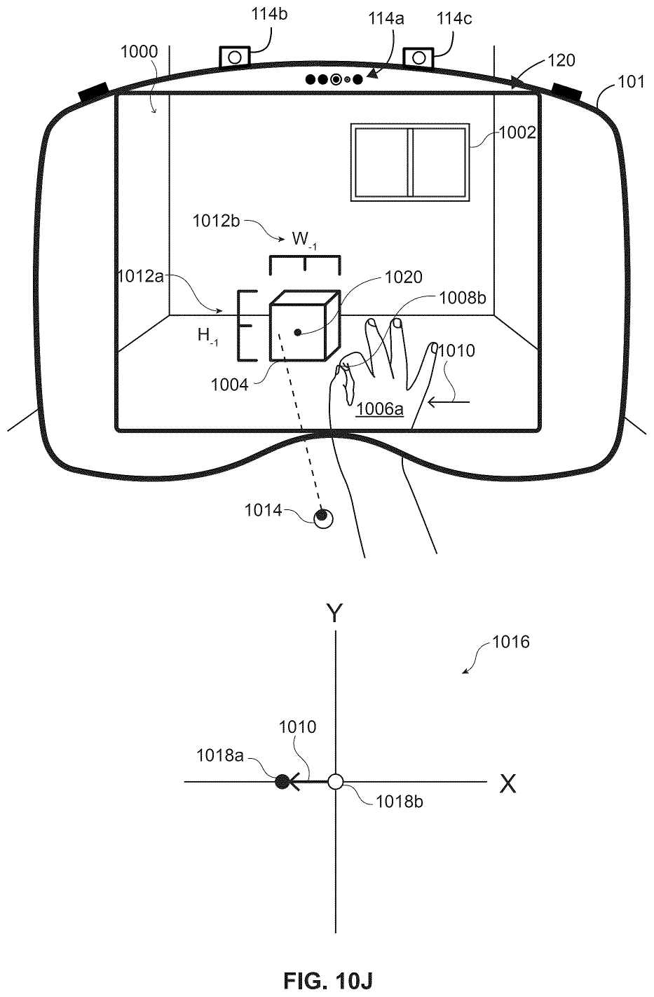

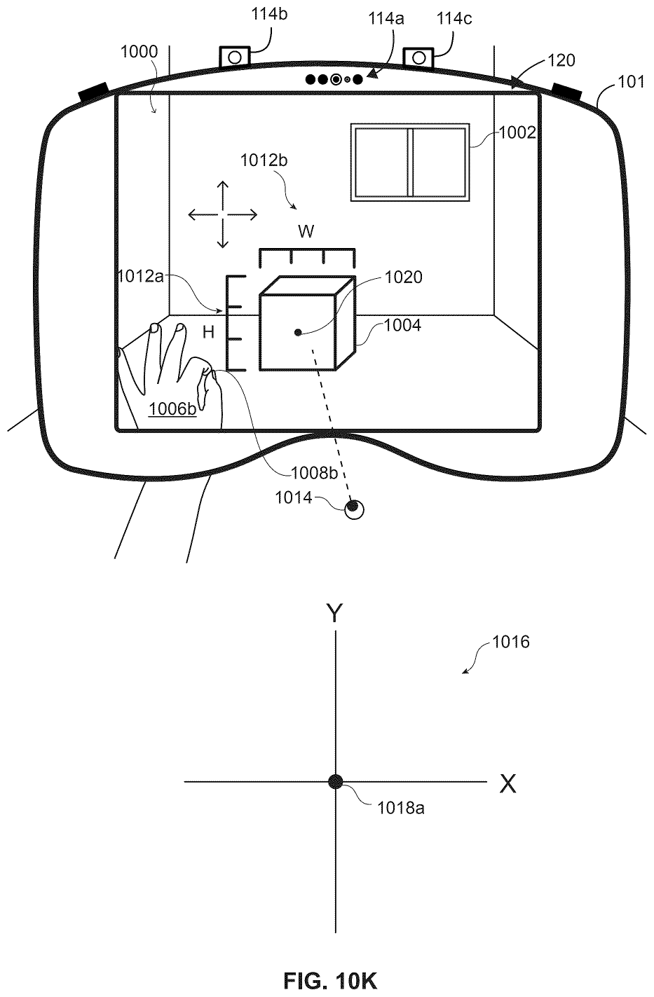

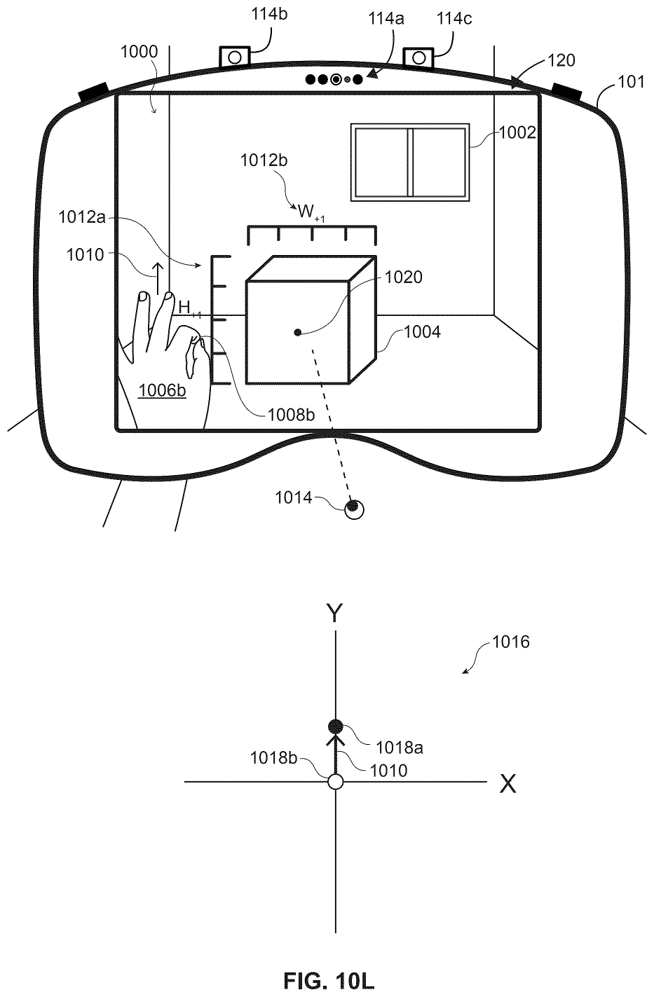

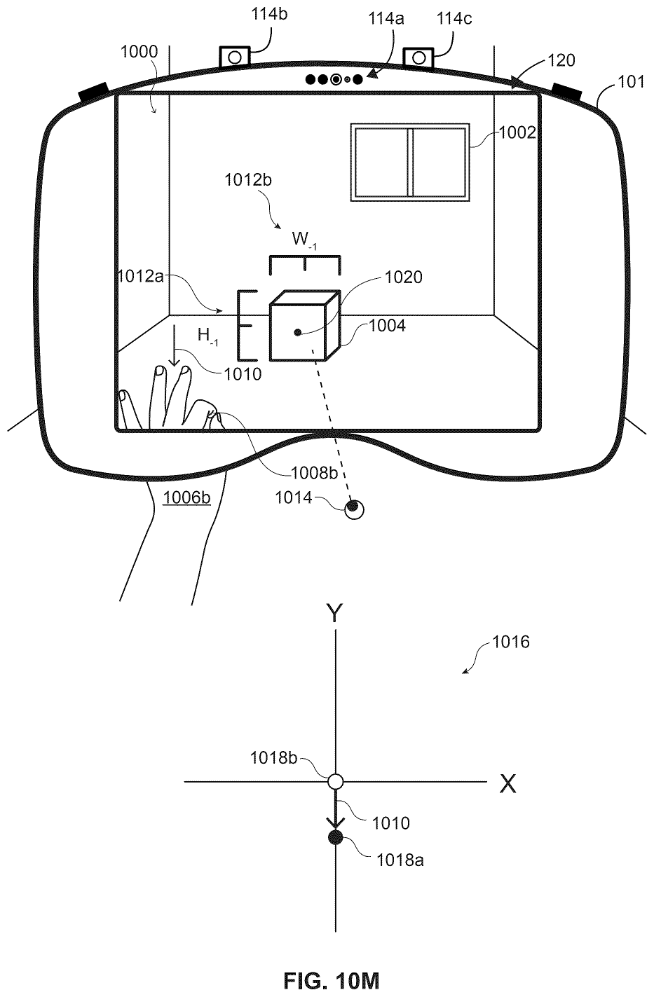

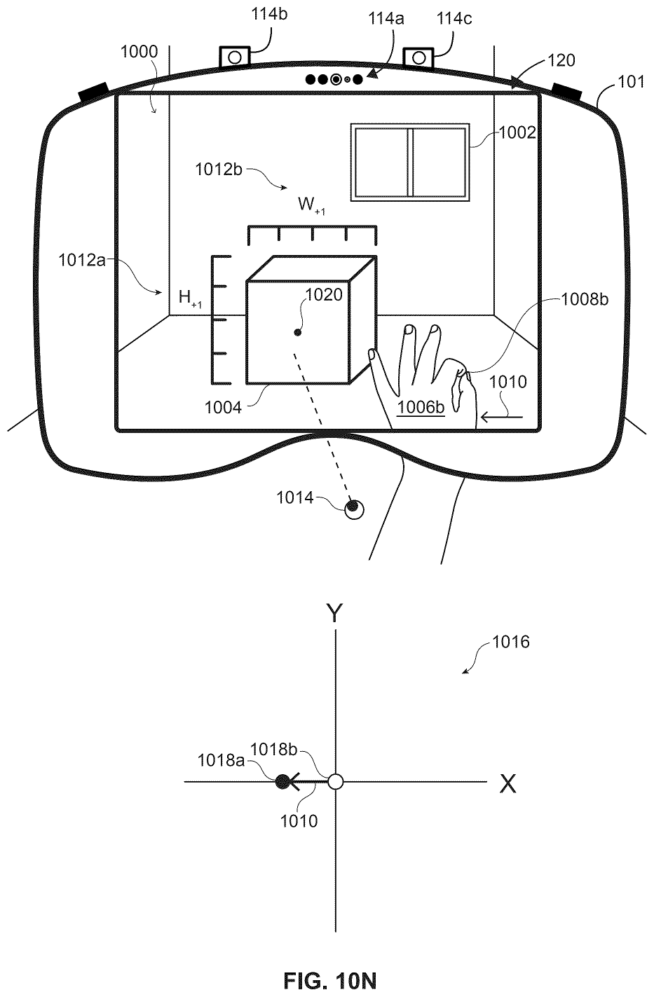

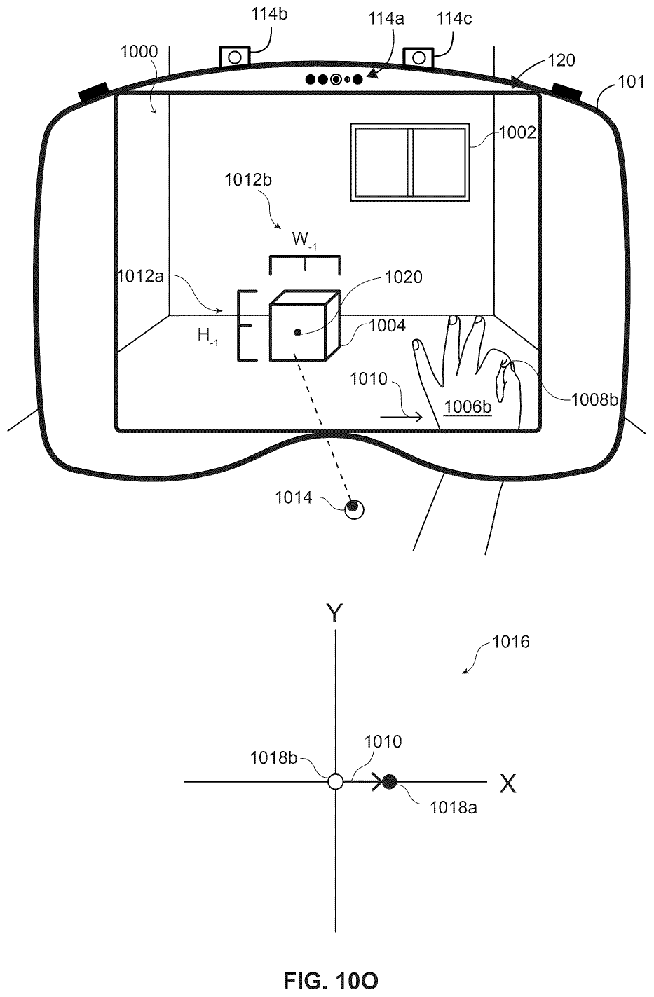

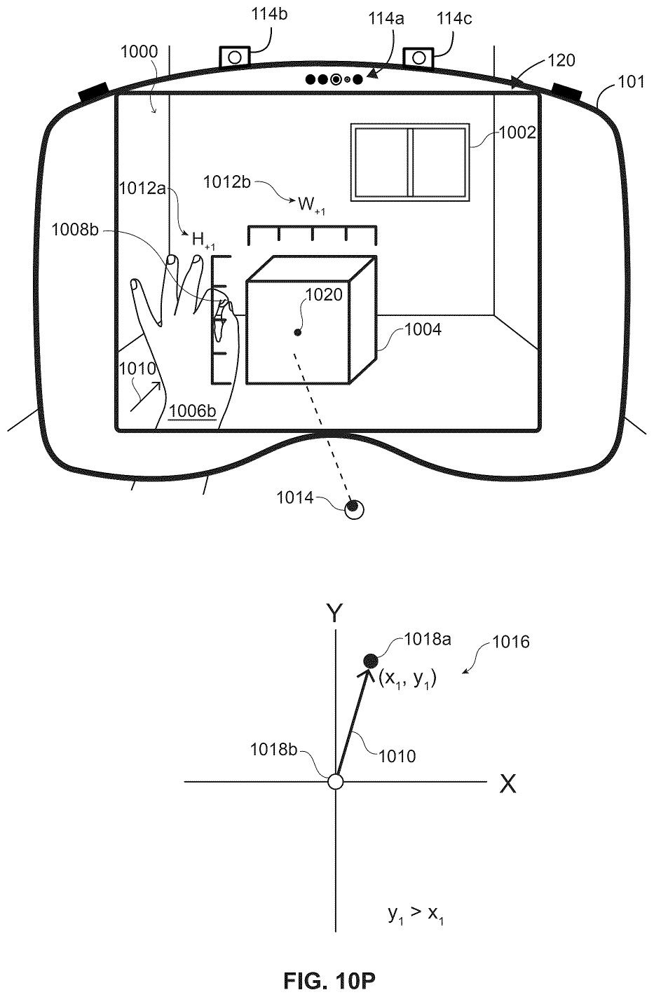

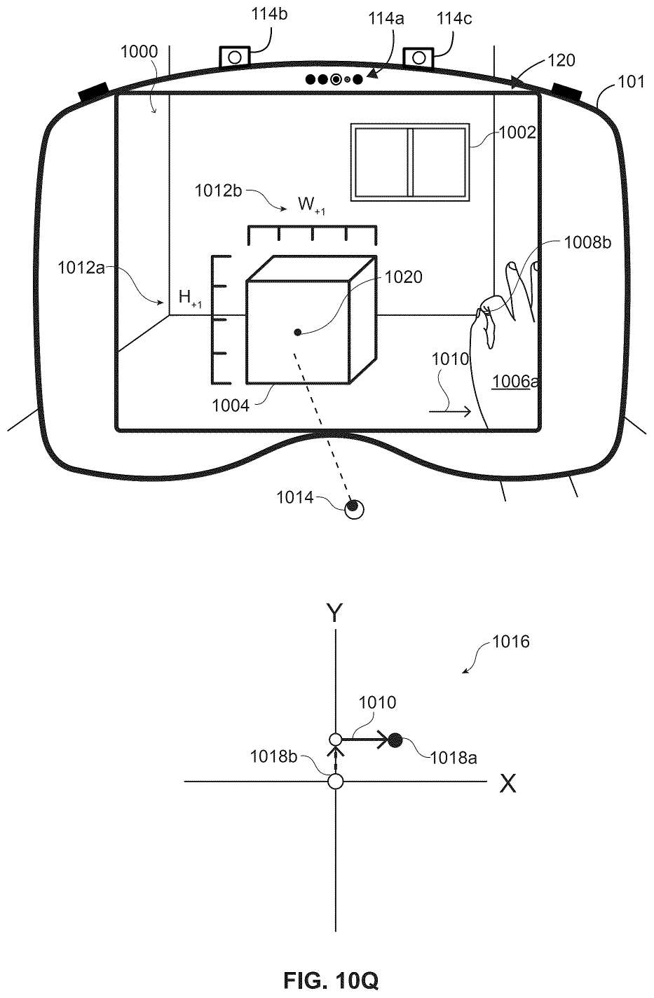

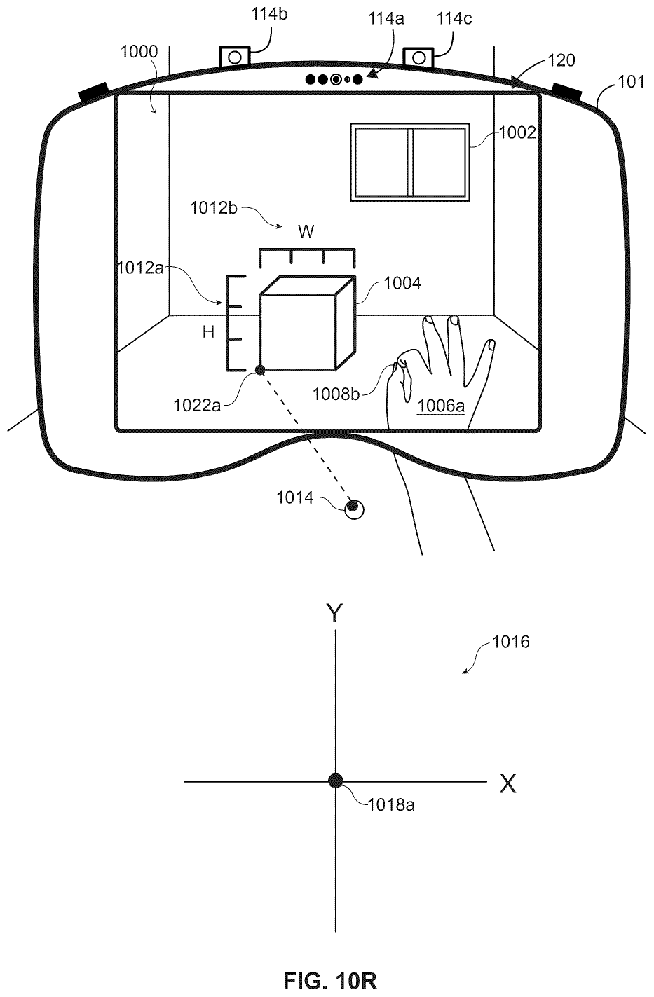

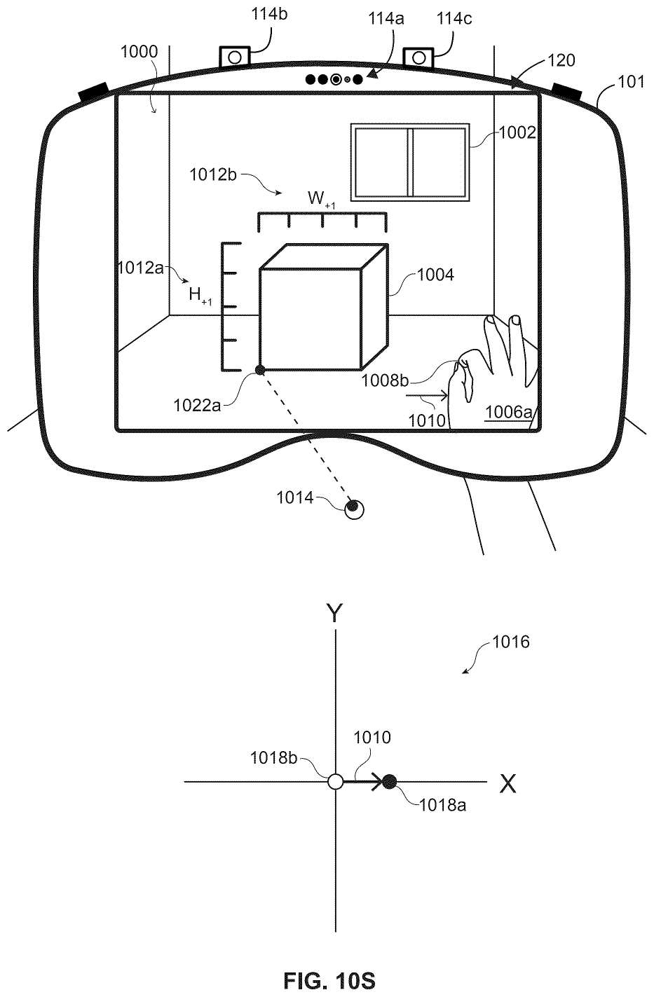

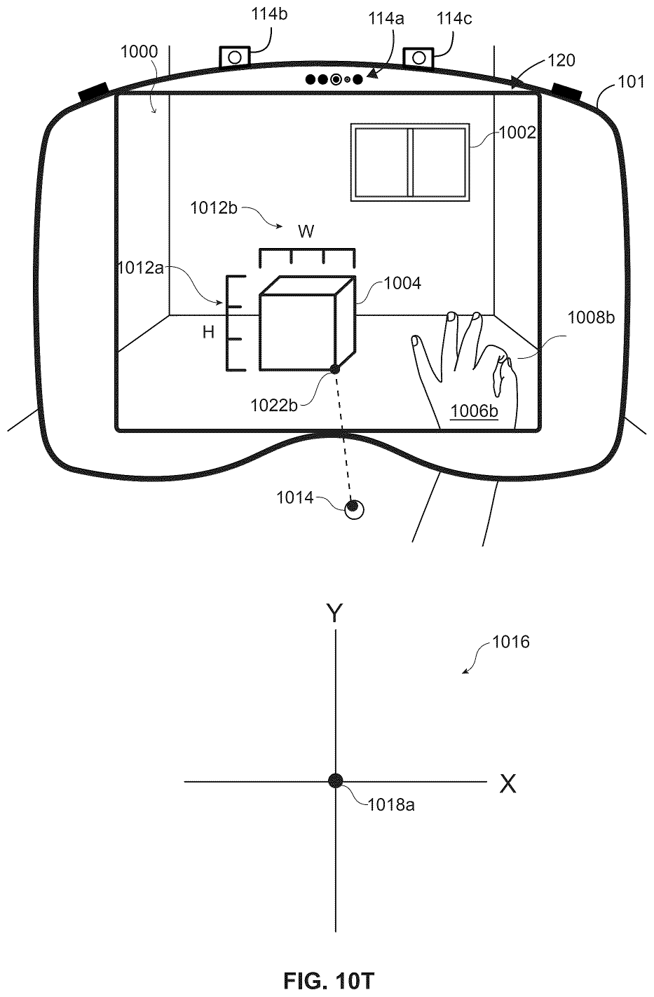

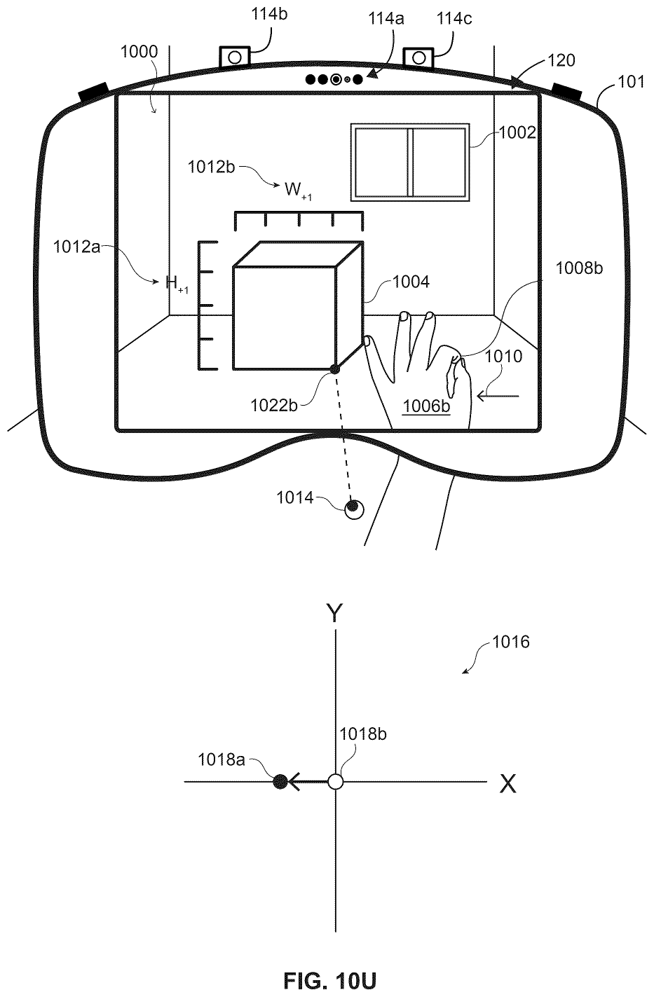

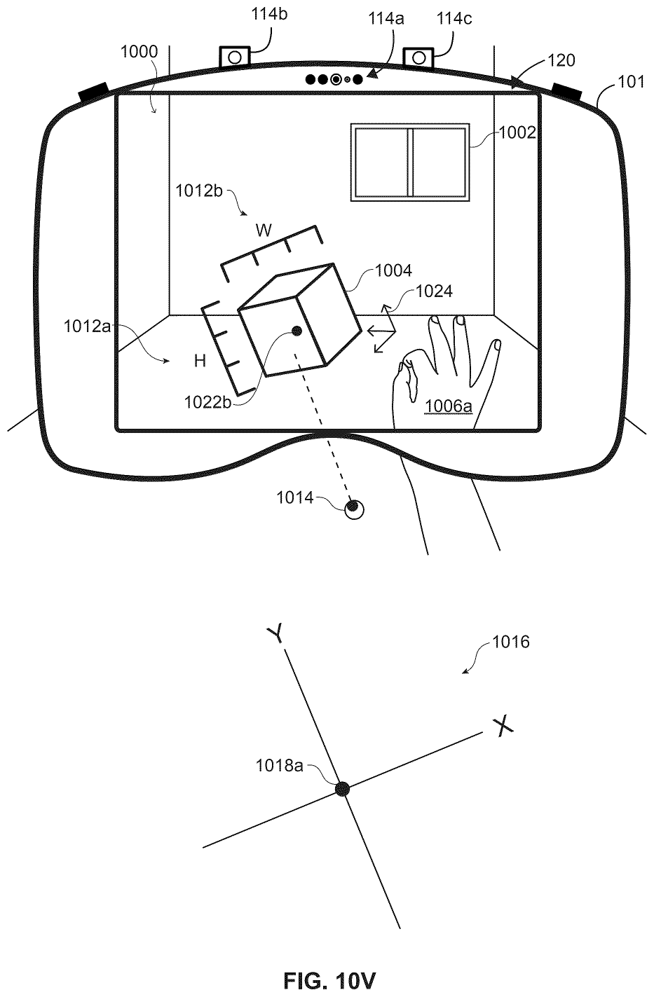

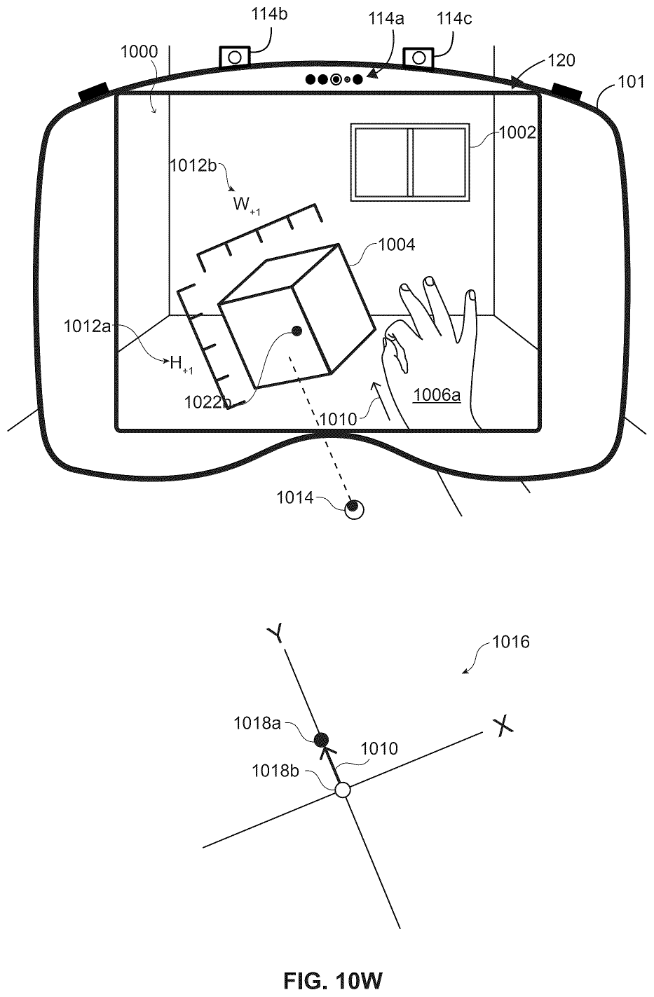

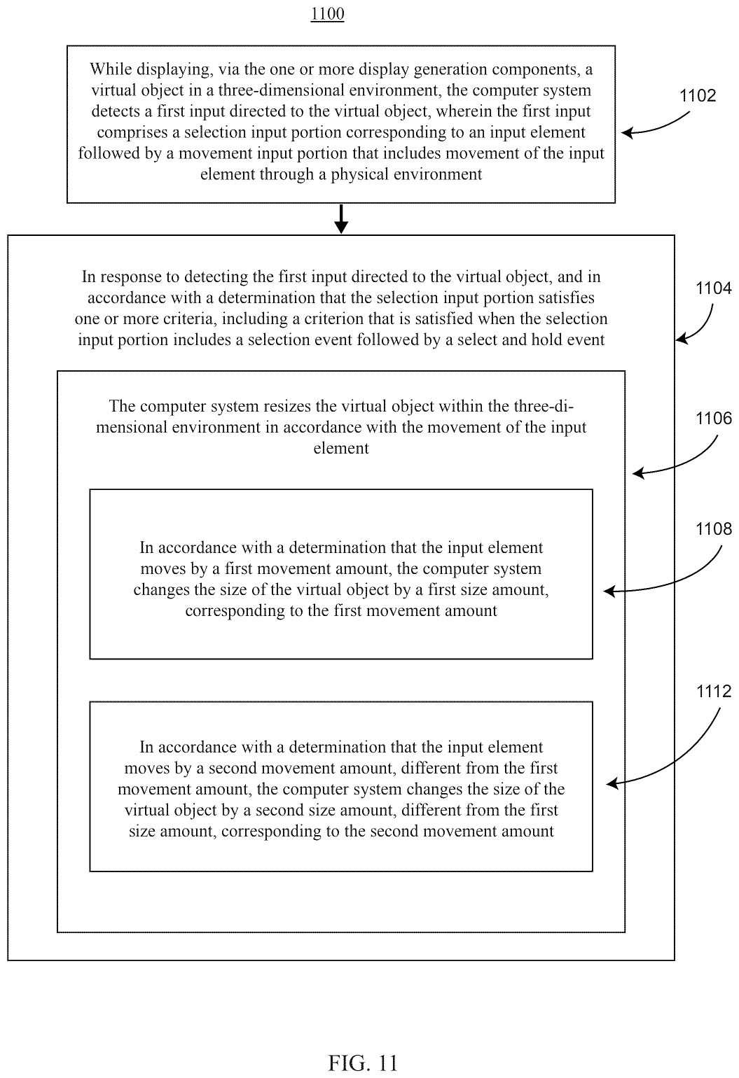

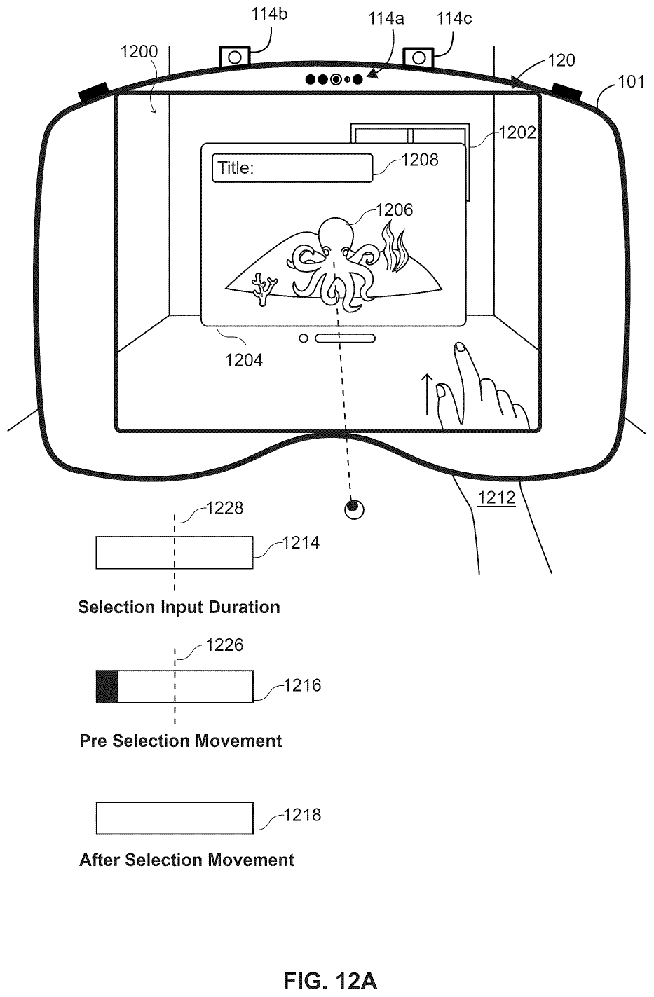

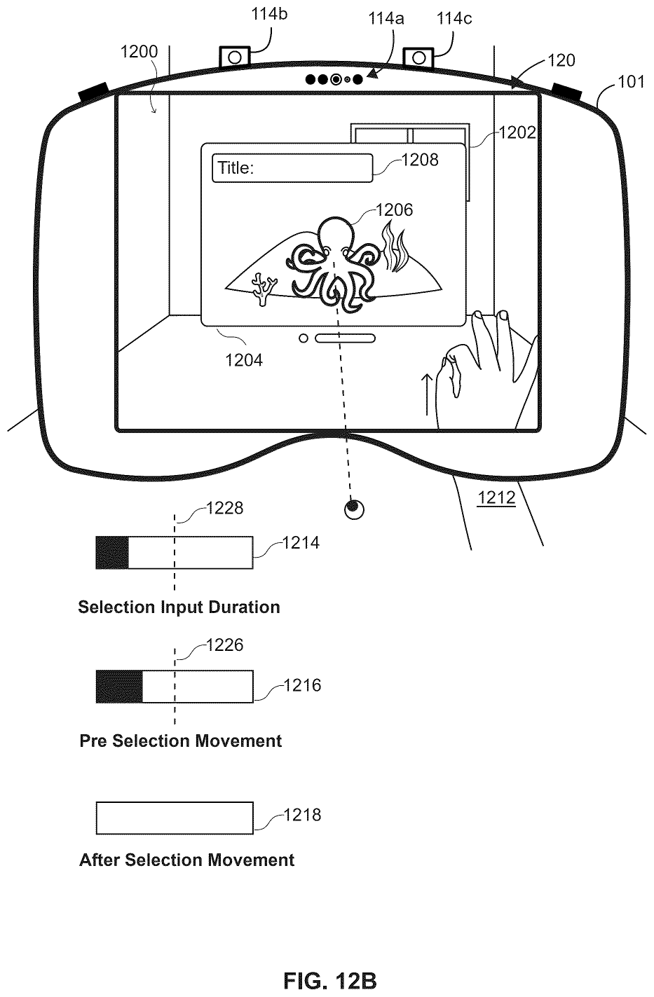

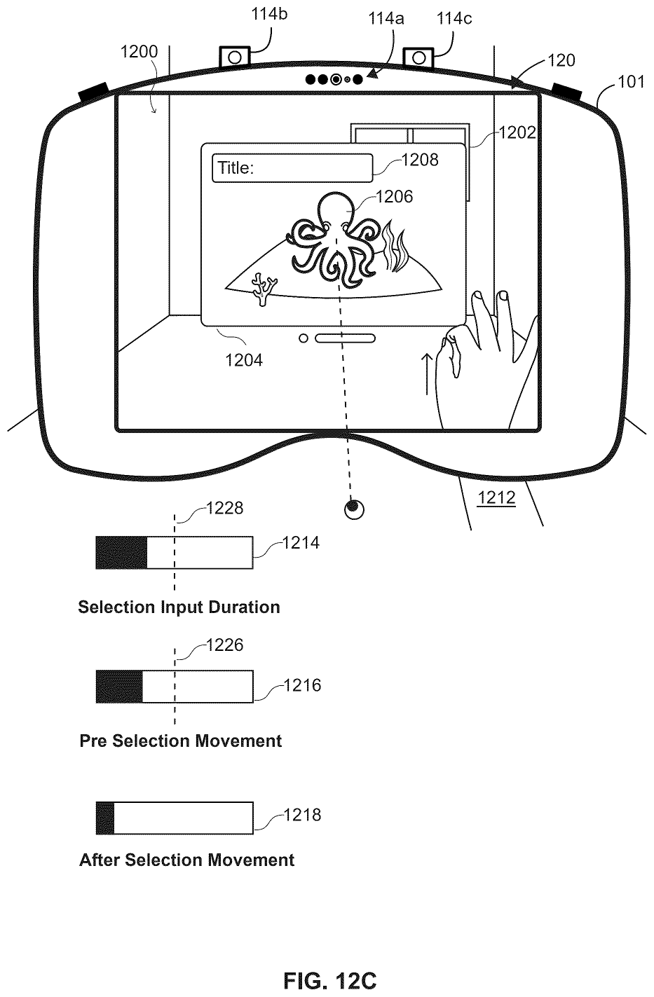

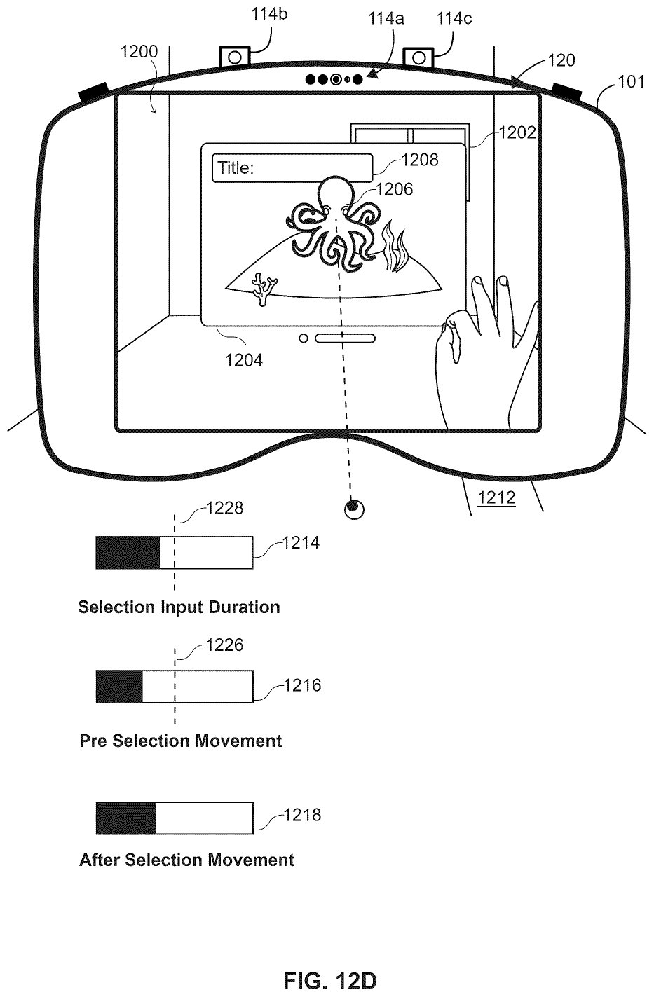

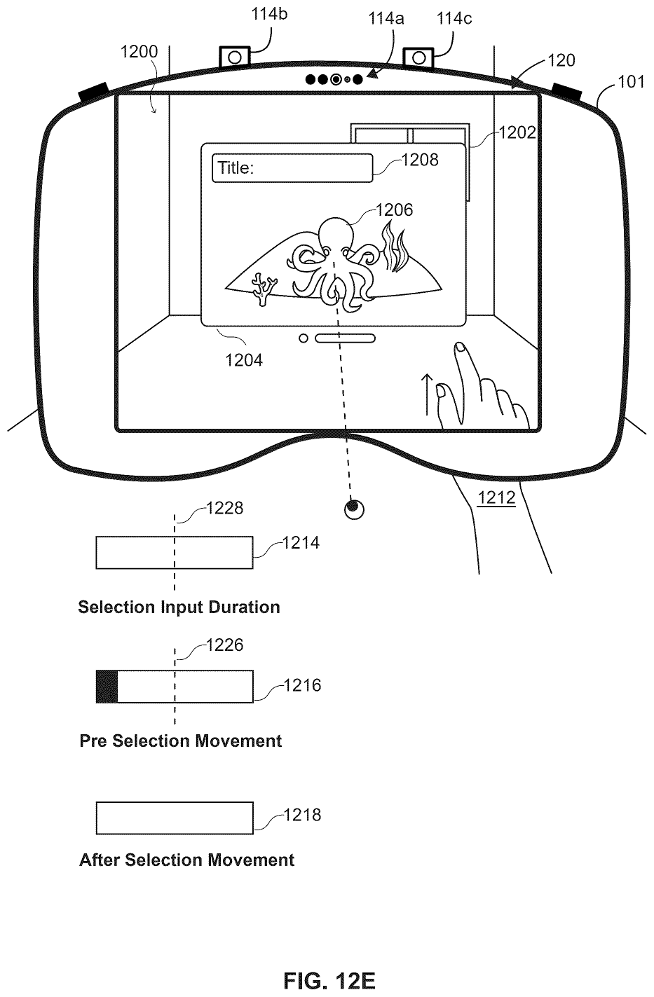

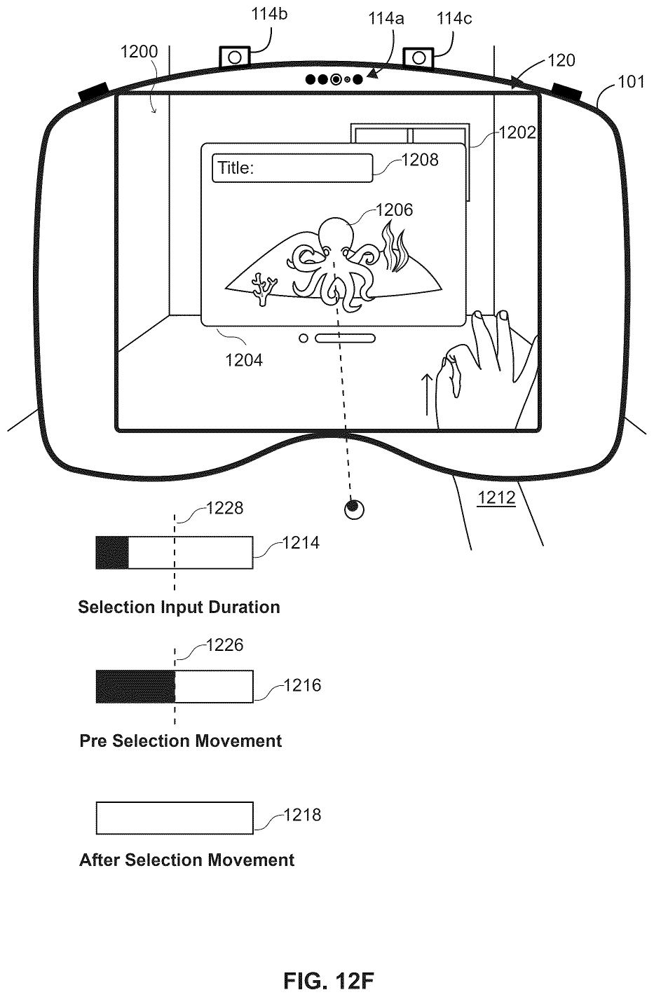

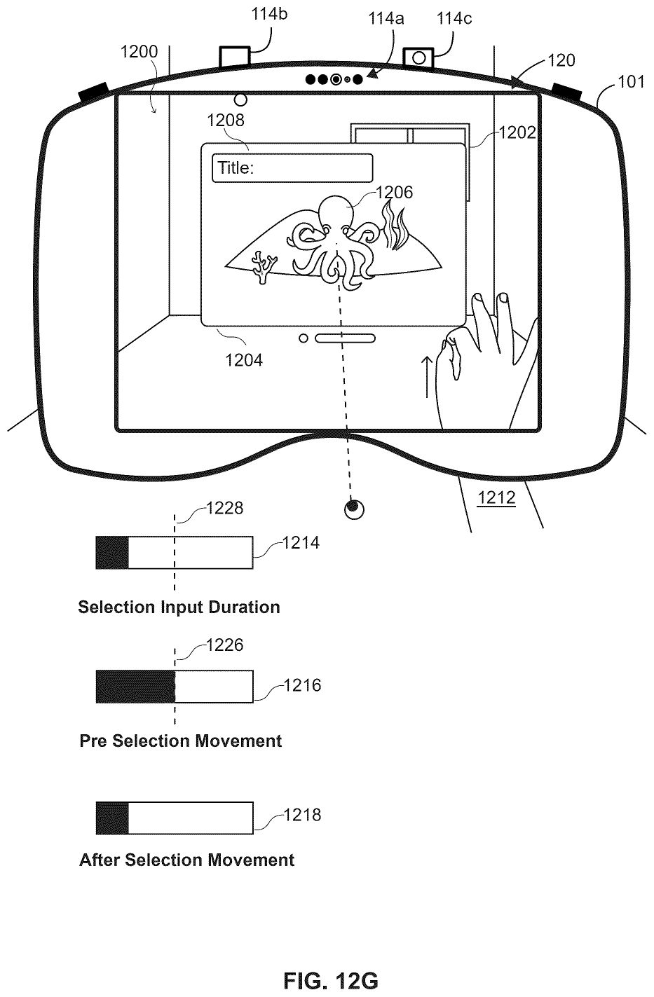

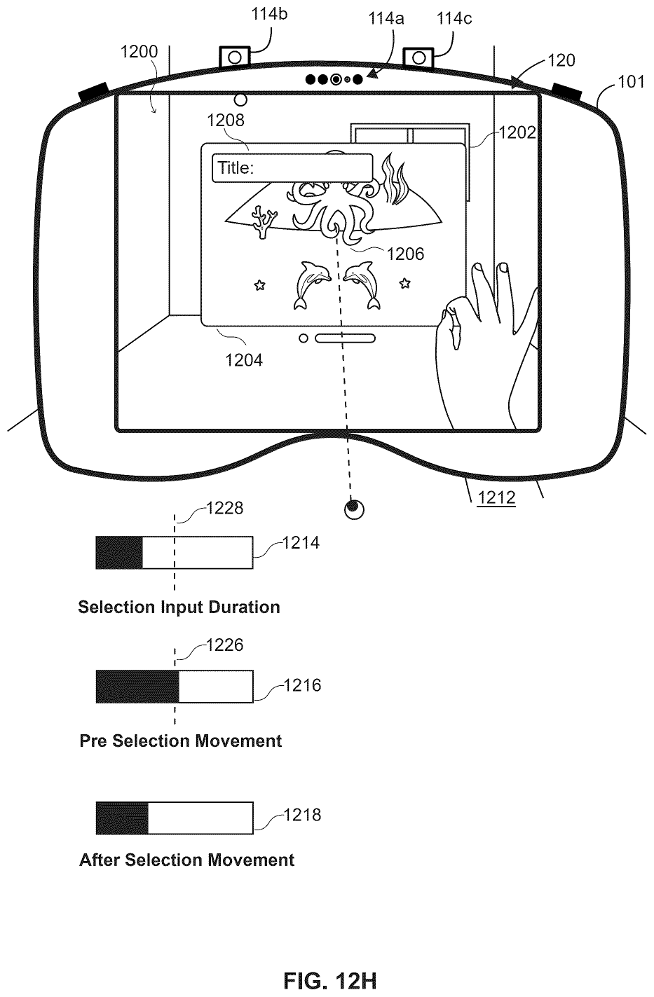

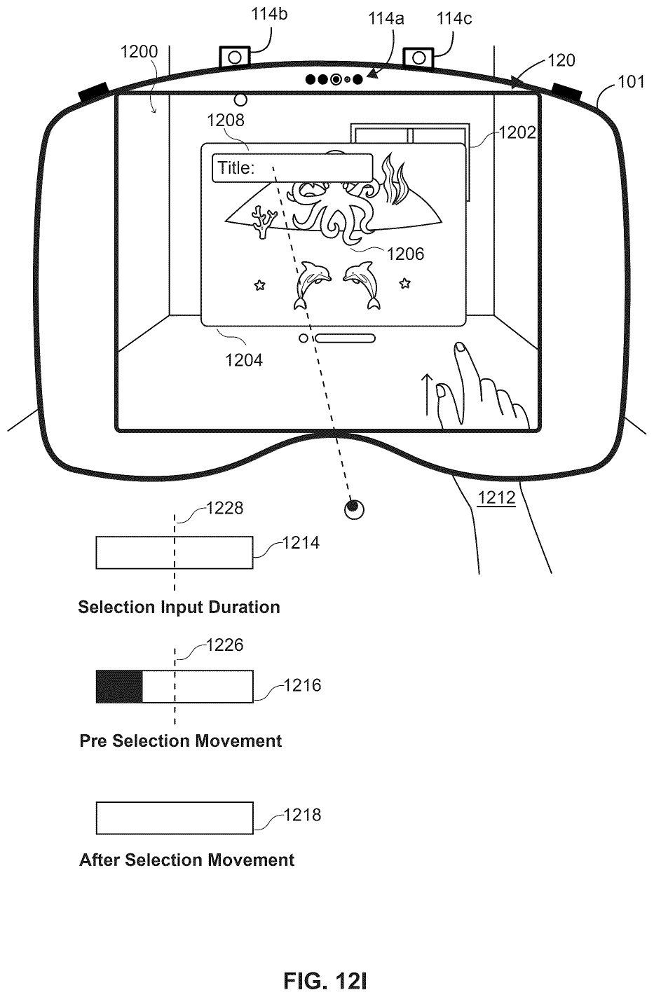

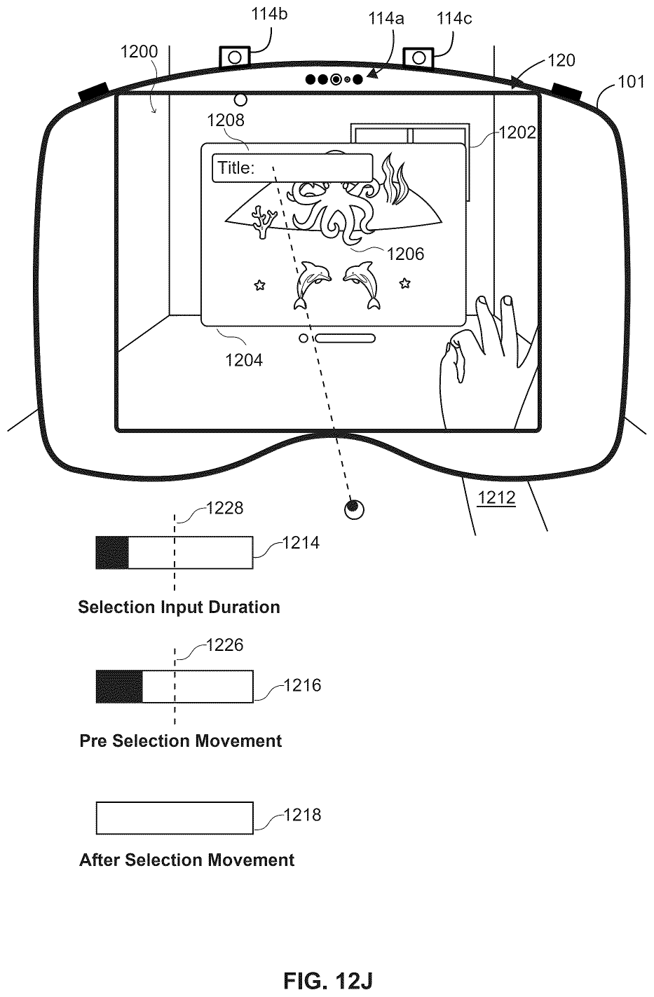

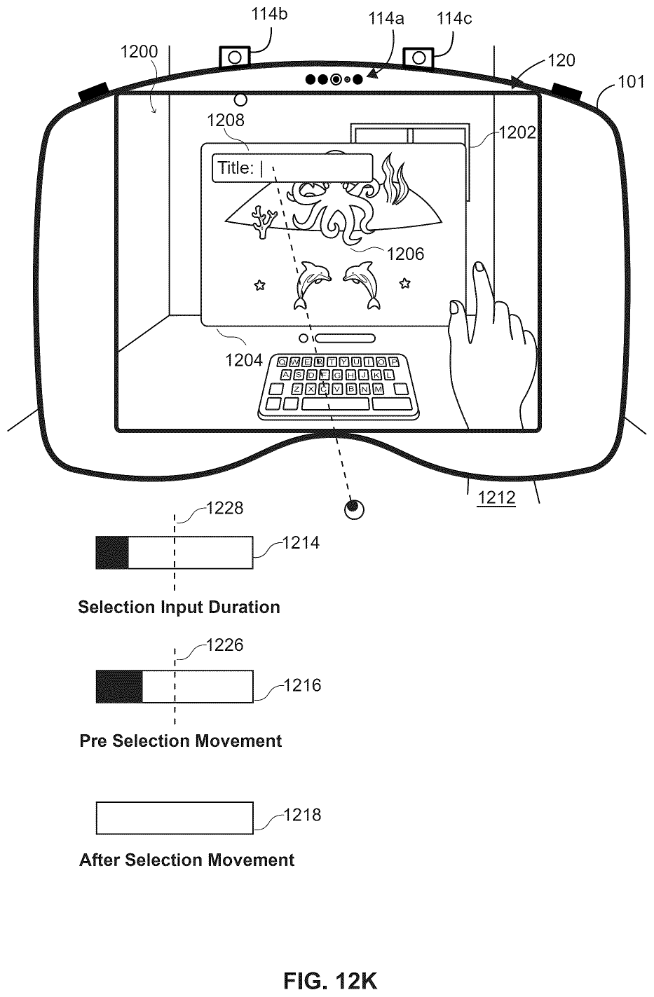

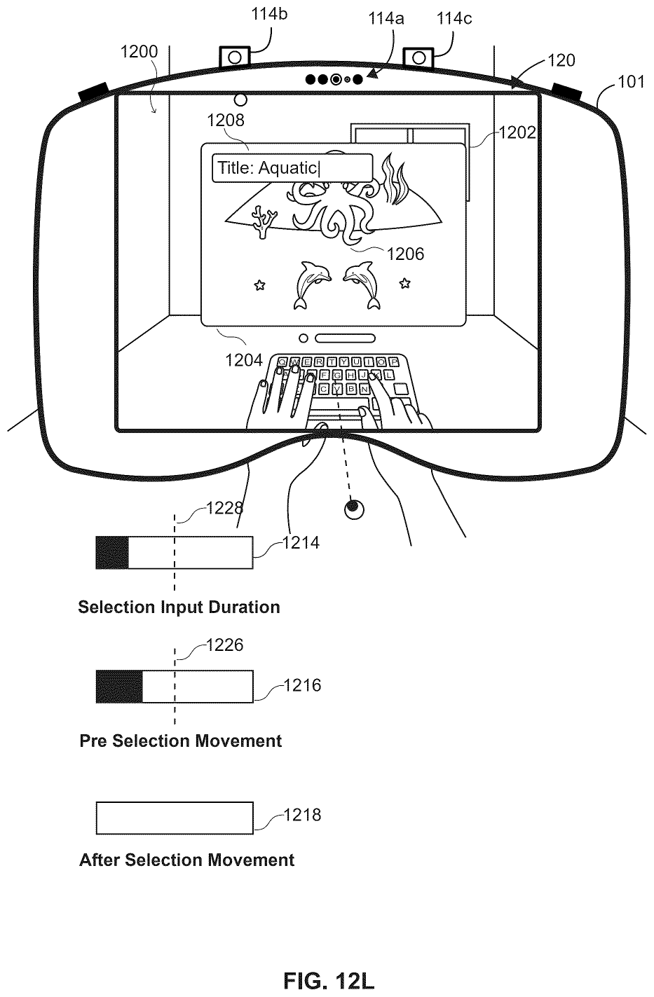

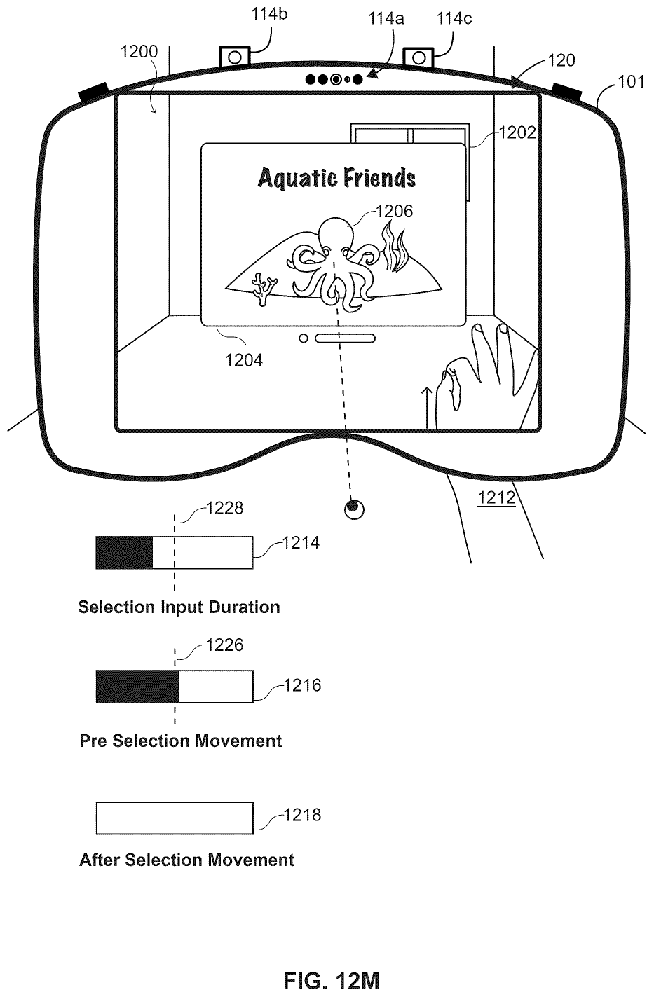

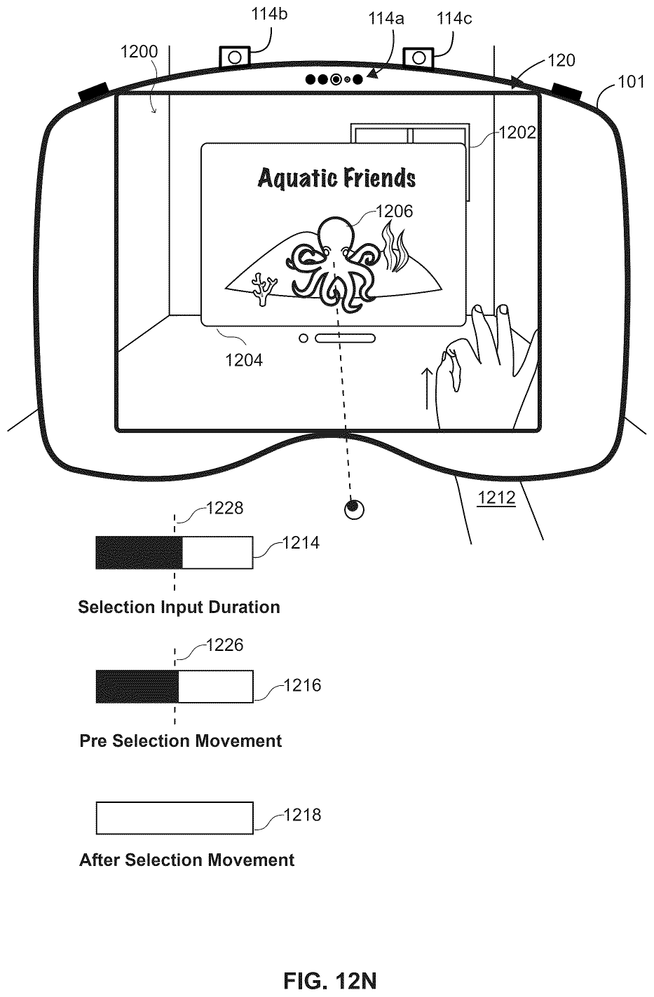

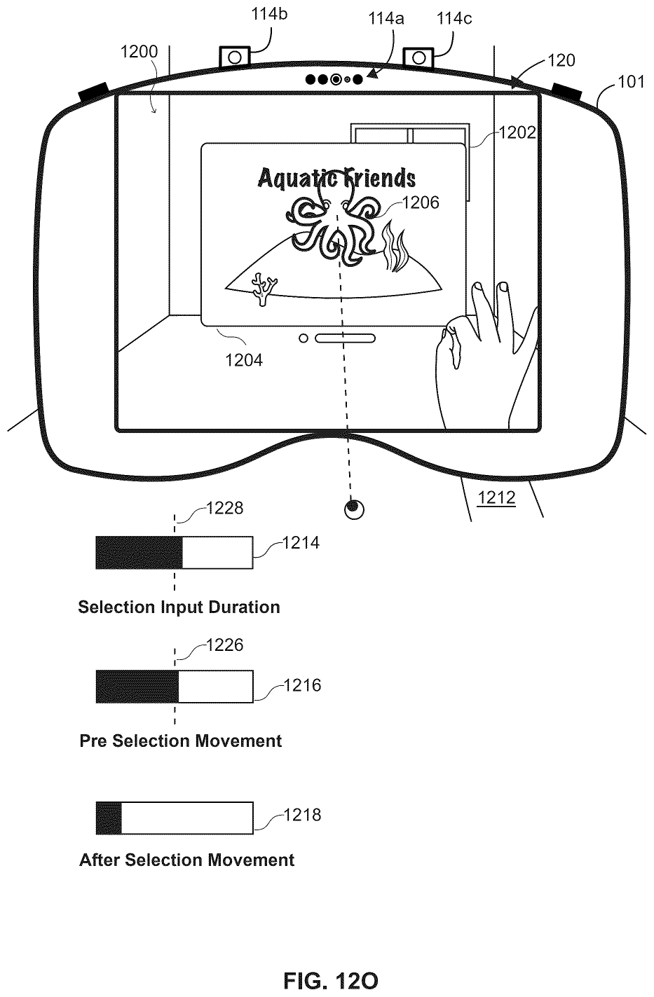

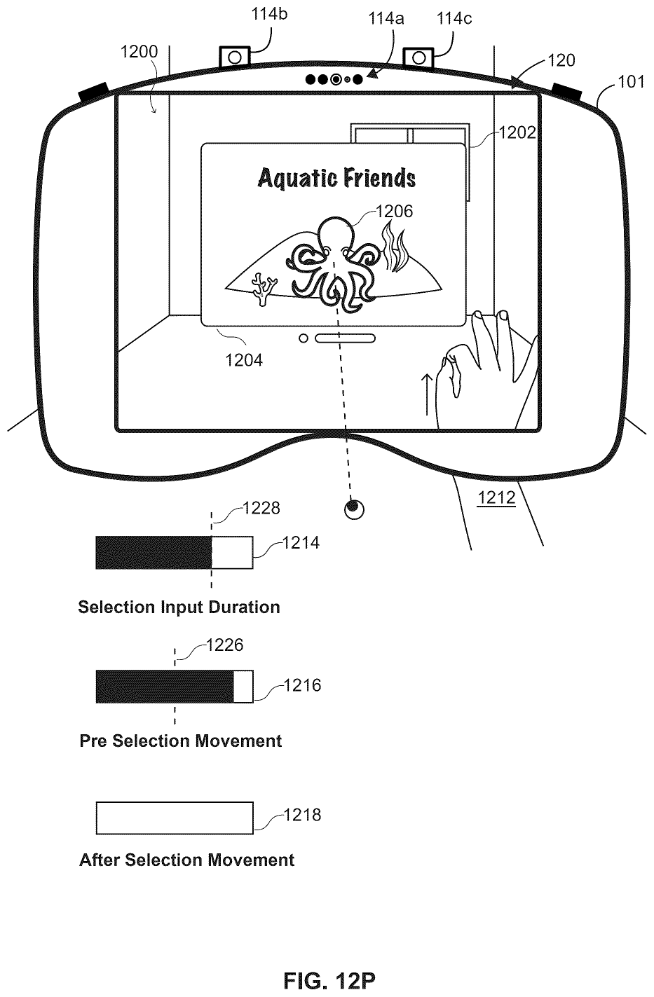

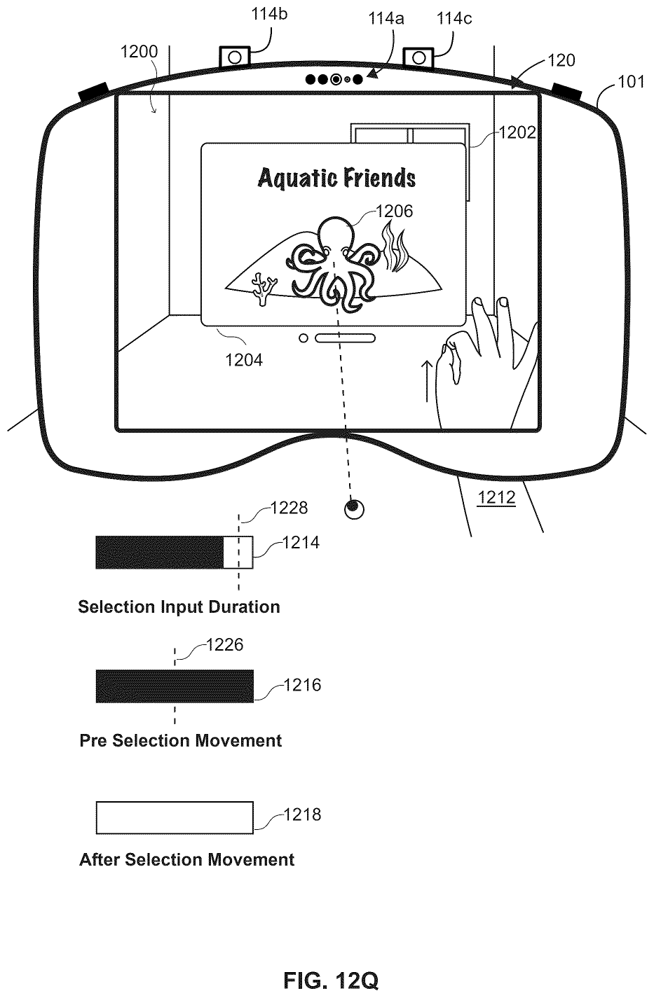

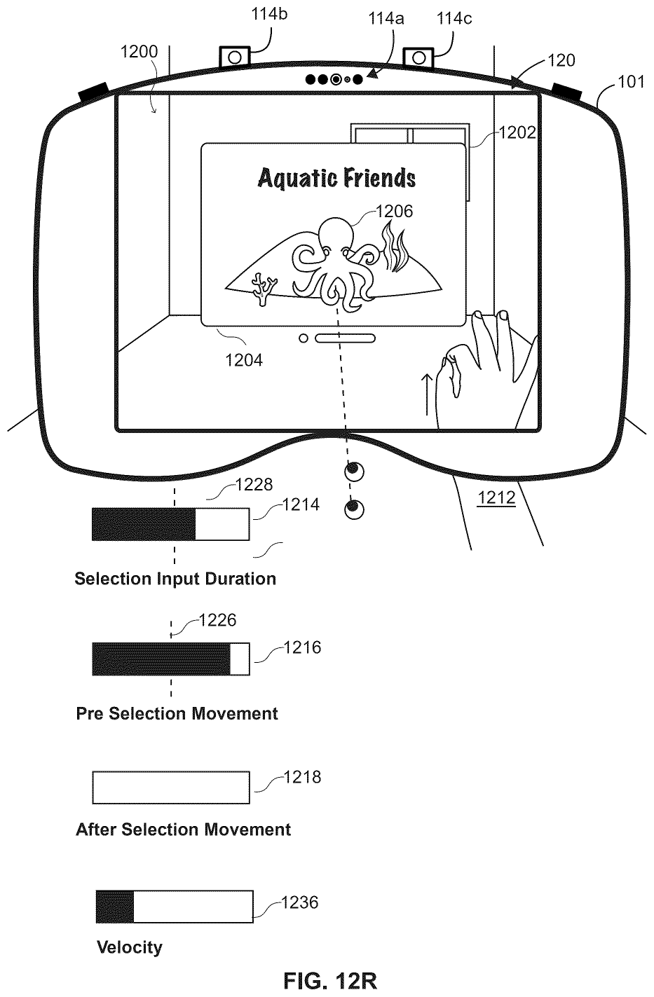

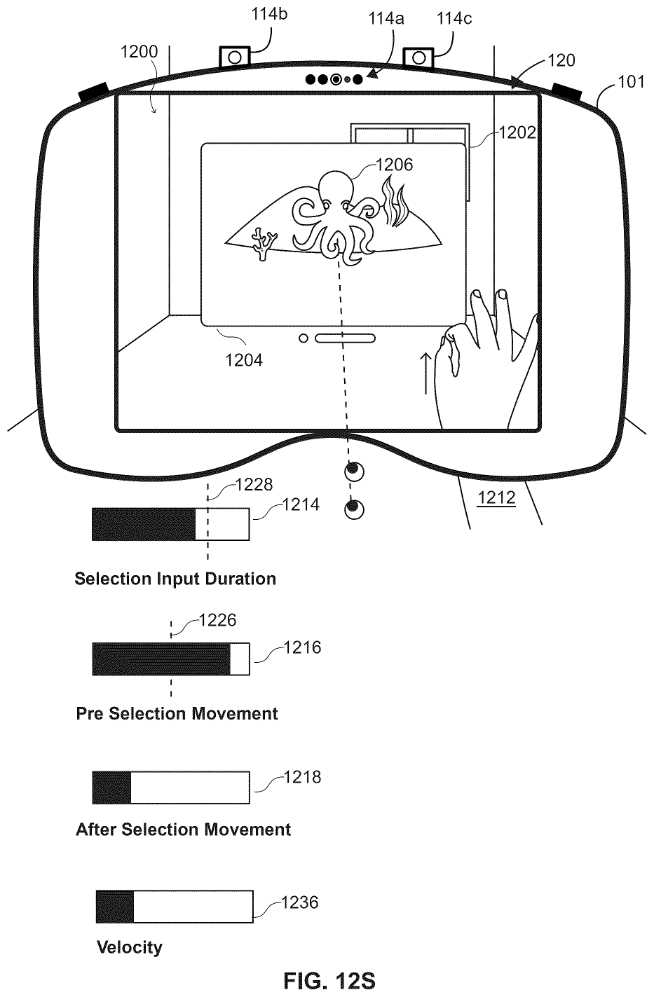

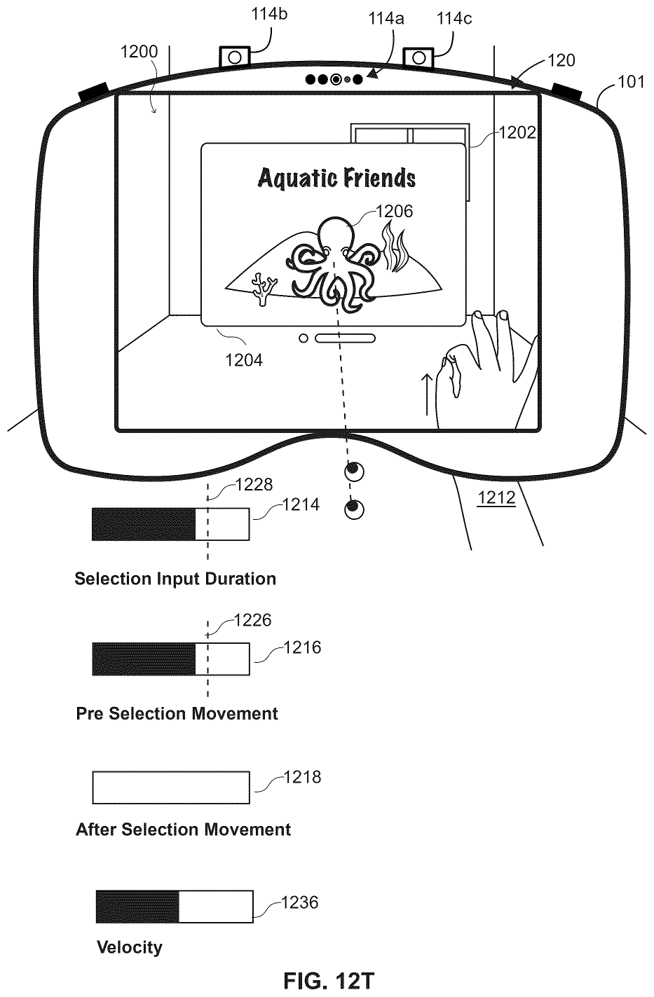

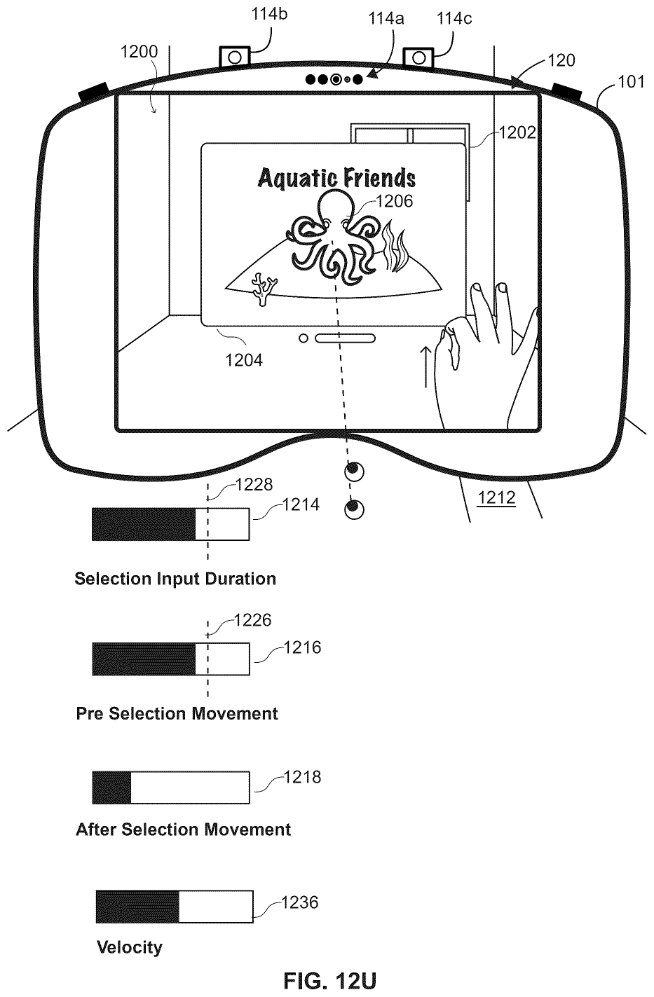

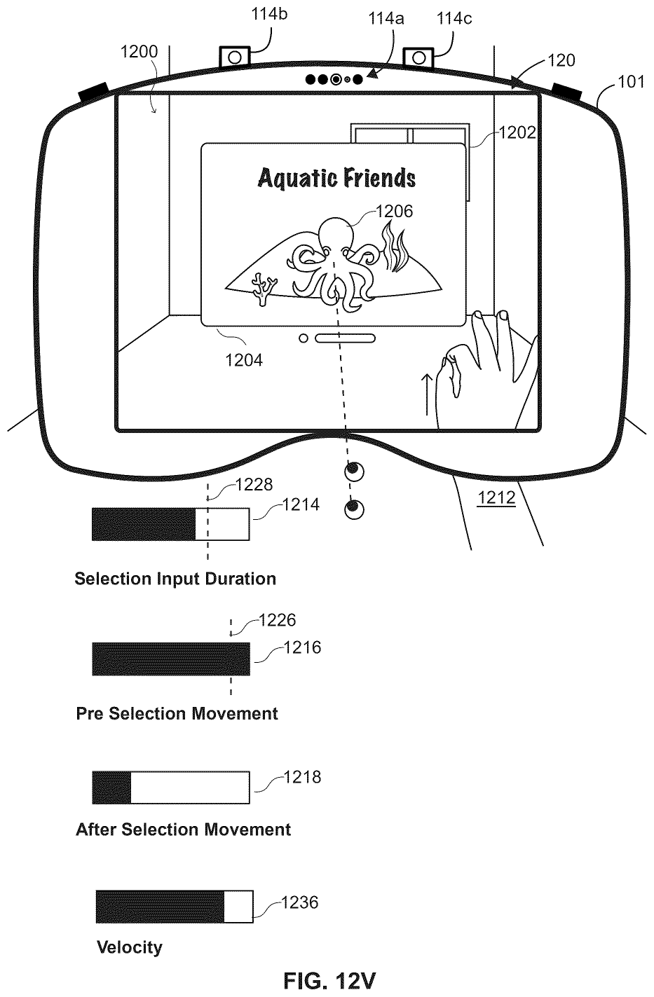

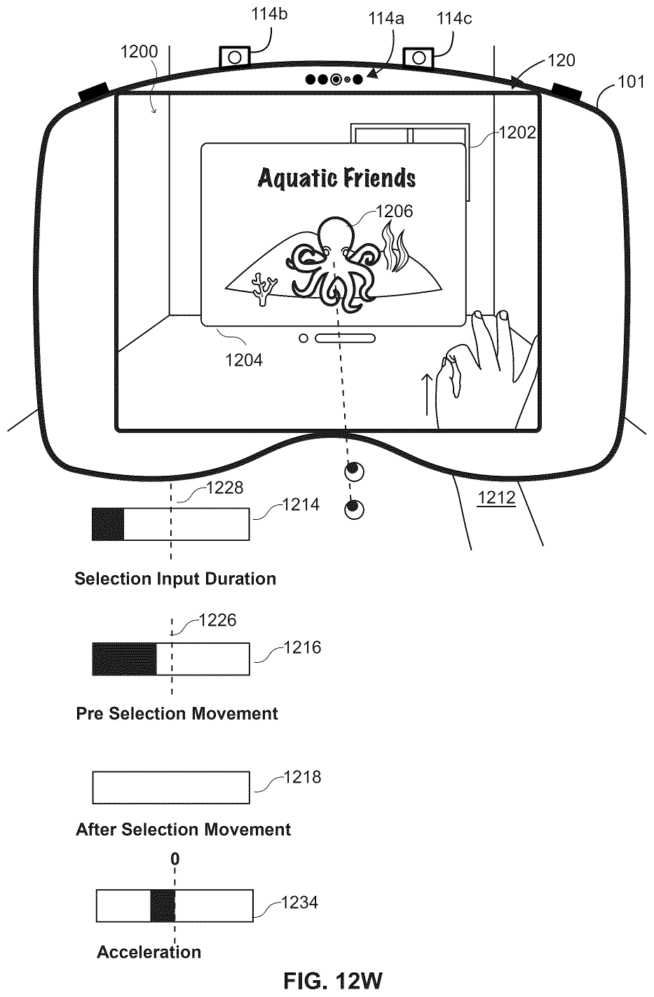

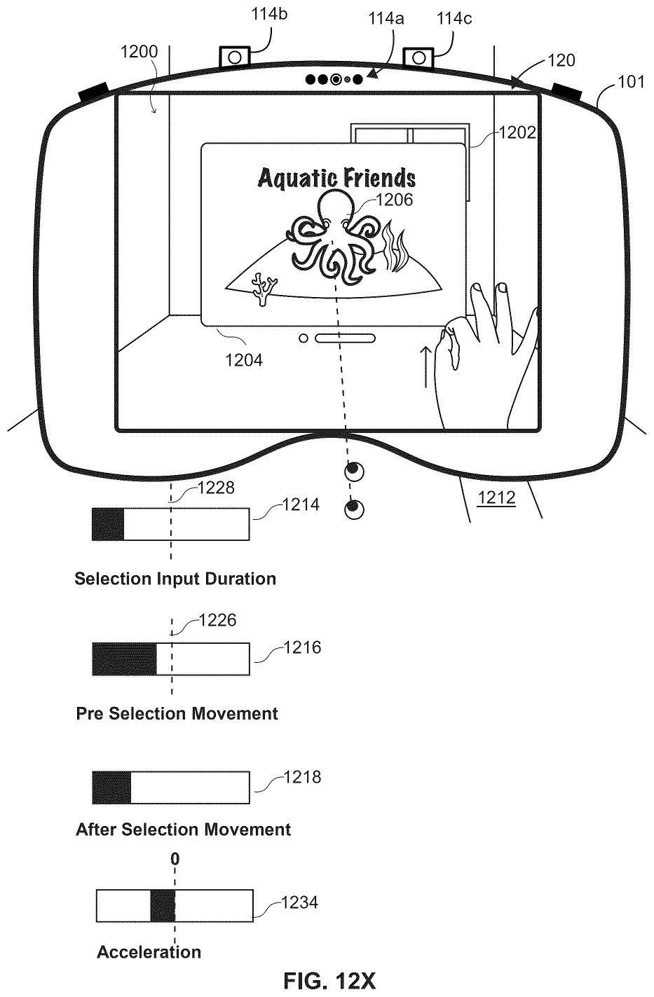

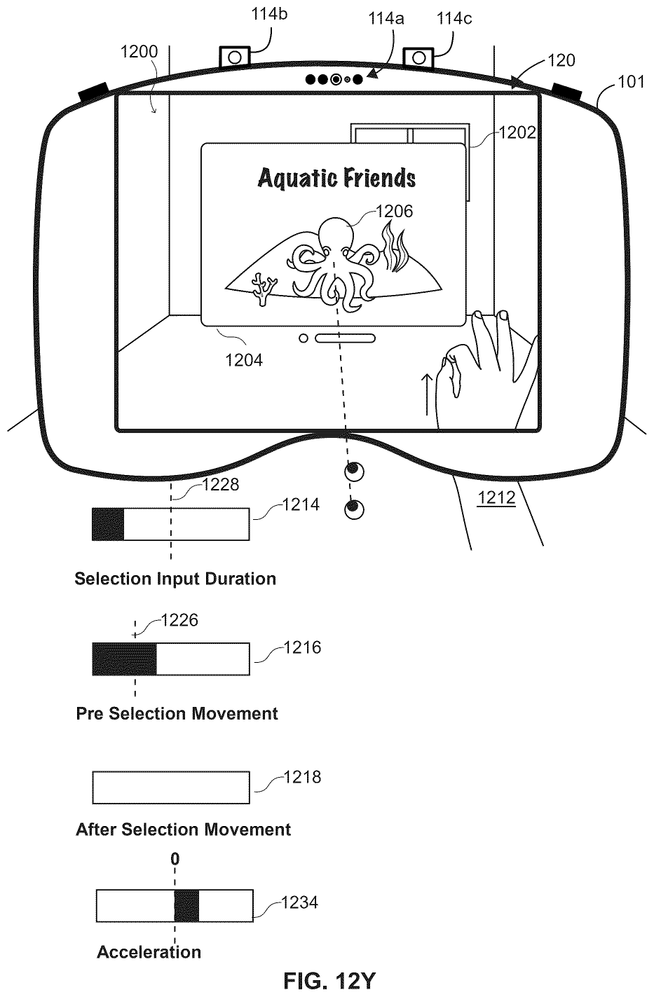

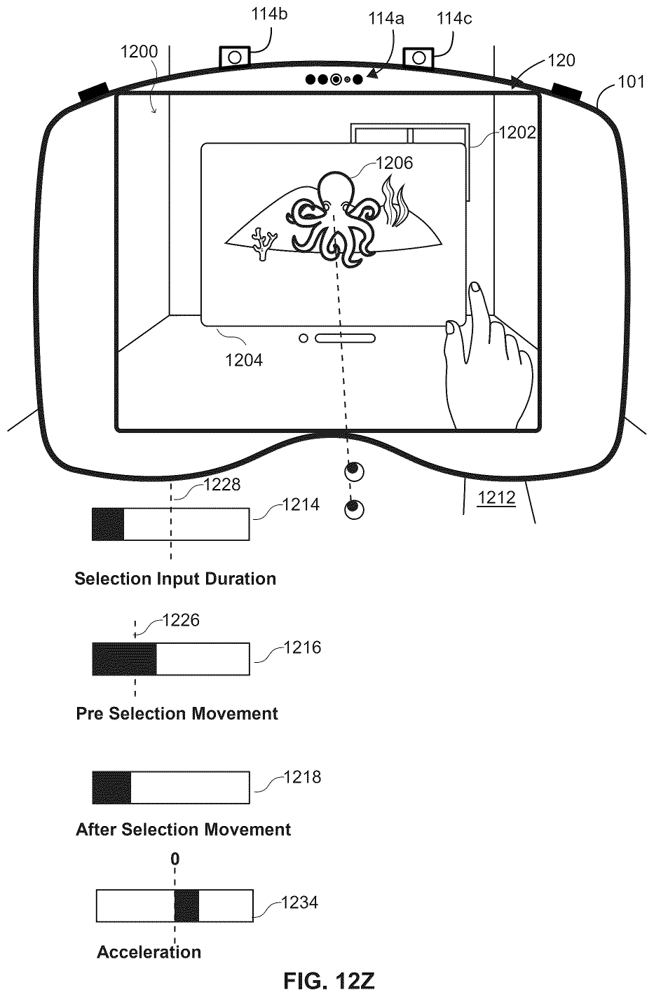

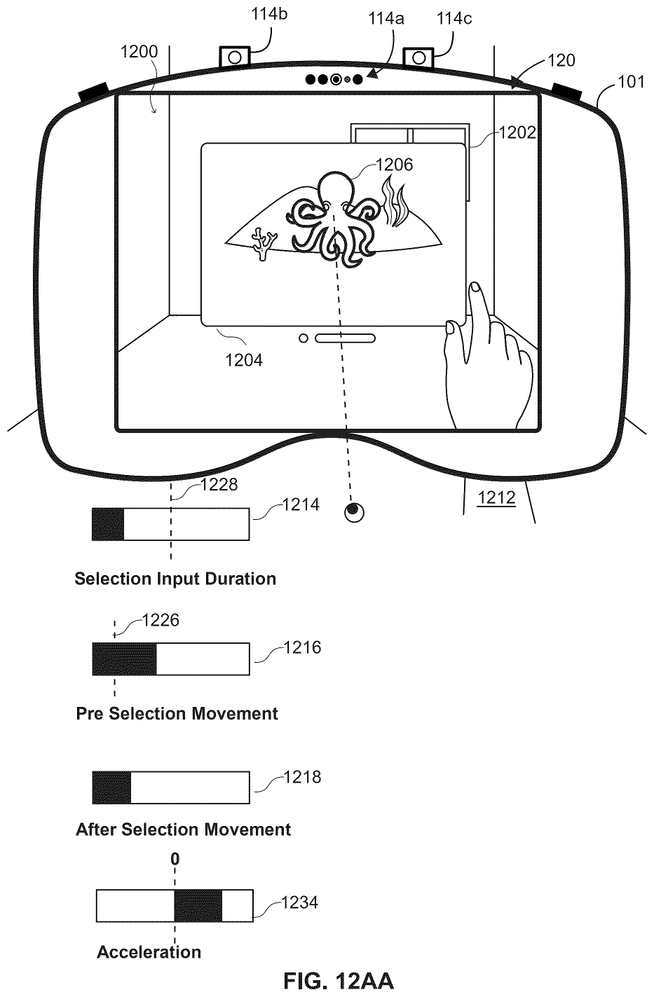

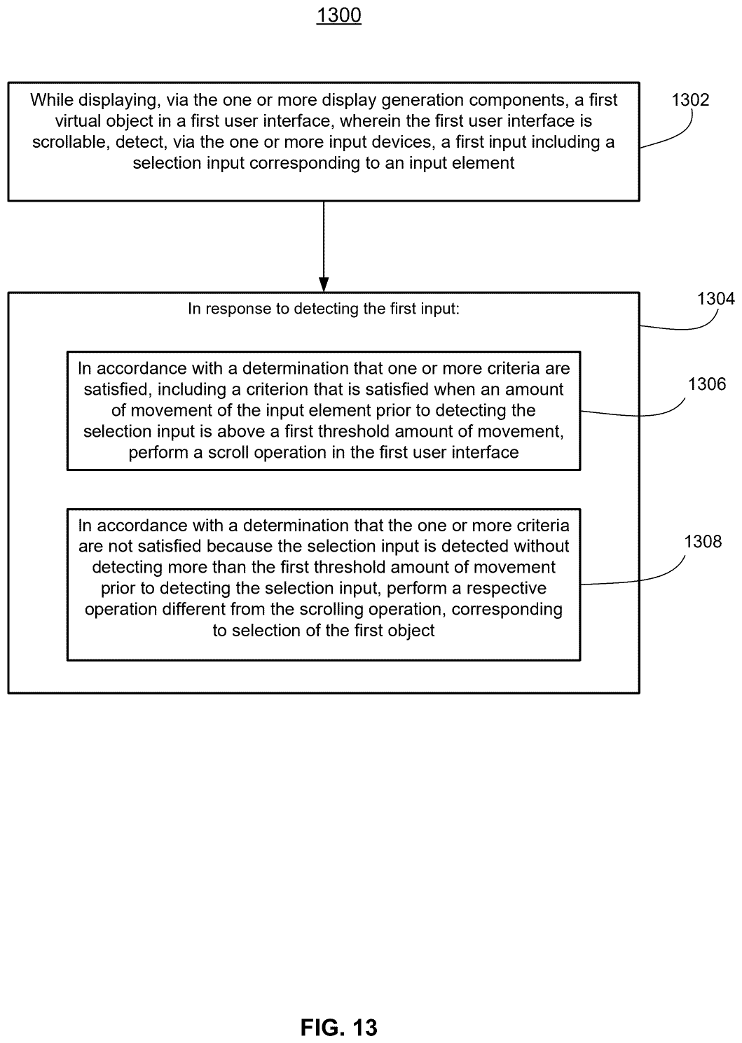

FIGS. 1A-6 provide a description of example computer systems for providing XR experiences to users (such as described below with respect to methods 700, 900, 1100, and/or 1300). FIG. 7 illustrates a method for applying a magnitude of object movement corresponding to the magnitude of input movement of an input element following detection of an input directed to a virtual object, the mapping of the input magnitude to the object movement is based on movement characteristics of the input element, and/or characteristics of the virtual object, in accordance with some embodiments. The user interfaces in FIGS. 8A-8Y are used to illustrate the processes in FIG. 7 and FIG. 9. FIG. 9 illustrates a method for selectively applying translational movements and rotational movements to a virtual object corresponding to an input received from an input element directed to the virtual object, where the application and/or magnitude of the movements to the virtual object are dependent upon a gating strategy, the type of virtual object, and/or detected movements of the input element after the detection of the input in accordance with some embodiments of the disclosure, in accordance with some embodiments. The user interfaces in FIG. 10A-10W are used to illustrate the processes in FIG. 11. FIG. 11 illustrates a method for resizing virtual objects corresponding to an input received from an input element directed to the virtual object, wherein the manner of resizing is dependent upon the type of input element, the direction in which the input element is detected as moving following detection of the input, and/or the attention of the user, in accordance with some embodiments. FIGS. 12A-12AA illustrate example techniques for disambiguating selection operations and scroll operations based on movement characteristics of an input element prior to and/or after a selection input is performed, in accordance with some embodiments. FIG. 13 illustrates a flow diagram of methods for disambiguating selection operations and scroll operations based on movement characteristics of an input element prior to and/or after a selection input is performed, in accordance with some embodiments. The user interfaces in FIGS. 12A-12AA are used to illustrate the processes in FIG. 13.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

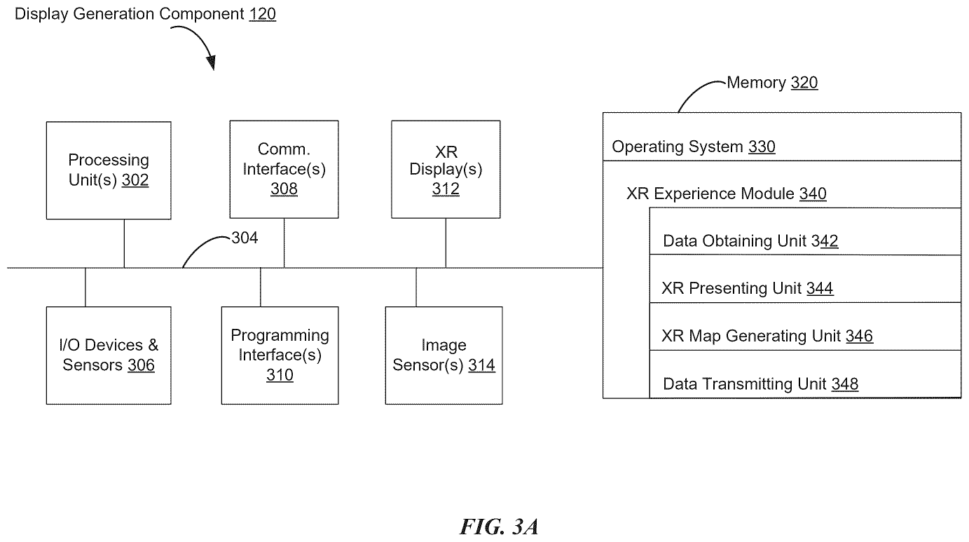

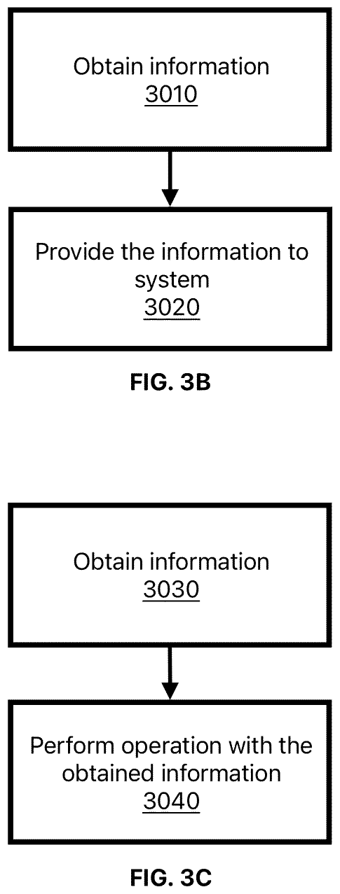

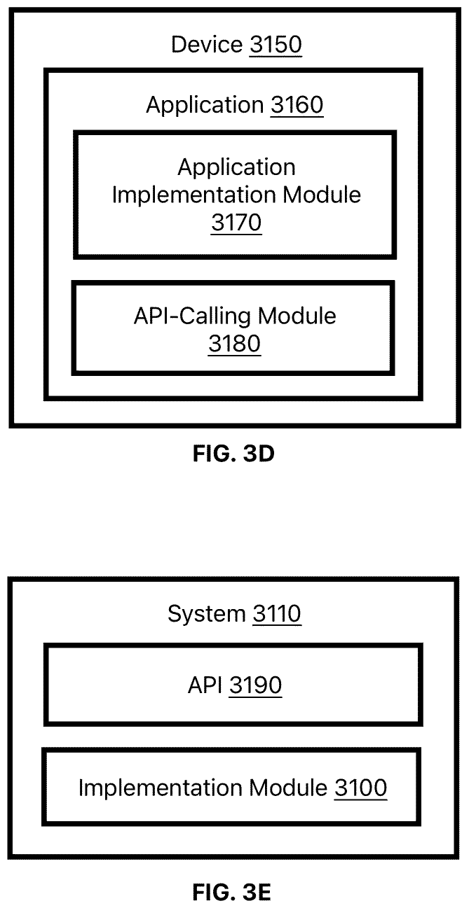

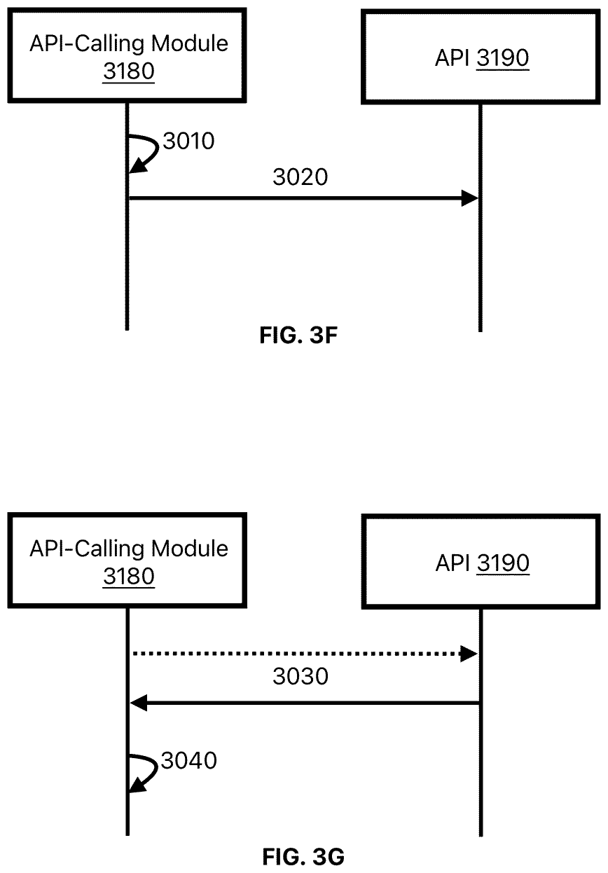

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 11) for detecting information about a physical environment of the device which can be used (optionally in conjunction with one or more illuminators such as the illuminators described in FIG. 11) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 11) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 11) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin, for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 11-1J and 1L and described herein. Likewise, any of the features, components, and/or parts, including the arrangements and configurations thereof shown and described with reference to FIGS. 11-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 11-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

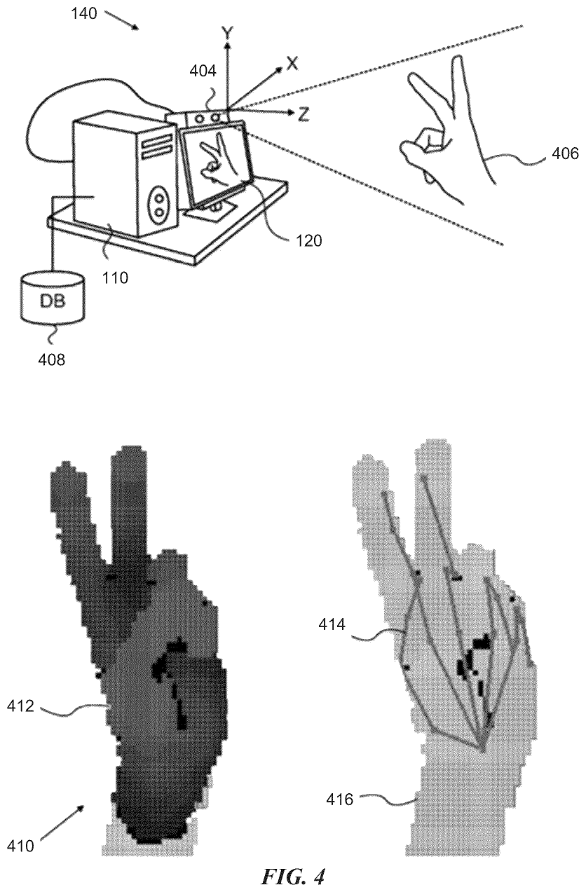

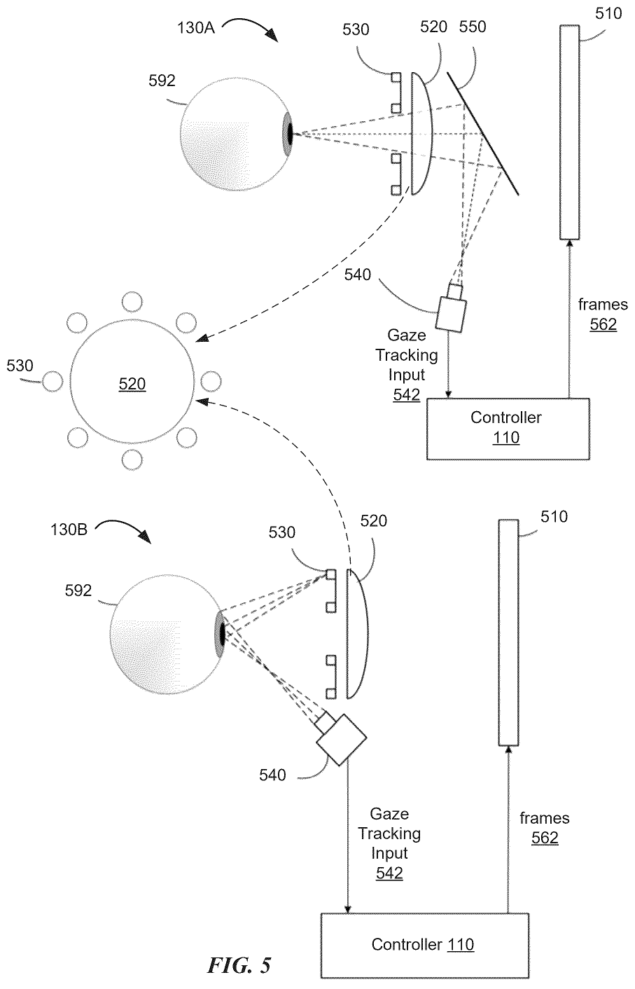

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7), method 900 (FIG. 9), method 1100 (FIG. 11), and/or method 1300 (FIG. 13), by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

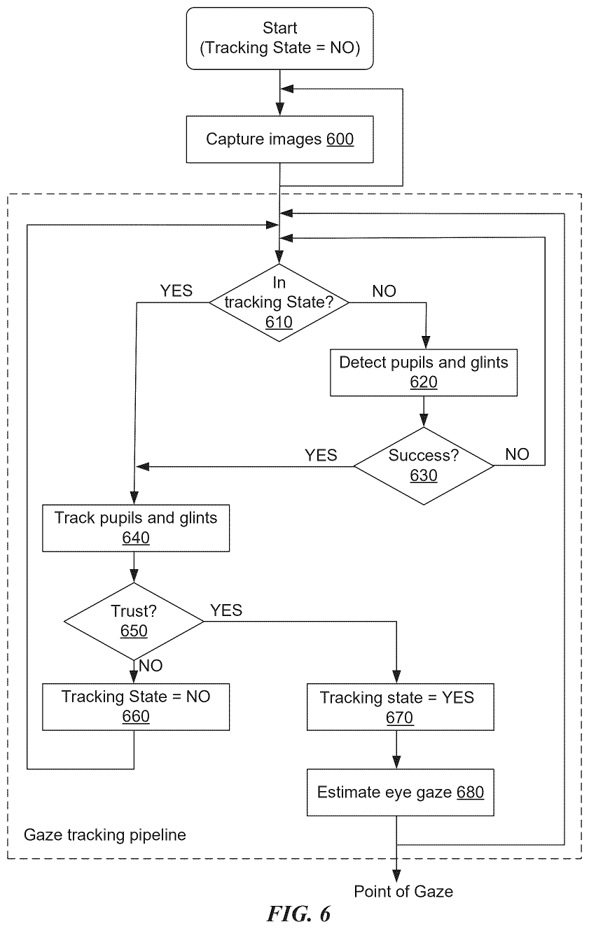

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIG. 7 is a flowchart illustrating a method of applying a magnitude of object movement corresponding to the magnitude of input movement of an input element following detection of an input directed to a virtual object, the mapping of the input magnitude to the object movement is based on movement characteristics of the input element, and/or characteristics of the virtual object, in accordance with some embodiments. In some embodiments, the method 700 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 700 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 700 are, optionally, combined and/or the order of some operations is, optionally, changed.

In some embodiments, method 700 is performed at a computer system in communication with one or more display generation components and one or more input devices. For example, a computer system, the one or more input devices, and/or the display generation component(s) have one or more characteristics of the computer system(s), the one or more input devices, and/or the display generation component(s) described with respect to methods 900, 1100, and 1300. In some embodiments the computer system is configured to provide a view of a physical environment surrounding a user, however the embodiments discussed herein are not limited thereto.

In some embodiments, the computer system displays, via the one or more display generation components, a container (e.g., a window or a volume) that includes a plurality of virtual objects (702), such as if the airplane 804 as illustrated in FIG. 8U were contained within application window 850, or as shown, for example, in FIGS. 8W-8Y with the checker pieces contained within the checkerboard. In some embodiments, displaying of a virtual object in a three-dimensional environment, the three-dimensional environment, and/or the virtual object share one or more characteristics with displaying of the virtual object in a three-dimensional environment, the three-dimensional environment, and/or the virtual object described with respect to methods 900, 1100, and/or 1300. A container optionally corresponds to an application window, immersive environment window, and/or a volume which includes one or more virtual objects.

For instance, in some embodiments the container corresponds to a representation of a board game, with a plurality of representation of game pieces associated with the representation of the board game within the container corresponding to the representation of the board game, such as, for example, in FIGS. 8W-8Y

In some embodiments, the computer system detects (704), via the one or more input devices, a first input (such as a pinch and hold gesture 808) directed to the container, followed by a movement in the depth direction directed to container, such as illustrated in FIGS. 8W-8Y. Detecting an input (e.g., first input) optionally shares one or more characteristics with detecting an input as described with respect to methods 900, 1100, and/or 1300. The first input optionally includes a selection input performed by an input element (e.g., one or more portions of the user, or remote controller) corresponding to an indication to move a container and/or one or more respective virtual objects within the container based on detected input element movements following the selection input. In some embodiments, the input element, and the selection input share one or more characteristics with the input element and the selection input described with respect to methods 900, 1100, and/or 1300. For example, the first input includes an air pinch gesture from a hand of the user detected while attention of the user is directed to the container and/or a respective virtual object within the container, followed by movement of the hand of the user while maintaining the air pinch hand gesture.

In some embodiments, in response to detecting the first input (706) (e.g., and while displaying the container that includes the one or more objects), and in accordance with a determination that the first input is a first type of input (e.g., movement toward the viewpoint of the user) that is directed to the container, the computer system moves (708) the container with a first movement (such as if movement 810a in the depth direction as shown in FIG. 8U was toward the user) that is determined based on a first mapping (such as third model 856) between a magnitude of the first input and a magnitude of the first movement, such as moving the checkerboard container in FIGS. 8W-8Y toward the viewpoint of the user. Detecting and moving one or more objects in the depth direction optionally share one or more characteristics with moving objects of a first type, and moving objects of a second type in the depth direction as described with respect method 900. When the computer system receives an indication from the user to move the container in the depth direction, the computer system optionally applies container movements in the depth direction in a different manner in contrast with a manner in which the computer system applies movements to respective virtual objects within the container in the depth direction. For instance, when the computer system receives an input from an input element (e.g., a hand of the user, and/or remote controller) directed to the container indicating movement toward the viewpoint of the user, the computer system optionally applies a first movement with a magnitude based on a first mapping between a magnitude of the first input and a magnitude of the first movement. The first mapping is optionally a first multiplier between the movement of the input element and the resulting movement of the container and/or virtual object within the container.

In some embodiments, in response to detecting the first input (e.g., and while displaying the container that includes the one or more objects), and in accordance with a determination that the first input is the first type of input (e.g., movement toward the viewpoint of the user) that is directed to a respective virtual object in the container, such as if the airplane 804 as illustrated in FIG. 8U were contained within application window 850 or such as with respect to a checkers piece within the checkerboard in FIGS. 8W-8Y, the computer system moves (710) the respective virtual object with a second movement (such as if movement 810a in the depth direction as shown in FIG. 8S was toward the user) that is determined based on a second mapping between a magnitude of the first input and a magnitude of the second movement, such as the first model 852 as illustrated in FIG. 8S, where the second mapping is different from the first mapping (e.g., the first mapping is based on a distance between a pinch point and a reference point of the user such as a torso or a shoulder and the second mapping is based on a magnitude of the input, without being based on the reference point of the user such as the torso or the shoulder). When the computer system detects an input from an input element (e.g., hand of the user performing a pinch gesture) directed to a respective virtual object within the container, and the computer system detects movement of the input element toward the viewpoint of the user (e.g., the hand of the user moving toward the user) the computer system applies a second movement to the respective object toward the viewpoint of the user with a magnitude based on a second mapping between the magnitude of the first input and the magnitude of the second movement, such as in FIG. 8X for example. In some embodiments the second mapping is different than the first mapping such that the first movement is different than (e.g., greater than, or less than) the second movement. The second mapping is optionally a second multiplier between the movement of the input element and the resulting movement of the container and/or virtual object within the container, different from the first multiplier described previously. In some embodiments, the first mapping is applied based on a measured distance between the input element (e.g., hand performing a pinch gesture) and a reference point such as the shoulder of the user. In contrast, in some embodiments, the second mapping is applied based on a magnitude of the input (e.g., movement) of the input element. In some embodiments, as related to the second mapping, the magnitude of the movement of the input element is measured in distance (e.g., meters, and/or pixels) from a reference point (e.g., corresponding to the user, corresponding to one or more virtual objects, and/or corresponding to the container), velocity (e.g., meters/s, and/or pixels/s), and/or acceleration (e.g., meters/s\hat{ }2, and/or pixels/s\hat{ }2), wherein the greater the absolute value of the magnitude of the input element movement toward the viewpoint of the user, the greater the magnitude of the container movement optionally applied by the computer system. For example, when the container corresponds to an application window including a representation of a chess board, and the container includes a plurality of representations of chess pieces on the representation of the chess board, movements applied by the computer system in response to detecting the first input indicating movement toward the viewpoint of the user are optionally applied differently to the representation of the chess board in contrast to a representation of a chess piece. Accordingly, movements in the depth direction toward the viewpoint of the user as applied to a container (e.g., chess board) are applied differently (e.g., asymmetrically) to movements as applied to the one or more virtual objects (e.g., chess pieces) in the respective container. By applying movements to a container in the depth direction toward the viewpoint of the user in a different manner (e.g., different mapping) than applying movements to respective virtual objects within the container in the depth direction toward the viewpoint of the user, the computer system optionally prevents movements of the respective virtual objects to locations outside the container.

In some embodiments, in accordance with a determination that the first input is a second type of input (e.g., movement away from the viewpoint of the user) that is directed to the container (such as if movement 810a in the depth direction as shown in FIG. 8U was away the user, and/or such as with respect to the movement of the checkerboard away from the viewpoint of the user in FIGS. 8W-8Y), the computer system moves the container with a third movement that is determined based on a third mapping (such as the fourth model as illustrated in FIG. 8U) between a magnitude of the first input and a magnitude of the third movement. In some embodiments, when the computer system detects the first input and determines that the first input corresponds to an indication to move the container in the depth direction away from the viewpoint of the user, the computer system moves the container according to a third mapping which determines the amount of movement (e.g., magnitude of the third movement) that should be applied to the container in view of the magnitude of the first input corresponding to a movement of the second type (e.g., away from the viewpoint of the user) applied to the container. In some embodiments, when moving the container in the depth direction away from the viewpoint of the user, the computer system applies a first modification factor (e.g., multiplier). The first modification factor optionally corresponds to an amplification factor (e.g., 1.2, 1.6, 2, or 4 times the container movement magnitude corresponding to the input magnitude) to increase the magnitude of the third movement in relation to the magnitude of the first input corresponding to a movement of the second type. Additionally or alternatively, the first modification factor optionally corresponds to a damping factor (e.g., 0.1, 0.3, 0.7, or 0.9 times the container movement magnitude corresponding to the input magnitude) to decrease the magnitude of the third movement in relation to the magnitude of the first input. The amplification factor and the damping factor as described optionally share one or more characteristics with the amplification factor and damping factor as described in relation to method 900.

In some embodiments, in accordance with a determination that the input is the second type of input (e.g., movement away from the viewpoint of the user) that is directed to the respective virtual object in the container (such as if movement 810a in the depth direction as shown in FIG. 8S was away from the user, and/or such as with respect to movement away from the viewpoint being directed to a checkers piece on the checkerboard as shown from FIG. 8W-8X), the computer system moves the respective virtual object with a fourth movement that is determined based on a fourth mapping (such as the second model 854 as illustrated in FIG. 8S) between a magnitude of the first input and a magnitude of the fourth movement, where the fourth mapping is different from the third mapping. When the computer system detects the first input and determines that the first input corresponds to an indication to move the respective virtual object in the depth direction away from the viewpoint of the user, the computer system moves the respective virtual object according to a fourth mapping which determines the amount of movement (e.g., magnitude of the fourth movement) that should be applied to the respective virtual object in view of the magnitude of the first input corresponding to a movement of the second type (e.g., away from the viewpoint of the user) applied to the respective virtual object. In some embodiments, the fourth mapping uses a second modification factor (e.g., amplification or damping) that is different from the first modification factor to optionally increase or decrease the magnitude of the fourth movement in relation to the magnitude of the first input in the depth direction away from the user. The modification factor optionally shares one or more characteristics (e.g., damping, and/or amplification) with the modification factor as described herein with respect to the first modification factor. For example, when the container corresponds to an application window including a representation of a chess board, and within the container a plurality of representations of chess pieces on the representation of the chess board, movements applied by the computer system in response to detecting the first input indicating movement away from the viewpoint of the user, are optionally applied differently to the representation of the chess board in contrast to the representation of a chess piece. By applying movements to a container in the depth direction away from the viewpoint of the user in a different manner (e.g., different mapping) than applying movements to respective virtual objects within the container in the depth direction away from the viewpoint of the user, the computer system optionally prevents movements of the respective virtual objects to locations outside the container.

In some embodiments, the third mapping is independent of the application to which the container corresponds, such as if the fourth model 854 were applied to movements of the container in the depth direction regardless of the type of application window 850 and/or the type of application associated with the checkerboard in FIGS. 8W-8Y (e.g., the same mapping is used for multiple different applications). In some embodiments, when the computer system applies a third movement to the container corresponding to a movement of the container away from the viewpoint of the user, the computer system applies the third movement in a manner which is agnostic to the application and/or type of application. In some embodiments, the fourth mapping is determined based at least in part on the application to which the container corresponds, such as if the second model 854 shown in FIG. 8S were modified (e.g., damped, or amplified) dependent upon one or more characteristics (e.g., internal container depth, and/or internal container width) of the application window 850 in which the airplane 804 is contained and/or of the checkerboard within which the checkers pieces are contained (e.g., the use of one or more different applications optionally corresponds to the use of different mappings in order to determine the magnitude of movement to apply to the respective virtual objects that are moved within the application volume in the depth direction). For example, in accordance with a determination that the container is associated with a first application, the fourth mapping applies the second modification factor (e.g., amplification or damping) in a manner which corresponds to the first application, and in accordance with a determination that the container is associated with a second application that is different from the first application, the fourth mapping applies the second modification factor (e.g., amplification or damping) in a manner which corresponds to the second application, such that the second modification factor corresponding to the first application is different than the second modification factor corresponding to the second application. For instance, when a first container corresponds to a representation of a poker table including representations of playing cards as respective virtual objects, and a second container corresponds to a representation of a chess board including representations of chess pieces as respective virtual objects, when the computer system detects an input of the third type (e.g., moving a container away from the viewpoint of the user), the resulting magnitude of movement applied to either the first container or the second container would optionally result in the same amount of movement of the container in the depth direction away from the viewpoint of the user. Additionally or alternatively, when the computer system detects an input of the fourth type (e.g., moving a respective virtual object away from the viewpoint of the user), the magnitude of the fourth movement applied to a representation of a playing card is optionally different than the magnitude of the fourth movement applied to a representation of a chess piece. By optionally moving containers in the depth direction away from the viewpoint of the user in a manner which is agnostic to the application to which the container(s) correspond, the computer system maintains a consistency of visual effect and user interface as associated with moving application windows and/or container. Moving respective virtual objects in containers in a manner which is specific to the particular application to which the container corresponds allows the computer system to maintain a consistency of visual effect and user interaction associated with the functionality within the container and/or application.

In some embodiments, the third mapping is independent of a size of the container, such as if the fourth model 854 were applied to movements of the container in the depth direction regardless of the size of application window 850 and/or regardless of the size of the checkerboard in FIGS. 8W-8Y (e.g., the same mapping is used for the container when the container is displayed at different sizes). Accordingly, the third mapping remains unchanged, and is agnostic to the size of the container. In some embodiments, the fourth mapping is determined based at least in part on a size of the container. For example, in accordance with a determination that the container has a first size, the fourth mapping applies the second modification factor (e.g., amplification or damping) in a manner which corresponds to the container being displayed at the first size, and in accordance with a determination that the container has a second size that is different from the first size, the fourth mapping applies the second modification factor (e.g., amplification or damping) in a manner which corresponds to the container being displayed at the second size, such that the second modification factor corresponding to the container displayed at the first size is different than the modification factor corresponding to the container displayed at the second size. In some embodiments, the size of the container is determined based on a longest axis/dimension of the container. In some embodiments, smaller containers use a greater degree of damping (or lesser degree of amplification) of the input magnitude, while larger containers use a lesser degree of damping (or greater degree of amplification) of the input magnitude in determining the magnitude of the fourth movement. For example, when the container corresponds to an application window including a representation of a chess board, and the container includes a plurality of representations of chess pieces on the representation of the chess board, movements applied by the computer system to move the representation of the chess board in the depth direction away from the viewpoint of the user is agnostic to the size of the representation of the chess board. Additionally or alternatively, movements applied by the computer system to move a representation of a chess piece is optionally dependent on the size of the board. For instance, a larger representation of a chess board (or checkerboard, such as in FIGS. 8W-8Y) corresponds to larger magnitudes of movements required to move a representation of a chess piece (or checkers piece, such as in FIGS. 8W-8Y) by a single space. Accordingly, when the representation of the chess board is a first size, the computer system determines that the magnitude of the movement to move the representation of the chess piece in the depth direction away from the user by one space is a first amount, and when the representation of the chess board is a second size, larger than the first size, the computer system determines that the magnitude of the movement to move the representation of the chess piece in the depth direction away from the user by one space is a second amount, greater than the first amount. By optionally moving containers in the depth direction away from the viewpoint of the user in a manner which is agnostic to the size of the application to which the container(s) correspond, and/or the size of the container(s), the computer system maintains a consistency of visual effect and user interface as associated with moving application windows and/or container. By moving respective virtual objects in containers in a manner which is dependent on the size of the container, allows the computer system to maintain a consistency of visual effect and user interface as associated with the functionality within the container and/or application.

In some embodiments, in response to detecting the first input, in accordance with a determination that the input is a third type of input (e.g., movement perpendicular to a direction away from a viewpoint of the user such as a change in elevation and/or yaw relative to a viewpoint of the user) that is directed to the container (such as window 850 as shown in FIG. 8U), the computer system moves the container with a fifth movement that is determined based on a fifth mapping between a magnitude of the first input and a magnitude of the fifth movement, such as if the first model 852 and/or the second model 854 as shown in FIG. 8S were applied in relation to elevation change and/or yaw such that model 852 is applied to movements (e.g., yaw and/or elevation) instructing the computer system to move the container closer to the user, and model 854 is applied to movements (e.g., yaw and/or elevation) directing the computer system to move the container further from the user. When the computer system determines that first input includes an indication to move the container in a direction which is perpendicular to the depth direction in relation to the viewpoint of the user, which optionally includes changes in elevation and/or yaw, wherein yaw optionally corresponds to lateral movements of the container in a radial manner across the field of view of the user, the computer system optionally uses a fifth mapping to determine the magnitude of the movement applied to the container in one or more directions perpendicular to the depth direction from the viewpoint of the user.

In some embodiments, in response to detecting the first input, in accordance with a determination that the input is the third type of input (e.g., movement perpendicular to a direction away from a viewpoint of the user such as a change in elevation and/or yaw) that is directed to the respective virtual object in the container, the computer system moves the respective virtual object with a sixth movement that is determined based on a sixth mapping between a magnitude of the first input and a magnitude of the sixth movement, wherein the sixth mapping the same as the fifth mapping, such as if the first model 852 and/or the second model 854 as shown in FIG. 8S were applied in relation to elevation change and/or yaw such that model 852 is applied to movements (e.g., yaw and/or elevation) instructing the computer system to move the respective virtual object closer to the user, and model 854 is applied to movements (e.g., yaw and/or elevation) directing the computer system to move the virtual object further from the user. (e.g., movement in elevation and/or yaw uses a same input mapping for both the container and the objects within the container). When the computer system determines that first input includes an indication to move the respective virtual object in a direction which is perpendicular to the depth direction in relation to the viewpoint of the user, which optionally includes changes in elevation and/or yaw, wherein yaw optionally corresponds to lateral movements the respective virtual object in a radial manner across the field of view of the user, the computer system optionally uses a sixth mapping to determine the movement applied to the respective virtual object in one or more directions perpendicular to the depth direction from the viewpoint of the user, wherein the fifth mapping is optionally the same as the sixth mapping. For instance, when the container corresponds to an application window including a representation of a chess board, and the container includes a plurality of representations of chess pieces on the representation of the chess board, movements applied by the computer system to move the representation of the chess board upward, downward, to the left, and/or to the right in relation to the viewpoint of the user, are applied in the same manner as movements are applied by the computer system to move a chess piece in corresponding directions (e.g., upward, downward, to the left, and/or to the right in relation to the viewpoint of the user). Using the same mapping for determining the magnitude of movement corresponding to the magnitude of the first input as applied to a container and the respective virtual objects in the container allows the computer system to maintain a consistency of user experience with the container and/or the respective virtual objects within the container.

It should be understood that the particular order in which the operations in method 700 have been described is merely exemplary and is not intended to indicate that the described order is the only order in which the operations could be performed. One of ordinary skill in the art would recognize various ways to reorder the operations described herein. In some embodiments, aspects/operations of method 700 may be interchanged, substituted, and/or added between these methods. For example, various object manipulation techniques and/or object movement techniques of method 700 is optionally interchanged, substituted, and/or added between these methods. For brevity, these details are not repeated here.

FIGS. 8A-8Y illustrate methods of and systems for selectively applying translational movements and rotational movements to a virtual object corresponding to an input received from an input element directed to the virtual object, where the application and/or magnitude of the movements to the virtual object are dependent upon a gating strategy, the type of virtual object, and/or in accordance with some embodiments of the disclosure.

FIG. 8A-8Y illustrate exemplary ways in which a computer system, while displaying at least a first portion of a representation of a physical environment of a user or a virtual environment, allows the user to interact with a virtual object. User interactions with the virtual object include the computer system rotating and/or translating the virtual object in response to user input from an input element (e.g., a hand of a user performing air gestures, and/or hand movements). Furthermore, the computer system determining when to translate and/or rotate a virtual object optionally depends on gating relationships between detected indications to translate a virtual object in conjunction with and/or in contrast with detected indications to rotate the virtual object. FIG. 8A-8E, FIG. 8G-8O, and FIG. 8Q-8R include a Top-Down view including the location of a virtual object (e.g., an airplane 804) within the three-dimensional environment in relation to the location corresponding to the user 805. It is understood that in some embodiments, gestures (e.g., pinch, and/or pinch-and-hold) performed by one or more portions of the user (e.g., hand of the user) with respect to the current method correspond to air gestures.

FIG. 8A illustrates the computer system 101 detecting the hand 806 of the user providing a first input which includes the computer system 101 detecting a pinch and hold gesture 808 while the gaze 814 of the user is directed to the virtual object (e.g., representation of an airplane 804) prior to translating 810a and/or rotating 812a (shown in FIG. 8B). The detection of the hand 806 performing and holding the gesture corresponds to an indication to the computer system to move the virtual object (e.g., airplane 804) in accordance with detected movements (e.g., translation, and/or rotational movements) of the hand and translate and/or rotate the virtual object accordingly.

As further illustrated in FIG. 8A, display generation component 120 displays one or more virtual objects in a three-dimensional environment 800. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 8A-8Y.

FIG. 8B illustrates the computer system 101 detecting the hand 806 of the user providing the first input while maintaining the gesture 808 including the hand 806 of the user translating 810a (e.g., moving up, down, left, right, away from the viewpoint of the user, and/or toward the viewpoint of the user) and rotating 812a (e.g., rotating about one or more axes). In the example of FIG. 8B, computer system 101 detects that the translation component 810b exceeds the threshold amount of translation 810d, before detecting the rotation component 812b, and in response translates the object 804 by an amount of translation 810c which corresponds to the translation component 810b, without rotating the object 804.

As shown in FIG. 8B, and subsequent figures, marker 840 depicts a level at which an amount of translation 810c applied to the representation of the airplane 804 corresponds with the translation component 810b. Similarly, marker 842 depicts a level at which an amount of rotation 812c applied to the representation of the airplane 804 corresponds with the rotation component 812b. For instance, as shown in FIG. 8B, the amount of translation 810c applied to the representation of the airplane 804 corresponds with the translation component 810b, and the amount of rotation 812c (e.g., zero) corresponds with the rotation component 812b.

As illustrated in FIG. 8C, when the computer system 101 detects that the translation component 810b, corresponding to the translation 810a of the hand, exceeds the threshold amount of translation 810d prior to detecting the rotation component 812b (e.g., as depicted in FIG. 8B), the computer system 101 translates the representation of the airplane 804 by a first amount of translation 810c which corresponds with the translation component 810b (see, for example, marker 840), without rotating the representation of the airplane 804. Although the computer system detects the rotation component 812b, corresponding with the hand 806 rotating, computer system 101 forgoes rotating the representation of the airplane 804 because the computer system has detected that the translation component exceeds the threshold amount of rotation prior to detecting the rotation component (e.g., as shown in FIG. 8B).

In some embodiments, as shown in FIG. 8D, when the computer system 101 detects that rotation component 812b has increased to an amount which is greater than the first threshold amount of rotation 812d, the computer system continues to forgo rotating the representation of the airplane 804 due to the translation component exceeding the first threshold amount of translation 810d. In order for the computer system to rotate in response to detecting the rotation component of the hand of the user, the computer system optionally requires that the rotation component be detected prior to the translation component exceeding the threshold amount of translation.

As illustrated in FIG. 8E, following detecting of the gesture 808 (e.g., as shown in FIG. 8A), when the computer system detects that the translation component 810b does not exceed the threshold amount of translation 810d, and the rotation component 812b exceeds the threshold amount of rotation 812d, the computer system translates the representation of the airplane 804 by an amount of translation 810c corresponding to the translation component 810b (see, for example, marker 840), and rotates the representation of the airplane 804 by an amount of rotation 812c which corresponds to the rotation component 812b (see, for example, marker 842).

The rotation and/or translation components of the input, as detected by the computer system, are optionally tracked in reference to one or more parts of the user as illustrated in FIG. 8F. FIG. 8F (which includes FIGS. 8F1-8F4) illustrates that various movements of the hand and/or arm of the user (e.g., rotation, and/or translation) detected by the computer system 101 are optionally based on rotational movements and/or translation movements corresponding to different portions of the user. FIG. 8F-1 illustrates the rotational and translational movements of the hand of the user being detected at location 816a which corresponds with a location where the finger and thumb of the user meet when performing the pinch and hold gesture 808 of the gesture 808 with the hand 806. When the computer system determines a translation component of the hand and/or arm of the user in relation to a location (e.g., 816a) the computer system detects a change in position of the location 816a laterally, vertically, and/or in the depth direction in relation to the viewpoint of the user as seen in FIG. 8F-1 for instance in relation to a first time, a second time, and third time. When the computer system determines a rotation component of the hand and/or arm of the user in relation to a location (e.g., 816a) the computer system detects a change in position of the one or more parts of the user (e.g., hand, wrist, elbow, and/or arm) rotationally about the location (e.g., 816a). FIG. 8F-2 illustrates the rotational and translational movements of the hand 806 of the user being detected at a location 816b which corresponds with one or more knuckles of the hand 806 of the user. FIG. 8F-3 illustrates the rotational and translational movements of the input element, corresponding to the arm 807 of the user being detected at a location 816c which corresponds with a wrist of the user. FIG. 8F-4 illustrates the rotational and translational movements of the input element, corresponding to the arm 807 of the user being detected at a location 816d which corresponds with an elbow of the user.

In some embodiments, when the translation component and the rotation component are both detected by the computer system as being below the threshold amounts of translation and rotation respectively, the computer system optionally translates the virtual object by an amount which corresponds to the translation component, and rotates the virtual object by an amount with corresponds to the rotation component reduced (e.g., damped) by one or more factors as illustrated in FIG. 8G. As illustrated in FIG. 8G, following the detecting of the gesture 808 (e.g., as shown in FIG. 8A), computer system 101 detects input from the hand 806 of the user, including the translation component 810b which is less than the first threshold of translation 810d, and the rotation component 812b which is less than the first threshold of rotation 812d. In accordance with the translation component 810b and the translation component 812b being non-zero, the computer system translates the representation of the airplane 804 in by an amount of translation 810c which corresponds with the translation component 810b (see, for example, marker 840), and the computer system rotates the representation of the airplane 804 by an amount of rotation 812c which corresponds with the rotation component 812b reduced by a first damping factor. A damping factor corresponds to a modifier (e.g., multiplier or other modifier or modification function) which is applied by the computer system to the magnitude of the rotation component and/or the translation component to reduce the amount of object movement (e.g., object rotation, and/or object translation) that is applied to the virtual object in relation to the input component (e.g., rotation component, and/or translation component). Accordingly, the amount of rotation 812c by which the computer system 101 rotates the representation of the airplane 804 is less than the amount corresponding to the rotation component 812b (see, for example, marker 842).

While the rotation of the virtual object is damped, when the rotation component increases, the computer system optionally applies a second damping factor when further rotation is detected, but the rotation component remains below the threshold amount of rotation as illustrated in FIG. 8H. In the example of FIG. 8H, while the representation of the airplane 804 is displayed with an amount of rotation corresponding to the rotation component 812b reduced by the first damping factor (e.g., as shown in FIG. 8G), when the computer system 101 detects that the rotation component 812b increases and the rotation component 812b remains below the first threshold of rotation 812d, and the translation component 810b remains below the first threshold of translation 810d, the computer system increases the rotation amount 812c applied to the representation of the airplane 804 corresponding to the rotation component 812b reduced by a second damping factor, which is optionally different than, and optionally greater than, the first damping factor. Accordingly, the amount of object rotation 812c by which the computer system 101 rotates the representation of the airplane 804 in relation to the orientation as shown in FIG. 8H is less than the amount corresponding to the rotation component 812b (see, for example, marker 842).

However, when the rotation component is detected as exceeding the threshold amount of rotation, while the translation component remains below the threshold amount of translation, the computer system rotates the virtual object by an amount of rotation which corresponds with the rotation component. As illustrated in FIG. 8I, while the representation of the airplane 804 is displayed with an amount of rotation 812c which corresponds with the rotation component 812b reduced by a damping factor (e.g., first damping factor and/or second damping factor) such as shown in FIGS. 8G-8H, when the computer system 101 detects that the rotation component 812b exceeds the threshold amount of rotation 812d, while the input continues (e.g., while the hand of the user 806 continues to hold the pinch and hold gesture 808), the computer system rotates the representation of the airplane 804 by an amount of rotation 812c which corresponds to the rotation component 812b (see, for example, marker 842). Accordingly, the computer system rotates the airplane 804 by an amount of object rotation 812c corresponding to the magnitude of the rotation component 812b without applying a damping factor to the amount of object rotation. For example, when the threshold amount of rotation is 30 degrees, and the rotation component was previously at 29 degrees, the computer system optionally displays the airplane 804 with a damping factor which results in object rotation of 18 degrees. When the computer system detects the rotation component subsequently at 31 degrees, thus satisfying the rotation threshold of rotation, the computer system optionally displays the airplane 804 with a rotation of 31 degrees.

After the rotation component exceeds the threshold amount of rotation during the first input, and while the translation component remains below the threshold amount of rotation, the computer system rotates the virtual object by an amount which corresponds to the rotation component. As illustrated in FIG. 8J, once the computer system 101 rotates the representation of the airplane 804 by an amount of rotation 812c which corresponds to the rotation component 812b as a result of detecting that the rotation component 812b exceeds the first threshold of rotation 812d, the computer system continues to rotate the representation of the airplane 804 by an amount of rotation 812c which corresponds to the rotation component 812b. As illustrated in FIG. 8J, the computer system continues to rotate the representation of the airplane 804 by an amount of rotation 812c which corresponds to the rotation component 812b (see, for example, marker 842) while the hand gesture 808 is maintained (e.g., the first input continues). Rotating the representation of the airplane 804 by an amount of rotation 812c corresponding to the rotation component 812b after the rotation component exceeds the threshold amount of rotation 812d, optionally includes rotating the airplane 804 by an amount of object rotation 812c corresponding to the rotation component 812b, even when the rotation component is detected below the threshold amount of rotation 812d during the first input subsequent to the rotation component exceeding the threshold amount of rotation.

After the rotation component exceeds the threshold amount of rotation during the first input, and while the translation component remains below the threshold amount of rotation, the computer system continues to rotate the virtual object by an amount which corresponds to the rotation component, even when the rotation component is detected as dropping below the threshold amount of rotation. As illustrated in FIG. 8K, after the rotation component 812b is detected as exceeding the threshold amount (e.g., as shown in FIG. 8I) of rotation 812d, while the input continues (e.g., while the hand of the user 806 continues to hold the pinch and hold gesture 808) and the rotation component 812b decreases below the threshold amount of rotation 812d, the computer system rotates the representation of the airplane 804 by an amount of rotation 812c which corresponds to the rotation component 812b (see, for example, marker 842) as shown in FIG. 8K, below threshold amount of rotation 812d.

However, in some embodiments, when the computer system detects that the translation component exceeds the threshold amount of translation, the computer system optionally locks the rotation of the virtual object and prevents further rotation of the virtual object. As illustrated in FIG. 8L, while the representation of the airplane 804 is displayed in a rotated orientation (e.g., damped, or in accordance with the rotation component) due to rotations applied during the first input, such as shown in FIG. 8G-8K for instance, while the first input continues and when the computer system 101 detects that the hand of the user 806 exceeds the threshold amount of translation 810d as illustrated in FIG. 8L, the computer system 101 locks 844 the rotation of the representation of the airplane 804 and forgoes any additional increase or decrease of the rotation component (see, for example, marker 842).

As illustrated in FIG. 8M, while the rotation of the representation of the airplane 804 is locked 844, when the computer system 101 detects that the rotation component has changed (e.g., increased), the computer system 101 forgoes changing the rotation amount 812c applied the representation of the airplane 804 (see, for example, marker 842) as the translation component was detected as exceeding the threshold amount of translation (e.g., as shown in FIG. 8L).

In some embodiments, when the computer system detects that the translation component exceeds the threshold amount of translation, the computer system optionally reverts the rotation of the virtual object to an orientation of the virtual object prior to the first input was detected (e.g., as shown in FIG. 8A), even without corresponding rotation of the hand of the user. As illustrated in FIG. 8N, while the representation of the airplane 804 is displayed in a rotated orientation (e.g. as shown in FIG. 8K), when the computer system detects that the translation component 810b exceeds the first threshold amount of translation 810d, the computer system reduces the rotation amount 812c applied to the representation of the airplane 804 over time. As shown, over a period of time 848, the orientation of the representation of the airplane 804 gradually reverts back to a non-rotated orientation (e.g., orientation of the representation of the airplane 804 prior to rotation in accordance with rotation 812a of the hand of the user during the first input), such as the orientation shown in FIG. 8A. In FIG. 8N, the amount of time 846 which has elapsed is less than the period of time 848; as such, the computer system has partially reverted the orientation of the representation of the airplane 804 to the non-rotated orientation.

As illustrated in FIG. 8O, when the time elapsed 846 from when the computer system detected that the translation component 810b exceeded the first threshold amount of translation 810d is equal to or greater than the period of time 848, the computer system has completely reverted the orientation of the representation of the airplane 804 to the non-rotated orientation. In some embodiments, when the threshold of translation 810d is detected by the computer system 101 as exceeded by the translation component 810b corresponding to the translation 810a of the hand of the user such as shown in FIG. 8H, the computer system 101 rotates the representation of the airplane back to the non-rotated orientation instantly (e.g., without displaying partial rotation prior to displaying the representation of the airplane 804 in the non-rotated orientation).

When the computer system receives an indication to rotate the virtual object, the pivot point about which the computer system rotates the virtual object optionally includes the context of the computer system detecting: the center of the virtual object, the attention of the user being directed to the virtual object, the attention of the user being directed to a portion of the virtual object, and/or the attention of the user being directed to a portion of the physical environment of the user not corresponding to the virtual object. FIG. 8P (collectively referencing FIG. 8P-1-8P-4) illustrates alternative points of rotation (e.g., pivot point) which the computer system 101 rotates the airplane. Additionally or alternatively, as illustrated in FIG. 8P-1, when the computer system detects the gaze 814 of the user directed toward the representation of the airplane 804, the computer system optionally rotates the representation of the airplane 804 about the center 820a of the representation of the airplane 804. Additionally or alternatively, as illustrated in FIG. 8P-2, when the computer system 101 detects that the gaze 814 of the user is directed toward a particular location on the representation of the airplane 804 such as the wingtip 820b, the computer system rotates the representation of the airplane 804 about a point 821 on the representation of the airplane 804 coinciding with the axis, between the center 820a, and the wingtip 820b (e.g., an axis 822 between the wingtip 820b and the center 820a of the representation of the airplane). Additionally or alternatively, as illustrated in FIG. 8P-3, when the computer system 101 detects that the gaze 814 of the user is directed toward a particular location on the representation of the airplane 804 such as the tail 820c, the computer system rotates the representation of the airplane 804 about a point 821, which does not coincide with the representation of the airplane 804, coinciding with an axis 822, between the center 820a, and the tail 820c (e.g., an axis between the tail 820c and the center 820a of the representation of the airplane). Additionally or alternatively, as illustrated in FIG. 8P-4, when the computer system 101 detects that the gaze 814 of the user is directed toward a point 820d in the three-dimensional environment which does not coincide with the representation of the airplane 804, the computer system rotates the representation of the airplane 804 about a point 821, which does not coincide with the representation of the airplane 804, coinciding with the axis 822, between the center 820a, and the point 820d within the three-dimensional environment (e.g., an axis 822 between the point 820d and the center 820a of the representation of the airplane).

When the computer system detects that the input element (e.g., hand of the user) ceases to perform the gesture to translate and/or rotate the virtual object (e.g., gesture 808), the computer system determines that the first input has been terminated and forgoes translating and/or rotating the virtual object. A subsequent indication (e.g., gesture 808) to translate and/or rotate is determined to correspond to a subsequent input (e.g., second input). As illustrated in FIG. 8Q, when the computer system 101 detects that the hand 806 of the user is no longer holding the pinch and hold gesture (808 at FIG. 8A-8M), the computer system 101 forgoes rotating the representation of the airplane 804 in accordance with movements of the hand 806 of the user (e.g., rotation component 812b corresponding to the rotation 812a of the hand 806 of the user, and/or translation component 810b corresponding to the translation 810a of the hand 806 of the user).

As illustrated in FIG. 8R, following the release of the pinch and hold gesture (e.g., as shown in FIG. 8P), the rotation 812a of the hand 806 of the user increases, however the computer system 101 forgoes rotating the representation of the airplane 804 in accordance with the rotation component 812b as the hand 806 of the user is no longer holding the pinch and hold gesture (808 at FIG. 8A-8M). Accordingly, when the computer system detects that the hand of the user translates 810a and/or rotates 812a, the computer system forgoes translating and/or rotating the representation of the airplane 804 (see, for example, marker 840, and/or marker 842).

In some embodiments the computer system optionally translates virtual objects in a depth direction differently than those discussed and illustrated with respect to preceding figures FIG. 8A-FIG. 8R. Translations of virtual objects in the depth direction detected by the computer system optionally depend upon the object type. In the following figures (FIG. 8S-8V), translations in the depth direction corresponding to a representation of an object or representation of a physical object are optionally performed according to a first model, and translations in the depth direction corresponding to an application window or container (e.g., an application window which includes a plurality of virtual objects) are performed in accordance with a second model.

As illustrated in FIG. 8S, when the computer system 101 receives an indication to translate (e.g., translational movement 810a of the hand 806 of the user) a virtual object of a first type (e.g., representation of the airplane 804) in the depth direction, the computer system 101 translates the representation of the airplane 804a toward the viewpoint of the user according to a first model 852, and translates the representation of the airplane away from the viewpoint of the user according to a second model 854, which is the same as the first model 852 in reverse. For instance, as shown in FIG. 8T (collectively referencing FIG. 8T-1-8T-5), the plane begins at a distance from the user with the arm 807 of the user at full extension (e.g., as shown in FIG. 8T-1). Although mappings including the context of arm length and/or arm extension are presented in relation to FIG. 8, alternative mapping between the magnitude of object movement corresponding to the magnitude of the magnitude of the user input (e.g., hand translation in the depth direction) are within the spirit and scope of the present disclosure. Alternative mappings between the magnitude of object movement corresponding to the magnitude of the magnitude of the user input optionally include factors corresponding to the distance, speed, and/or acceleration of the hand of the user which are optionally independent of arm length and/or arm extension. As shown, when the computer system detects that the hand 806 of the user is halfway between the distance of the hand from the user shown in FIG. 8T-1 and the user, the computer system has translated the representation of the plane 804 half the distance from starting location (e.g., as shown in FIG. 8T-1) to the user as shown in FIG. 8T-2. When the computer system detects that the hand 806 of the user is no longer extended as shown in FIG. 8T-3, the computer system has translated the representation of the plane 804 to close to the remainder of the distance between the user and the representation of the plane 804. Similarly, FIG. 8T-3-FIG. 8T-5 illustrate the model by which the computer system translates the representation of the plane away from the user using the second model 854 which is the same as the first model in reverse.

As illustrated in FIG. 8U, when the computer system 101 receives an indication to translate (e.g., translational movement 810a of the hand 806 of the user) a virtual object of a second type (e.g., application window 850) in the depth direction, the computer system 101 translates the application window 850 toward the viewpoint of the user in accordance with a third model 856, and translates the application window 850 away from the viewpoint of the user in accordance with a fourth model 858, such that the fourth model 858 is different than the third model 856. In some embodiments, the fourth model corresponding to moving an application window away from the viewpoint of the user is optionally the same as the second model for moving virtual objects away from the viewpoint of the user. For instance, as illustrated in the FIG. 8V (referencing FIG. 8V-1-FIG. 8V-5 collectively), the application window 850 begins at a distance from the user with the arm 807 of the user at full extension (e.g., as shown in FIG. 8V-1). When the computer system detects that the hand 806 of the user halfway between the distance of the hand from the user shown in FIG. 8V-1 and the user, the computer system has translated the application window 850 all the way back to the location corresponding to the user as shown for instance in FIG. 8V-2. For movements to the application window 850 away from the viewpoint of the user, the application window begins at the location corresponding to the user with the hand of the user at the side of the user as shown in FIG. 8V-3. When the user translates the application window 850 away in the depth direction, when the computer system detects the arm 807 of the user is at half extension, the computer system has translated the application window 850 half the distance away from the user as shown for instance in FIG. 8V-4. When the computer system detects that the arm 807 of the user is at full extension, the computer system has translated the application window the remainder of the distance away from the user.

Although scenarios discussed herein include virtual objects being translated in the depth direction in accordance with a first model and second model (e.g., as shown in FIG. 8S-8T) which are optionally symmetric with respect to translations toward and away the user in the depth direction, in some embodiments the computer system optionally translates virtual objects within an application window and/or container in a manner corresponding to the third model and the fourth model as described with respect to FIG. 8U-8V. Furthermore, the computer system optionally translates virtual object within an application window and/or container in a manner which corresponds with the third model and the fourth model which have been reduced and/or scaled in a manner corresponding to one or more factors optionally including one or more dimensions of the application window and/or container in the depth direction, as described in more detail with reference to method 700.

FIG. 8W illustrates, the attention (e.g., based on gaze) of the user being optionally directed to a container 860 (e.g., directed to the movement element of the container) corresponding to an application which includes a representation of a checker board 862 with a plurality of checker pieces 864. When the computer system detects that the attention of the user was directed to a portion of the container 860 (e.g., directed to the movement element of the container) when an input from hand 806 is detected (e.g., an air pinch and drag movement), the computer system moves the container based on a magnitude of movement of the hand 806 mapped to a magnitude of movement of the container. When the computer system detects that the attention of the user was directed to a checker piece 864 when the input from the hand is detected, the computer system moves the checker piece 864 (e.g., without moving the container), based on a magnitude of movement of the hand 806 mapped to a magnitude of movement of the checker piece 864.

FIG. 8X illustrates the result of the input in FIG. 8W in which the gaze 814 of the user was directed to a checker piece 864 when the input from the hand was detected in FIG. 8W. Accordingly, the computer system moves the checker piece 864 (e.g., without moving the container) based on a magnitude of movement of the hand 806 mapped to a magnitude of movement of the checker piece 864. Thus, the computer system changes the spatial relationship (e.g., relative positions and/or orientations) between the moved checker piece 864 and the checkboard 862 based on the movement of the hand, without changing the spatial relationship between the checkerboard 862, the unmoved checker pieces 864 and the viewpoint of the user.

FIG. 8Y illustrates the result of the input in FIG. 8W in which the gaze 814 of the user was directed to the container 860 (e.g., directed to the movement element of the container) when the input from the hand was detected in FIG. 8W. Accordingly, the computer system moves the container 860, including the checkers pieces 864, based on a magnitude of movement of the hand 806 mapped to a magnitude of movement of the container 860. Thus, the computer system changes the spatial relationship (e.g., relative positions and/or orientations) between the checkboard 862, the checkers pieces and the viewpoint of the user based on the movement of the hand, without changing the spatial relationship between the checkerboard 862 and the checkers pieces 864.

FIG. 9 is a flowchart illustrating a method of selectively applying translational movements and rotational movements to a virtual object corresponding to an input received from an input element directed to the virtual object, where the application and/or magnitude of the movements to the virtual object are dependent upon a gating strategy, the type of virtual object, and/or detected movements of the input element after the detection of the input, in accordance with some embodiments. In some embodiments, the method 900 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 900 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 900 are, optionally, combined and/or the order of some operations is, optionally, changed.

In some embodiments, method 900 is performed at a computer system in communication with one or more display generation components, and one or more input devices. For example, a computer system, the one or more input devices, and/or the one or more display generation components have one or more characteristics of the computer system(s), the one or more input devices, and/or the one or more display generation components(s) described with reference to FIG. 1-FIG. 2. In some embodiments the computer system is configured to provide a view of a physical environment surrounding a user, however the embodiments discussed herein are not limited thereto. In some embodiments: the computer system, the one or more display generation components, and the one or more input devices share one or more characteristics with the computer systems described with respect to methods 700, 1100, and/or 1300. For example, a mobile device (e.g., a tablet, a smartphone, a media player, and/or a wearable device), or a computer or other computer system. In some embodiments, the one or more display generation components is a display integrated with the computer system (optionally a touch screen display), external display such as a monitor, projector, television, or a hardware component (optionally integrated or external) for projecting a user interface or causing a user interface to be visible to one or more users, etc. In some embodiments, the one or more input devices include a computer system or component capable of receiving a user input (e.g., capturing a user input, and/or detecting a user input,) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, and/or a hand motion sensor), etc. In some embodiments, the computer system is in communication with a hand tracking device (e.g., one or more cameras, depth sensors, proximity sensors, and/or touch sensors (e.g., a touch screen, and/or trackpad)). In some embodiments, the hand tracking device is a wearable device, such as a smart glove. In some embodiments, the hand tracking device is a handheld input device, such as a remote control or stylus.

In some embodiments, the computer system displays (902), via the one or more display generation components, a virtual object in a three-dimensional environment (such as airplane 804 in FIG. 8A).

In some embodiments, the computer system detects (903), via the one or more input devices, a first input (e.g., first pinch-and-hold, a touch and drag input at a location of the virtual object, or a mouse click and drag input when the cursor is located at a position corresponding to the virtual object) directed to the virtual object (such as gesture 808 in FIG. 8C) that includes a translation component (such as 810b in FIG. 8C) (e.g., a non-zero translation component) and a rotation component (such as 812b in FIG. 8C) (e.g., a non-zero rotation component). For instance, when the user's attention is directed toward the virtual object, the hand of the user performs a pinch-and-hold gesture, and while holding the pinch-and-hold gesture, the computer system detects the hand of the user moving in a translative manner in one or more directions, and the computer system detects the hand of the user moving in a rotative manner about one or more axes of rotation, and/or one or more points of rotation. For instance, the motion associated with the user moving their hand laterally in front of their body optionally includes translation component due to intentional translative movement, and a rotation component due to natural physiological mechanics and limitations of the body of the user.

In some embodiments, displaying of a virtual object in a three-dimensional environment, the one or more display generation components, and the virtual object share one or more characteristics with displaying of the virtual object in a three-dimensional environment, the one or more display generation components, and the virtual object with respect to methods 700, 1100, and/or 1300. In some embodiments, the three-dimensional environment at least partially incorporates a representation of the real-world physical environment of the user while using the computer system (e.g., via active or passive passthrough). Additionally or alternatively, the three-dimensional environment is a purely virtual environment (e.g., the environment does not include representations of the physical environment of the user). In some embodiments, the virtual object refers to one or more of objects, content windows, and/or other virtually rendered content (e.g., content that is a representation of the real-world physical environment). Optionally, while the virtual object is displayed via the one or more display generation components of the computer system, the computer system further detects one or more portions of a user. The one or more portions of the user optionally include one or more portions of a body of the user (e.g., hand(s), wrist(s), forearm(s), elbow(s), arm(s), head, leg(s), foot and/or feet). In some embodiments the one or more portions of the user share one or more characteristics of the one or more portions of the user described with respect to methods 700, 1100, and/or 1300. For example, the three-dimensional environment is an extended reality (XR) environment, such as a virtual reality (VR) environment, a mixed reality (MR) environment, or an augmented reality (AR) environment. In some embodiments, the three-dimensional environment at least partially or entirely includes the physical environment of the user of the computer system. For example, the computer system optionally includes one or more outward facing cameras and/or passive optical components (e.g., lenses, panes or sheets of transparent materials, and/or mirrors) configured to allow the user to view the physical environment and/or a representation of the physical environment (e.g., images and/or another visual reproduction of the physical environment). In some embodiments, the three-dimensional environment includes one or more virtual objects and/or representations of objects in a physical environment of a user of the computer system.

In some embodiments, in response to detecting the first input (904), in accordance with a determination that more than a first threshold amount of translation is detected in the translation component of the first input prior to detecting the rotation component of the first input (such as illustrated in FIG. 8B), the computer system translates the virtual object within the three-dimensional environment in accordance with the translation component of the first input (e.g., translating the virtual object in a direction based on the direction of the translation component and/or translating the virtual object by an amount based on an amount of the translation component) without rotating the virtual object (about an axis of the object) in accordance with the rotation component of the first input (906), such as illustrated in FIG. 8C wherein the rotation component 812b is non-zero, and the computer system forgoes rotating the airplane 804).

When the computer system detects that the one or more portions of the user (e.g., a first hand of the user) is detected as performing the first gesture (e.g., air-pinch of a thumb and a finger), the computer system optionally applies the detected movement(s) (e.g., input element translation, and/or input element rotation) of the one or more portions of the user to corresponding movement(s) of the virtual object.

The computer system optionally determines when movements of the one or more portions of the user corresponding to one or more input element translation inputs (e.g., translation of the hand of the user) such as movement(s) across (e.g., up, down, left, and/or right) a field of view the computer system from the viewpoint of the user, and/or toward and/or away from a location corresponding to the location (e.g., viewpoint) of the user, exceed a first threshold amount of translation. In some embodiments, the translation component corresponds to the direction and/or the magnitude of the movement of the one or more portions of the user (e.g., first hand) while performing the first gesture (e.g., air-pinch). Furthermore, the computer system optionally determines when movements of the user corresponding to one or more input element rotation inputs (e.g., rotation of the hand of the user) such as corresponding to rotation of the one or more portions of the user, exceed a first threshold amount of rotation. In some embodiments, the rotation component corresponds to the direction of rotation and/or the magnitude of rotation of the one or more portions of the user (e.g., first hand) about an axis and/or point. For instance, the rotation component optionally corresponds to the first hand of the user rotating about a point corresponding to the virtual object and/or an axis (e.g., axis extending along a length of a forearm of the user).

In some embodiments, the direction and/or magnitude of the translation component corresponds to the direction and/or magnitude of the movement of the one or more portions of the user (e.g., first hand) while the one or more portions of the user is performing the first gesture (e.g., air-pinch of a thumb and a finger). Additionally or alternatively, the direction and/or magnitude of the rotation component optionally corresponds to the direction and/or magnitude of the input element rotation of one or more portions of the user while performing the first gesture.

A rotation component optionally includes rotation of the one or more portions of the user about a location in space within the three-dimensional environment, rotation of a first portion of the user about a second portion of the user, and/or rotation about a predetermined location. When the computer system detects movements of a first hand (e.g., right hand, or left hand) of a user corresponding to one or more translation inputs which exceed the first threshold amount of translation, the computer system optionally moves the virtual object the first distance which corresponds to the translation input. When the computer system detects that the movement of the first hand (e.g., right hand, or left hand) corresponds to one or more rotation inputs which exceed the first threshold amount of rotation, the computer system optionally rotates the virtual object in a manner which corresponds with the rotation of the first hand of the user. However, when the computer system determines that the movements of the hand of the user exceed the first threshold amount of translation prior to exceeding the first threshold amount of rotation, the computer system optionally translates the virtual object a first distance which corresponds to the one or more translation inputs without rotating the virtual object about an axis of the object. For instance, when the computer system receives a translation input from the first hand of a user to move a virtual object (e.g., a cube) to the right, wherein the translation input exceeds the first threshold amount of translation, before the computer system receives a rotation input from the first hand of the user to rotate the cube concurrent with the translation input, the computer system optionally translates the cube to the right, but does not rotate the cube.

In some embodiments, the first threshold amount of translation is measured in virtual distance units (e.g., pixels) as related to a distance the one or more portions of the user moves in the three-dimensional environment, examples of which include: less that 1 pixel, 1 pixel, 5 pixels, 10 pixels, 25 pixels, 50 pixels, 100 pixels, and/or more than 100 pixels. In some embodiments the first threshold amount of translation is measured in physical distance units (e.g. mm, cm, and/or m) as related to a distance the one or more portions of the user moves in a physical environment, examples of which include: 1 mm, 5 mm, 25 mm, 10 cm, 25 cm, 50 cm, 1 m, and/or more than 1m. In some embodiments the movement of the one or more portions of the user is measured in relation to the first threshold amount of translation over a predetermined time period (e.g., seconds), examples of which include: less than 50 milliseconds, 50 milliseconds, 150 milliseconds, 0.5 seconds, 1 second, and/or more than 1 second.

In some embodiments, the first threshold amount of translation is measured in virtual velocity units (e.g., pixels/s) as related to a velocity the one or more portions of the user move in the three-dimensional environment, examples of which include: less that 1 pixel/s, 1 pixel/s, 5 pixels/s, 10 pixels/s, 25 pixels/s, 50 pixels/s, 100 pixels/s, and/or more than 100 pixels/s. In some embodiments first threshold amount of translation is measured in physical velocity units (e.g. mm/s, cm/s, and/or m/s) as related to a velocity the one or more portions of the user move in the physical environment, examples of which include: 1 mm/s, 5 mm/s, 25 mm/s, 10 cm/s, 25 cm/s, 50 cm/s, 1 m/s, and/or more than 1 m/s.

In some embodiments, the first threshold amount of translation is measured in virtual acceleration units (e.g., pixels/s\hat{ }2) as related to an acceleration of the one or more portions of the user in the three-dimensional environment, examples of which include: less that 1 pixel/s\hat{ }2, 1 pixel/s\hat{ }2, 5 pixels/s\hat{ }2, 10 pixels/s\hat{ }2, 25 pixels/s\hat{ }2, 50 pixels/s\hat{ }2, 100 pixels/s\hat{ }2, and/or more than 100 pixels/s\hat{ }2. In some embodiments, the first threshold amount of translation is measured in physical acceleration units (e.g. mm/s\hat{ }2, cm/s\hat{ }2, and/or m/s\hat{ }2) as related to an acceleration of the one or more portions of the user in the physical environment, examples of which include: 1 mm/s\hat{ }2, 5 mm/s\hat{ }2, 25 mm/s\hat{ }2, 10 cm/s\hat{ }2, 25 cm/s\hat{ }2, 50 cm/s\hat{ }2, 1 m/s\hat{ }2, and/or more than 1 m/s\hat{ }2. In some embodiments, the first threshold amount of rotation is measured in rotation displacement units (e.g., degrees) as related to rotation displacement of one or more portions of the user, examples of which include: less than 1 degree, 1 degree, 5 degrees, 10 degrees, 20 degrees, 30 degrees, 45 degrees, 60 degrees, 90 degrees, and/or more than 90 degrees. In some embodiments, the first threshold amount of rotation is measured in rotation velocity units (e.g., degrees/s) as related to rotation velocity of one or more portions of the user, examples of which include: less than 1 degree/s, 1 degree/s, 5 degrees/s, 10 degrees/s, 20 degrees/s, 30 degrees/s, 45 degrees/s, 60 degrees/s, 90 degrees/s, and/or more than 90 degrees/s. In some embodiments, the first threshold amount of rotation is measured in rotation acceleration units (e.g., degrees/s\hat{ }2) as related to rotation velocity of one or more portions of the user, examples of which include: less than 1 degree/s\hat{ }2, 1 degree/s\hat{ }2, 5 degrees/s\hat{ }2, 10 degrees/s\hat{ }2, 20 degrees/s\hat{ }2, 30 degrees/s\hat{ }2, 45 degrees/s\hat{ }2, 60 degrees/s\hat{ }2, 90 degrees/s\hat{ }2, and/or more than 90 degrees/s\hat{ }2.

As disclosed herein, the translation inputs of the one or more portions of the user and the rotation inputs of the one or more portions of the user optionally correspond to a physical one or more portions of the user and/or a representation of the one or more portions of the user displaced in the three-dimensional environment.

In some embodiments, when the computer system detects a translation input which exceeds a first threshold amount of translation, and a rotation input from the one or more portions of the user, by translating the virtual object without rotating the virtual object, the computer system eliminates unintentional rotations of the virtual object within the three-dimensional environment by prioritizing one or more user inputs based on user input types (e.g., translation, and/or rotation) and dependent on one or more thresholds (e.g., first threshold amount of translation, and/or first threshold amount of rotation).

In some embodiments, in response to detecting the first input, in accordance with a determination that more than a first threshold amount of rotation (e.g., 5 degrees, 10 degrees, and/or 20 degrees) is detected in the rotation component of the first input prior to detecting that more than the first threshold amount of translation (e.g., 5 pixels, 10 pixels, and/or 20 pixels) is detected in the translation component of the first input, the computer system rotates the virtual object within the three-dimensional environment (e.g., about one or more axes of the object, about a point of the object, about an axis identified by the user, and/or about a point identified by the user) in accordance with the rotation component of the first input, such as shown in FIG. 8E for instance where the airplane 804 is rotated in accordance with the rotation component 812b. In some embodiments, in response to detecting the first input, in accordance with a determination that more than a first threshold amount of rotation (e.g., 5 degrees, 10 degrees, and/or 20 degrees) is detected in the rotation component of the first input prior to detecting that more than the first threshold amount of translation (e.g., 5 pixels, 10 pixels, and/or 20 pixels) is detected in the translation component of the first input, the computer system translates the virtual object within the three-dimensional environment (e.g., along one or more axes) in accordance with the translation component of the first input, such as shown in FIG. 8E where the airplane 804 is translated in accordance with the translation component 810b. When the computer system determines that the rotation component (e.g., corresponding to hand rotation) exceeds a first threshold amount of rotation first threshold amount of rotation before detecting that the translation component (e.g., corresponding to hand translation) exceeds the first threshold amount of translation, the computer system optionally rotates the virtual object in accordance with both the rotation component of the first input and the translation component of the first input. Determining when the rotation component is greater than the first threshold amount of rotation optionally includes a determination that the rotation component is greater than an amount of rotation, rotational velocity, and/or rotational acceleration. For instance, during first input (e.g., while the hand of the user is detected as performing an air-pinch), the computer system detects the hand of the user rotating and translating, such that the rotation of the hand of the user exceeds the first threshold amount of rotation (e.g., more than 10 degrees, faster than 30 degrees/s, and/or acceleration in excess of 5 degrees/s\hat{ }2) prior to the hand of the user translating an amount that exceeds the first threshold amount of translation (e.g., more than 5 cm, faster than 5 cm/s, and/or acceleration in excess of 5 cm/s\hat{ }2), the computer system optionally concurrently rotates the virtual object in a manner corresponding to the rotation component of the user and optionally translates the virtual object in a manner corresponding to the translation component. In some embodiments, rotating the virtual object in accordance with the rotation component, includes rotating the virtual object by an amount of object rotation which matches the rotation component. For instance, when the computer system detects the hand of the user rotates by 15 degrees, the computer system rotates the virtual object by 15 degrees. Additionally or alternatively, when the computer system detects that an input element (e.g., hand of the user) rotates by 15 degrees, the computer system rotates the virtual object by more than or less than 15 degrees to allow for increased object rotation or more precise object rotation control respectively. In some embodiments the rotation of the input element about an axis corresponds to the object rotation of the virtual object about an analogous axis. For instance, when the computer system detects the hand of the user rotating about a vertical axis, the computer system rotates the virtual object about a vertical axis. Additionally or alternatively, when the computer system rotates the virtual object about a predetermined or selected axis which is not analogous to the axis of rotation of the input element. In some embodiments, translating the virtual object in accordance with the rotation component, includes translating the virtual object by an amount of object translation which matches the translation of the input element. For instance, when the computer system detects the hand of the user translates by 20 pixels, the computer system translates the virtual object by 20 pixels. Additionally or alternatively, when the computer system detects that the input element translates by 20 pixels, the computer system translates the virtual object by more than or less than 20 pixels to allow for increased object translation or more precise object translation control respectively. By allowing the user to translate and rotate an object when the hand of the user is detected as rotating more than a first threshold amount of rotation first threshold amount of rotation before it is detected as translating more than a threshold amount of translation, the computer system considers the rotation component and translation components intentional inputs to move the virtual object, thus allowing the user to move the virtual object as one would move a physical object.

In some embodiments, in response to detecting the first input, in accordance with a determination that more than the first threshold amount of translation (e.g., 5 pixels, 10 pixels, and/or 20 pixels) is detected in the translation component of the first input after more than a first threshold amount of rotation (e.g., 5 degrees, 10 degrees, and/or 20 degrees) is detected in the rotation component, the computer system translates the virtual object within the three-dimensional environment (e.g., along one or more axes) in accordance with the translation component of the first input, without rotating the virtual object within the three-dimensional environment in accordance with the rotation component of the first input, such as shown in FIG. 8M for instance where the amount of rotation 812c applied to the airplane 804 is locked 844. When the computer system determines that the rotation component (e.g., corresponding to hand rotation) exceeds a first threshold amount of rotation, and subsequently detects that the translation component (e.g., corresponding to hand translation) exceeds the first threshold amount of translation (in response to continued motion associated with the first input), the computer system optionally ceases rotating the virtual object in accordance with the rotation component of the first input. Upon detecting that the translation component exceeds the first threshold amount of translation, the computer system locks out (e.g., forgoes) rotating the virtual object, thus translating the virtual object in accordance with the translation component of the first input without rotating the virtual object in accordance with the rotation component of the first input. Additionally or alternatively, when the computer system detects that the translation component exceeds a first threshold amount of translation subsequent to detecting that the rotation component exceeds the first threshold amount of rotation, computer system optionally reverts the orientation of the object to a starting position (e.g., undoes the object rotation that was performed while the translation component of the first input was below the first threshold amount of translation), thereby negating any object rotation applied to the virtual object, and translates the virtual object in a manner corresponding to the translation input. By forgoing rotating the virtual object and/or negating rotation applied to the virtual object prior to the translation component exceeding a first threshold amount of translation, the computer system prevents rotating the virtual object based on unintentional movements of the hand such as natural rotations of the hand which are a biomechanical product of translations of the hand being based on rotations of a user's arm from the elbow and/or shoulder.

In some embodiments, the rotation component of the first input includes rotation of a hand of the user (e.g., rotating about the wrist, a first axis, and/or a second axis) performing the first input. In some embodiments, in response to detecting the first input and while rotating the virtual object within the three-dimensional environment in accordance with the rotation component of the first input, in accordance with a determination that the hand of the user has rotated by a first amount of hand rotation (e.g., 5 degrees, 10 degrees, or 20 degrees), the computer system rotates the virtual object by a first amount of object rotation corresponding to the first amount of hand rotation (e.g., optionally the same as the first amount of hand rotation, greater than the first amount of hand rotation, or less than the first amount of hand rotation), such as illustrated in FIG. 8J for example wherein the amount of object rotation 812c corresponds with the rotation component 812b.

In some embodiments, in response to detecting the first input and while rotating the virtual object within the three-dimensional environment in accordance with the rotation component of the first input, in accordance with a determination that the hand of the user has rotated by a second amount of hand rotation, different from the first amount of hand rotation (optionally greater than, or less than the first amount), the computer system rotates the virtual object by a second amount of object rotation (e.g., the same as the third amount of hand rotation, greater than the third amount of hand rotation, or less than the third amount of rotation) corresponding to the second amount of hand rotation, wherein the second amount of object rotation is different from the first amount of object rotation, such as illustrated in FIG. 8K for example wherein the amount of object rotation 812c corresponds with the rotation component 812b, rotating the airplane 804 from the orientation shown in FIG. 8J to the orientation in FIG. 8K. In some embodiments the rotation of the first hand (e.g., hand rotation) corresponds to rotations of the first hand in relation to a first wrist of the user corresponding to (e.g., proximally located to) the first hand of the user. In some embodiments the rotation of the first hand of the user corresponds to twisting motions (e.g., pronation, and/or supination) of the hand originating from a first elbow, corresponding to (e.g., proximally located to) the first hand of the user. Additionally or alternatively, the rotation of the hand optionally corresponds to rotations of the first hand of the user resulting from rotations of a first shoulder corresponding to (e.g., proximally located to) the first hand of the user. For instance, a rotation component optionally corresponds to the rotation about a point corresponding to a portion of the first hand, and/or a point corresponding to a portion of the virtual object. In some embodiments, the computer system determines a point in space in relation to the first hand of the user which the first hand of the user rotates about to establish a rotation reference. For instance, when the computer system detects that the user provides rotational input through rotations of the first hand to rotate a representation of a globe representing the earth which mimic actions of rotating a physical globe, the computer system rotates the representation of the globe (e.g., representing the earth) about one or more axes as if the hand of the user were physically rotating the representation of the globe. Additionally or alternatively, rotation of the globe optionally includes rotating the representation of the globe about one or more predetermined axes (e.g., axis extending from a north pole to a south pole). In some embodiments, the amount of the rotation (e.g., hand rotation) of the input element optionally correlates with the amount of object rotation of the virtual object. For instance, when the computer system detects the amount of hand rotation of the hand of the user, the greater the detected amount of hand rotation of the hand, the greater the amount of object rotation that the computer system optionally rotates representation of the globe. Similarly, when the computer system detects a lesser amount of hand rotation of the hand, the computer system optionally rotates the representation of the globe by a lesser amount of object rotation. In some embodiments, the computer system rotates the virtual object in accordance with the direction of the rotation of the hand of the user, such that a rotation of the hand of the user about a first axis corresponds to a rotation of the representation of the virtual object about an analogous second axis. For instance, when the computer system detects the hand of the user rotating about a first axis (e.g., vertical axis), the computer system optionally rotates the representation of the globe about the first axis. Furthermore, when the computer system detects the hand of the user rotating about a second axis (e.g., horizontal axis), the computer system optionally rotates the representation of the globe about the second axis. Additionally or alternatively, when rotating the representation of the physical globe, the computer system rotates the representation of the physical globe proportional to the rotation of the hand, increased or decreased by a linear coefficient, and/or increased or decreased by an exponential factor. By rotating the first object in a manner corresponding to rotations of the first hand of the user, and optionally including hand rotations resulting from rotations from the first elbow and/or the first shoulder of the user, the computer system allows the user to rotate the virtual object in a manner mimicking and/or simulating how the user manipulates physical objects in the physical world.

In some embodiments, the rotation of the hand of the user includes rotation caused by at least one of wrist flexion or wrist extension (e.g., connected to the first hand), such as if the rotation of the hand 806 illustrated in FIG. 8K included, at least in part, a rotation of the wrist of the user. In some embodiments the rotation of the hand corresponds to input element rotations about a first wrist corresponding to the first hand of the user. It will be appreciated that input element rotations about the wrist occur mainly about two axes which allow flexion/extension about a transverse axis, and adduction/abduction about an antero-posterior axis. Accordingly any rotation of the hand about the wrist (e.g., bend, and/or twist) detected by the computer system corresponds with an input element rotation which is correlated to the rotation component. In some embodiments, slight flexion/extension (e.g., bending) movements of the hand about the user about the wrist of the user in an upward direction and/or downward motion are detected by the computer system as input element translations corresponding to the translation component. As a result, input element rotations about the wrist optionally include complex rotations of the hand. Accordingly, as discussed herein, input element rotations about the wrist optionally include flexion/extension rotations and/or adduction/abduction rotations. When the computer system detects input element rotations about the first wrist of the user, the computer system optionally rotates the virtual object in accordance with the rotations of the hand, and/or rotations of the hand in relation to a point corresponding to the first hand, and/or a virtual object. For instance, the computer system optionally allows a user to rotate a virtual object based on the rotation of the hand about the wrist (e.g., first wrist static and first hand rotating about the wrist), and/or the rotation of the hand about a specific point (e.g., a rotation of the first hand about a first point where the finger and thumb of the user meet when performing an air-pinch) by detecting the rotation of the hand of the user in relation to the wrist. When the computer system rotates the virtual object in accordance with input element rotation about the wrist of the user, the computer system rotates the virtual object proportionally to the rotation of the hand, increased or decreased by a linear coefficient, and/or increased or decreased by an exponential factor. By allowing the user to rotate the virtual object based on rotations of the wrist, including flexion and extension of the hand about the wrist, the computer system optionally allows the user to rotate the virtual object in a manner mimicking and/or simulating how the user manipulates physical objects in the physical world.

In some embodiments the first input is based on the movements of the user's hand, arm, and/or other portion of the user in relation to: the viewpoint of the user, a shoulder of the user, an elbow of the user, and/or from a wrist of the user, wherein the translation component corresponds to translative movements of the user's hard, arm and/or other portions of the user, and the rotation component corresponds to rotative movements of the user's hand, arm, and/or other portions of the user.

In some embodiments, in response to detecting the first input, in accordance with a determination that less than the first threshold amount of translation (e.g., 5 pixels, 10 pixels, and/or 20 pixels) is detected in the translation component of the first input prior to detecting the rotation component of the first input, and in accordance with detecting less than a first threshold amount of rotation (e.g., 5 degrees, 10 degrees, and/or 20 degrees) in the rotation component of the first input, the computer system translates the virtual object within the three-dimensional environment in accordance with the movement of the arm of the user in the first input, such as illustrated in FIG. 8E. In some embodiments, in response to detecting the first input, in accordance with a determination that less than the first threshold amount of translation (e.g., 5 pixels, 10 pixels, and/or 20 pixels) is detected in the translation component of the first input prior to detecting the rotation component of the first input, and in accordance with detecting less than a first threshold amount of rotation (e.g., 5 degrees, 10 degrees, and/or 20 degrees) in the rotation component of the first input, the computer system rotates the virtual object within the three-dimensional environment from a first orientation to a second orientation, different from the first orientation, in accordance with the rotation component of the first input that has been reduced by a first damping factor, such as illustrated in FIG. 8G. A damping factor as described herein surrounds the use of a multiplier (e.g., having an absolute value of between 0 and 1) which reduces the amount of object rotation applied to the virtual object. A higher damping factor optionally corresponds to a lower number, such as a value of 0.1 in contrast with a higher damping factor of 0.9. The damping factor reduces the amount of output (e.g., object rotation) that is generated for a given amount of input (e.g., hand rotation), such that application of a lower damping factor to the object rotation corresponding to a given amount of input element rotation, would result in a higher amount of object rotation than the same amount of input element rotation with a higher damping factor applied to the object rotation. In some embodiments, when the computer system determines that the translation component of the first input is less than the first threshold amount of translation, and the rotation component of the first input is less than the first threshold amount of rotation, the computer system translates the virtual object from a first location to a second location, and rotates the virtual object from a first orientation to a second orientation. In some embodiments the computer system translates the virtual object by a first amount of object translation which corresponds to the translation component, and rotates the virtual object by a first amount of object rotation which corresponds to the rotation component reduced by a first damping factor. The rotation component is optionally damped by a first damping factor which is a constant damping factor (e.g., 0.05, 0.1, 0.25, 0.50, 0.80, or 0.90) or an algorithmic reduction (e.g., multifactorial, exponential, and/or logarithmic) of the object rotation amount corresponding to the rotation component. The use of and/or the determination of the value of a damping factor is optionally variable and/or dependent, the size of the virtual object, the simulated inertia (e.g., based on a simulated mass of the virtual object). For instance, the computer system damps the object rotation of a smaller object (e.g., damping value of 0.90) less than an amount which the computer system damps a larger virtual object (e.g., damping value of 0.25). In some embodiments a more damping (e.g., 0.25) is used when the hand of the user is detected as being further from the viewpoint of the user (e.g., outstretched), and lesser damping factor (e.g., 0.90) is used than when the hand of the user is detected as being closer to the user to address rotations of the hand which are a byproduct of physiological mechanics.

When receiving a user input directed toward a virtual object which includes a translation component and a rotation component, each of which are below their respective thresholds (e.g., first threshold amount of translation, and first threshold amount of rotation), the computer system optionally translates the virtual object by a first object translation amount which corresponds to the translation component. However, rather than rotate the virtual object corresponding to the rotation component, the computer system optionally rotates the virtual object by a first object rotation amount which corresponds to a fraction of the first rotation component. For instance, when the computer system receives an input based on the movements of the hand of the user which includes a translation component which corresponds to a hand translation amount of 500 pixels to the left, less than the first threshold amount of translation (e.g., 1000 pixels), and a rotation component which corresponds to a hand rotation amount of 10 degrees about a first axis, less than the first threshold amount of rotation (e.g., 30 degrees), the computer system optionally translates the virtual object by 500 pixels to the left, and rotates the virtual object about the first axis by 5 degrees. By rotating based on arm movement when less than the first threshold amount of rotation is detected, the computer system mitigates unintended object translations of the virtual object associated unintended movements of the hand of the user.

In some embodiments, while the virtual object is at the second orientation, the computer system detects an additional rotation component of the first input (e.g., the hand of the user rotates further from the position (e.g., from 10 degrees to 15 degrees) which corresponds to the first orientation of the virtual object), and in response to detecting the additional rotation component of the first input, the computer system rotates the virtual object within the three-dimensional environment from the second orientation to a third orientation, different from the second orientation, relative to the three-dimensional environment in accordance with the additional rotation component of the first input that has been reduced by a second damping factor, greater than the first damping factor, such as illustrated in FIG. 8H. In certain embodiments the damping factor by which the object rotation amount corresponding to the rotation component is reduced, varies according to the amount of input element rotation detected and/or based on the determination of the first threshold amount of rotation. In some embodiments the damping factor becomes progressive smaller as the rotation component increases and nears the first threshold amount of rotation detected corresponding to the rotation component. For instance, when first threshold amount of rotation is 30 degrees, and the rotation component corresponds to an input element rotation amount of 10 degrees, the component is below the first threshold amount of rotation, the computer system optionally rotates the virtual object from a first orientation to a second orientation with 5 degrees of object rotation in accordance with a first damping factor of 50%. While the virtual object is in the second orientation, and when the computer system detects the rotation component increasing to correspond with an input element rotation amount of 20 degrees, still below the 30-degree first threshold amount of rotation, the computer system optionally rotates the virtual object from the second orientation to a third orientation with 7.5 degrees of object rotation, an increase of 2.5 degrees of object rotation between the second orientation and the third orientation, in accordance with a second damping factor of 37.5%. In some embodiments, when the computer system rotates the virtual object with a damping value, the damping of the object rotation of the virtual object optionally decreases as input element rotation and/or object rotation increases. For instance, when the computer system rotates the virtual object with damping factors, the virtual object optionally damps the object rotation of the virtual object by varying amounts of damping, optionally decreasing the damping factor as the rotation component increases and approaches the first threshold amount of rotation (e.g., starting with a first damping factor (e.g., 0.25), and reducing the damping factor (e.g., to 0.90)). Additionally or alternatively, in some embodiments, when the computer system rotates the virtual object with a damping value, the damping of the object rotation of the virtual object optionally increases as object rotation and/or input element rotation increases. The progression of damping of the object rotation of the virtual object optionally increases and/or decreases in a linear manner and/or in a non-linear manner (e.g., multifactorial, exponential, and/or logarithmic). By applying the object rotations corresponding with input element rotations below the first threshold amount of rotation, the computer system prevents unintentional input element rotation inputs while indicating to the user that the input element rotation inputs corresponding to the rotation component have been received by the computer system.

In some embodiments, while the virtual object is displayed in the second orientation, the computer system detects that the rotation component of the first input increases (e.g., the hand of the user rotates further (e.g., from 15 degrees to 20 degrees) from the position which corresponds to the second orientation of the virtual object), and in response to detecting that the rotation component of the first input increases, accordance with a determination that more than the first threshold amount of rotation has been detected in the rotation component of the first input, the computer system rotates the virtual object within the three-dimensional environment to a third orientation (optionally different than the first orientation and the second orientation) relative to the three-dimensional environment, wherein the third orientation corresponds to a magnitude of the rotation component of the first input that has not been reduced by a damping factor (e.g., not damped), such as illustrated in FIG. 8I. While the virtual object is displayed with a reduced (e.g., damped) rotation in the second orientation with the second damping factor, and while less than the first threshold amount of translation is detected, when the computer system detects that the rotation component increases to above a first threshold amount of rotation, the computer system rotates the virtual object to a third orientation wherein the resulting third orientation of the virtual object corresponds to the total rotation component of the first input without damping. For instance, while the virtual object is displayed, when the computer system detects the rotation component to correspond with an input element rotation of 20 degrees, less than the 30-degree first threshold amount of rotation, the computer system rotates the virtual object by 7.5 degrees due to a 37.5% damping factor to a second orientation. While the virtual object is in the second orientation, and the computer system subsequently receives further input resulting in a total rotational component corresponding to an input element rotation amount of 35 degrees, the computer system optionally rotates the virtual object to a third orientation, wherein the total object rotation from the first orientation to the third orientation is 35 degrees. By rotating the virtual object by a rotation amount corresponding with the rotation component after exceeding the first threshold amount of rotation, the computer system permits intentional rotation of the virtual object.

In some embodiments, while the virtual object is displayed in the second orientation, the computer system detects an increase in the translation component of the first input (e.g., the hand of the user is detected as moving from a total of 10 pixels to a total of 20 pixels), and in response to detecting the increase in the translation component of the first input, in accordance with a determination that more than the first threshold amount of translation (e.g., 5 pixels, 10 pixels, and/or 20 pixels) has been detected in the translation component of the first input, the computer system displays the virtual object within the three-dimensional environment at the first orientation relative to the three-dimensional environment, such as illustrated in FIG. 8O, wherein the orientation of the airplane has been reverted to the orientation shown in FIG. 8A following the detection of the translation component 810b exceeding the threshold amount of translation 810d as shown in FIG. 8N. In some embodiments, while displaying the virtual object in a rotated orientation (e.g., the second orientation with damped object rotation, or the third orientation without damping), when the computer system detects that increased user input corresponds to an increase of the translation component such that the translation component exceeds the first threshold amount of translation, the computer system reverts the orientation of the virtual object from the rotated orientation (e.g., second orientation, or third orientation) back to the first orientation, thereby negating any rotational modifications to the virtual object (e.g., the orientation of the virtual object snaps back to its original rotational configuration). The change from the rotated orientation to the first orientation optionally occurs instantaneously (e.g., displaying the virtual object in the first orientation without displaying orientations between the rotated orientation and the first orientation), or near instantaneously (e.g., displaying the regression of the rotation of the object from the rotated orientation to the first orientation) thus occurring over a period of time (e.g., less than 0.01 second, less than 0.05 seconds, or less than 0.1 seconds). By reverting from a rotated orientation to the first orientation (e.g., unrotated) the computer system negates unintentional rotational inputs from the user without further input from the user.

In some embodiments, displaying the virtual object within the three-dimensional environment in the first orientation relative to the three-dimensional environment includes gradually rotating the virtual object within the three-dimensional environment from the second orientation to the first orientation over time, such as illustrated in relation to FIG. 8N-8O wherein the airplane 804 is reverted to the original orientation (e.g., as shown in FIG. 8A) over a period of time 848. In some embodiments the change from the rotated orientation to the first orientation (e.g., unrotated), occurs or over a period of time (e.g., 0.2 second, 0.5 seconds, 1 second, or longer than 1 second). In some embodiments, the amount of time in which the computer system changes the orientation of the virtual object from the first orientation back to the second orientation is dependent how much the virtual object has been rotated. For instance, the computer system will rotate the virtual object which has been rotated by a greater amount of object rotation back to the first orientation over a longer period of time than when the virtual object has been rotated by a lesser amount of object rotation. In some embodiments, the object rotation of the virtual object from the second orientation back to the first orientation occurs at the same velocity, thereby virtual object which have been rotated less will be rotated back to the first orientation in less time than an object which has been rotated more. By reverting to the first orientation form a rotated orientation over a period of time, the computer system provides visual indication that further inputs to rotate the virtual object will be negated due to an increase of translation related inputs, thereby also allowing the user to adjust inputs (e.g., movements of one or more portions of the user) in the event they wish to continue rotating the virtual object.

In some embodiments, in response to detecting the first input, in accordance with a determination that more than a first threshold amount of rotation (e.g., 5 degrees, 10 degrees, or 20 degrees) is detected in the rotation component of the first input, the computer system rotates the virtual object within the three-dimensional environment from a first orientation (e.g., unrotated in relation to orientation of the virtual object at the time of the initiation of the first input) to a second orientation relative to the three-dimensional environment in accordance with the rotation component of the first input, such as illustrated in FIG. 8I wherein the airplane 804 is rotated by an amount of object rotation 812c corresponding to the magnitude of the rotation component. When the computer system determines that the rotation component, corresponding to the rotation of the input element (e.g., hand of the user), meets or exceeds the first threshold amount of rotation, the computer system rotates the virtual object within the three-dimensional environment in accordance with the rotation component. For instance, when the rotation of the input element (e.g., hand of the user) is detected as rotating 35 degrees in one or more directions, and the first threshold amount of rotation is 30 degrees, the computer system rotates the virtual object 35 degrees in accordance with the rotation of the hand of the user. In some embodiments, when the computer system determines that the rotation component corresponding to the rotation of the input element has not satisfied (e.g., met, and/or exceeded) the first threshold amount of rotation, the computer system forgoes rotating the virtual object, or rotates the virtual object by a reduced (e.g., damped) amount of object rotation corresponding to the rotation of the input element.

In some embodiments, when the computer system determines that the rotation component has exceeded the first threshold amount of rotation during the first input, the rotation of the virtual object corresponds to the rotation of the input element (e.g., hand of the user) for the duration of the first input. For instance, when the computer system determines that the input element has rotated 35 degrees, and more than the first threshold amount of rotation of 30 degrees in a first direction, and while detecting the first input, the hand of the user rotates in a second direction counter to the first direction by 15 degrees, such that the hand of the user has rotated a total of 20 degrees in the first direction, the computer system rotates the virtual object by 20 degrees in the first direction following the rotation of the hand of the user as the hand of the user rotates, wherein the orientation of the virtual object at any given time during the rotation of the virtual object optionally corresponds and/or matches the rotation of the hand of the user. By rotating the virtual object in accordance with the rotation component after the first threshold of rotation has been satisfied, the computer system allows the user to effectively unlock the object rotation of the virtual object in relation to all subsequent input element rotations of the input element, even if such subsequent input element rotations are individually less than the first threshold amount of rotation.

In some embodiments, rotating the virtual object within the three-dimensional environment from the first orientation to the second orientation includes rotating the virtual object in accordance with the rotation component of the first input increased by an amplifying factor, such as illustrated in FIG. 8J such as if the rotation component was equal to the threshold amount of rotation 812d with the amount of object rotation 812c and orientation of the airplane 804 as illustrated. An amplification factor as described herein surrounds the use of a multiplier (e.g., having an absolute value of greater than 1) which increases the amount of object rotation applied to the virtual object for a given amount of input rotation of the hand. A lower amplification factor optionally corresponds to a lower output rotation, such as a value of 1.2 in contrast with a higher amplification factor of 3 for instance. The amplification factor increases the amount of output (e.g., object rotation) that is generated for a given amount of input (e.g., hand rotation), such that application of a higher amplification factor to the object rotation corresponding to a given amount of input element rotation, would result in a higher amount of object rotation than the same amount of input element rotation with a lower amplification factor applied to the object rotation. In some embodiments, when the computer system determines that the rotation component corresponding to the rotation of the input element (e.g., hand of the user) satisfies the first threshold of rotation, the computer system rotates the virtual object in the three-dimensional environment in accordance with first component increased by an amplification factor. An amplification factor optionally includes a coefficient of amplification (e.g., 1.5, 2, 5, or 10) by which the rotation component is multiplied by. For instance, with a coefficient of amplification of 2, when the computer system detects that the rotation component corresponding with the rotation of the input element indicates a rotation component corresponding to an object rotation of 35 degrees without amplification, the computer system rotates the virtual object by 70 degrees. Additionally or alternatively, amplification of the rotation component optionally includes amplifying the rotation component in a non-linear manner such as in accordance with an algorithm (e.g., exponential, and/or logarithmic). Furthermore, in some embodiments the computer system pauses at increments (e.g., every 5 degrees, or every 15 degrees) to allow the user to rotate the virtual object by discrete increments. By rotating the virtual object in accordance with the rotation component which has been amplified (e.g., increasing, or decreasing), the computer system allows the user to rotate the virtual object by amounts and in directions which are physiologically difficult (e.g., rotating over 180 degrees), and/or allowing the user to precisely rotate the virtual object by reduced amounts (e.g., 1 degree, and/or 5 degrees).

In some embodiments, in response to detecting the first input, and while rotating the virtual object within the three-dimensional environment in accordance with the rotation component of the first input, in accordance with a determination that attention of the user (e.g., based on gaze) was directed to a first portion of the virtual object when the first input was detected, the computer system rotates the virtual object about a first pivot point, in accordance with the rotation component of the first input, such as if the attention of the user was directed to the wingtip 820b of the airplane 804, as illustrated in FIG. 8P-2, when the first input was detected, resulting in the rotation of the airplane about pivot point 821. In some embodiments, when the computer system rotates the virtual object within the three-dimensional environment, it rotates the virtual object about a point at which the attention (e.g., based on gaze) of the user was directed to at the time which the computer system detected the first input. For instance, when the computer system receives an indication from the user to rotate a virtual representation of an airplane within the three-dimensional environment, and the computer system detected at the time of detecting the first input that the gaze of the user was directed toward the nose of the virtual representation of the airplane, the computer system rotates the representation of the virtual representation of airplane about the nose of the virtual representation of airplane in accordance with the first rotation component. In some embodiments the object rotation about the location which the attention of the user is directed to occurs around one or more axes. In some embodiments the pivot point for rotation of the virtual object corresponds to the point of the virtual object which the attention (e.g., based on gaze) of the user was directed to prior to detecting the rotation component of the first input. Additionally or alternatively, in some embodiments the pivot point for rotation of the virtual object corresponds to the point of the virtual object which the attention of the user is directed to at the time of the rotation input.

In some embodiments, in response to detecting the first input, and while rotating the virtual object within the three-dimensional environment in accordance with the rotation component of the first input, in accordance with a determination that attention of the user (e.g., based on gaze) was directed to a second portion of the object, different than the first portion of the object when the first input was detected, the computer system rotates the virtual object about a second pivot point that is different from the first pivot point, in accordance with the rotation component of the first input, such as if the attention of the user was directed to the tail 820c of the airplane 804, as illustrated in FIG. 8P-3, when the first input was detected, resulting in the rotation of the airplane about pivot point 821.

Additionally or alternatively, the pivot-point for rotation optionally corresponds a point coincident with the virtual object which the attention of the user is directed to during the rotation in accordance with the rotation component, such that the pivot-point optionally continuously and/or periodically updates in accordance with the location which the attention of the user is directed to. In some embodiments, the pivot-point optionally corresponds to a location within the three-dimensional environment which the attention of the user is directed to even when the attention of the user is not directed to a point on the virtual object. The pivot point (e.g., first point, and/or second point) are optionally coincident with the virtual object, however the pivot point is optionally non-coincident with the virtual object and optionally coincident with an alternate virtual object within the three-dimensional environment. By rotating the virtual object about a point to which the attention (e.g., based on gaze) of the user is directed, the computer system allows the user to modify the point of rotation of a virtual object by looking at a particular portion of the virtual object and/or three-dimensional environment and updating the point of object rotation without requiring further inputs.

In some embodiments, rotating the virtual object within the three-dimensional environment includes rotating the virtual object about a center of the virtual object, such as illustrated in FIG. 8P-1. In some embodiments, when the computer system rotates the virtual object within the three-dimensional environment, it rotates the virtual object about a center of the virtual object. In some embodiments the center of the object is based on length, height, and/or width of the virtual object. In some embodiments, the pivot point for rotation and/or center of the virtual object is selected by the computer system or application that is displaying the object. When rotating about the center of the virtual object, the center of the virtual object is optionally unchanged based on the location of the gaze of the user (e.g., on the nose of the virtual representation of airplane, the tail of the virtual representation of airplane, or on a location non-coincident with the virtual representation of the airplane). Additionally or alternatively, the center of the object optionally corresponds to a virtual center of mass (e.g., assumption of uniform density), and/or a center of mass of a real world object to which the virtual object corresponds to, which takes into account variations of density and/or hollow aspects. For instance, when the computer system receives an indication from the user to rotate a virtual representation of an airplane within the three-dimensional environment, and the computer system optionally rotates the virtual representation of the airplane about the center of mass of the virtual representation of the airplane. In some embodiments the object rotation about the center of the object occurs around one or more axes. Accordingly, the rotation of the virtual object about a center of the virtual object optionally corresponds with (e.g., follows) the location of the virtual object, such that when the object changes locations from a first location to a second location, the center of the virtual object also changes, and accordingly, the pivot point changes with the location of the center of the virtual object. By rotating the virtual object about a center point, the computer system allows the user to rotate the virtual object without requiring the user to identify the point of rotation.

In some embodiments, the computer system rotates the virtual object within the three-dimensional environment in accordance with the rotation component, and in accordance with a determination that attention of the user (e.g., based on gaze) was directed to a first portion of the virtual object when the first input was detected, the computer system rotates the virtual object about a first pivot point corresponding to the first point and a center of the virtual object in accordance with the rotation component of the first input, such as if the attention of the user was directed to the tail 820c of the airplane, as illustrated in FIG. 8P-3, when the first input was detected, resulting in the rotation of the airplane 804 about pivot point 821 which corresponds to the tail and the center 820a of the airplane. In some embodiments, when the computer system rotates the virtual object within the three-dimensional environment, it rotates the virtual object about a location (e.g., point and/or axis) corresponding to the center of the object and a location which the attention (e.g., based on gaze) of the user was directed to when the computer system detected the first input. The location which the attention of the user is directed to is optionally a portion of the virtual object, but not restricted thereto. Using the example of the virtual representation of the airplane, the computer system optionally rotates the virtual representation of the airplane about one or more axes and/or about a pivot point corresponding to an average (basic, or weighted) pivot point between the top of the tail and the center of the virtual representation of the airplane.

In some embodiments, the computer system rotates the virtual object within the three-dimensional environment in accordance with the rotation component, and in accordance with a determination that attention of the user was directed to a second portion of the virtual object when the first input was detected (e.g., the gaze of the user changes from the nose of the virtual representation of the airplane to the tail of the virtual representation of the airplane), different from the first portion of the virtual object, the computer system rotates the virtual object in the three-dimensional environment about a second pivot point, different from the first pivot point, corresponding to the second portion of the virtual object and the center of the virtual object in accordance with the rotation component of the first input, such as if the attention of the user was directed to the wingtip 820b of the airplane, as illustrated in FIG. 8P-2, when the first input was detected, resulting in the rotation of the airplane 804 about pivot point 821 which corresponds to the wingtip and the center 820a of the airplane. In some embodiments, when the computer system determines that the attention of the user was directed to a second portion on the virtual object when the first input was detected, the computer system optionally rotates the virtual object about a second pivot point corresponding to the center of the object and the second portion of on the virtual object. When the attention of the user is directed to the second portion on the virtual object, the computer system optionally rotates the virtual object about a second pivot point corresponding to the second portion on the virtual object, which shares one or more characteristics with the first pivot point which corresponds to the first portion of the virtual object and the center of the virtual object as described herein. Rotating the virtual object about a second pivot point shares one or more characteristics with rotating the virtual object about the first pivot point as described herein. In some embodiments, when a first virtual object (e.g., representation of the virtual representation of the airplane) is selected for rotation and the attention of the user is directed to a second virtual object (e.g., toward a second virtual object), the computer system rotates the first virtual object about a pivot point corresponding to the center of the first virtual object and the location of the second virtual object. By rotating the virtual object about one or more axes and/or about a point corresponding to the location which the attention of the user is directed to, and the center of the object, the computer system allows the user to define a point or axis of rotation which is not dependent on predetermined axes or points of rotation.

In some embodiments, a location of the first pivot point is on a line intersecting the first point and the center of the virtual object, such as illustrated in FIG. 8P-2 in relation to the center 820a and the wingtip 820b, to which the gaze 814 of the user is directed. In some embodiments, when the computer system rotates the virtual object within the three-dimensional environment, it rotates the virtual object about a point along a line extending between the center of the object and a location which the attention (e.g., based on gaze) of the user is directed to. In some embodiments the point of object rotation is located a fraction (e.g., ⅛, ¼, ½, or ¾) between the center of the virtual object and the location which the attention of the user is directed to. For instance, when rotating a virtual representation of an airplane, when the attention of the user is directed to the top of the tail of the virtual representation of the airplane, the computer system optionally rotates the representation of the virtual representation of the airplane a point along a line extending between the center of the virtual representation of the airplane and the top of the tail of the virtual representation of the airplane. Additionally or alternatively, when the attention of the user changes, the point of object rotation optionally updates in accordance with the change in location of the attention of the user. For instance, when location of the attention of the user changes (e.g., the gaze of the user moves from the tail of the representation of the airplane to the wingtip of the representation of the airplane), the point of object rotation optionally changes to be located on a line extending from the wingtip of the airplane to the center of the airplane. In some embodiments, when a first virtual object (e.g., representation of the virtual representation of the airplane) is selected for object rotation and the attention of the user is directed to a second virtual object (e.g., toward a second virtual object), the computer system rotates the first virtual object about a point along a line extending between the center of the first virtual object and the location of the second virtual object. By rotating the virtual object about a point along a line extending between the location which the attention of the user is directed to, and the center of the object, the computer system allows the user to define a point or axis of rotation which is not dependent on predetermined axes or points of rotation.

In some embodiments, while translating the virtual object within the three-dimensional environment in accordance with the translation component of the first input without rotating the virtual object in accordance with the rotation component of the first input, the computer system detects that the translation component of the first input has stopped changing, such as if the translation component 812 as illustrated in FIG. 8B remained unchanged for a period of time (e.g., 0.5 seconds). In some embodiments the computer system determines that the translation component of the first input has stopped changing when the translation component has stopped increasing or decreasing, and/or the translation component of the first input exhibits changes less than a second threshold amount of translation (e.g., 1 pixels, 2 pixel, 3 pixels, 0.5 cm, 1 cm, and/or 2 cm), which is less than the first threshold amount of translation. Additionally or alternatively, the computer system optionally determines that the translation component of the first input has stopped changing when the translation component exhibits movement less than a threshold velocity (e.g., less than 0.5 pixels/s, 0.5 pixels/sec, 1 pixel/s, 2 pixels/sec, 3, pixels/sec, 6 pixels/sec).

In some embodiments, in response to detecting that the translation component of the first input has stopped changing, in accordance with a determination that the first input includes an additional translation component and an additional rotation component that occurs after detecting that the translation component has stopped changing, for instance starting with the rotation component 812b and translation component 810b at zero while the first input continues such as shown in FIG. 8A while the airplane 804 remains in the position shown in FIG. 8B, and that more than the first threshold amount of translation (e.g., 5 pixels, 10 pixels, and/or 20 pixels) is detected in the additional translation component prior to detecting the additional rotation component, the computer system translates the virtual object within the three-dimensional environment in accordance with the additional translation component of the first input without rotating the virtual object in accordance with the additional rotation component of the first input, once again such as illustrated by 8B as if the airplane were displayed further to the left within the viewport of the user. The additional translation component optionally shares one or more characteristics with the translation component of the first input as described herein, and the additional rotation component of the first input optionally shares one or more characteristics with the rotation component of the first input as described herein. The additional rotation input optionally includes an increase in input element rotation or a decrease in input element rotation.

In some embodiments, after a first input is detected and has stopped changing (e.g., translation component reduces to zero, or near zero) the computer system detects a respective translation input and a respective rotation component of the first input. The respective translation component and respective rotation component optionally share one or more characteristics with respect to translating the virtual object in accordance with the translation component, with or without rotating the virtual object in accordance with the rotation component as described herein. When the computer system detects that the translation component of the first input has stopped changing, while the first input continues (e.g., the computer system detects that the hand of the user continues to hold the pinch-and-hold gesture), the computer system reassesses when to translate and/or rotate the virtual object in accordance with the first input. In some embodiments, the computer system reverts and/or resets aspects (e.g., the rotation component, and/or the translation component) related to the detecting of the translation component and/or the rotation component of the first input. By resetting the translation component and/or the rotation component for instance, establishes a baseline position and baseline orientation of the hand of the user such that any additional input element translation and/or any additional input element rotation of the hand of the user is measured from the baseline position and orientation. The baseline position and/or baseline orientation optionally correspond to a rotation component and translation component value of zero. When the computer system reverts and/or resets aspects related to the detecting of the translation component and/or or the rotation component of the first input, wherein translating the virtual object in accordance with any additional translation component and/or rotating the virtual object in accordance with any additional rotation component are optionally independent of previous translations and/or rotations of the virtual object in accordance with the first input.

In some embodiments, in response to detecting that the translation component of the first input has stopped changing, in accordance with a determination that less than the first threshold amount of translation is detected in the additional translation component prior to detecting the additional rotation component, the computer system translates the virtual object within the three-dimensional environment in accordance with the additional translation component of the first input; and the computer system rotates the virtual object in accordance with the additional rotation component of the first input, such as if the translation component 810b and the rotation component 812b were detected as shown in FIG. 8H after the computer system detected that the translation component of the first input stopped changing. Determining that less than the first threshold amount of translation is detected in the additional translation component before detecting the additional rotation component shares one or more characteristics with determining that less than the first threshold amount of translation is detected in the translation component prior to detecting the rotation component as described herein.

Translating the virtual object in accordance with the additional translation component of the first input optionally shares one or more characteristics with translating the virtual object in accordance with the translation component of the first input described herein. Rotating the virtual object in accordance with the additional rotation component of the first input optionally shares one or more characteristics with rotating the virtual object in accordance with the rotation component of the first input described herein. When the computer system determines that the additional translation component satisfies the first threshold of translation prior to detecting the additional input element rotation, the computer system optionally translates the virtual object in accordance with the additional translation component, and forgoes rotating the virtual object in accordance with the additional rotation component. By detecting for a respective translation component and respective rotation component after the translation component has stopped changing, the computer system allows the user to make more than one modification to the location and/or orientation of the virtual object without requiring the user to end the first input and initiate a second input.

In some embodiments, detecting that the translation component of the first input has stopped changing includes detecting that the translation component has stopped changing for longer than a threshold amount of time (e.g., less than 50 milliseconds, 50 milliseconds, 150 milliseconds, 0.5 seconds, 1 second, 3 seconds, 5 second or 10 seconds), such as if the translation component 810b as shown in FIG. 8B has stopped for more than 0.5 seconds. In some embodiments, until the computer system detects that the translation component has stopped for the threshold amount of time, the computer system continues to translate and/or rotate the virtual object in accordance with the translation component and the rotation component as described herein. Detecting that the first threshold component has stopped changing includes detecting that the movement of the first input element (e.g., hand of the user) has stopped changing or is moving less than a threshold amount of movement for a threshold amount of time. A threshold amount of movement is optionally less than the threshold amount of translation, and optionally shares one or more characteristics with the threshold amount of translation as described herein. The threshold amount of time optionally shares one or more characteristics with the predetermined time period as described herein. For instance, when the threshold amount of movement is 3 pixels/s and the input element (e.g., hand of the user) is detected as moving at 1 pixel/s for more than 0.5 seconds, the computer system optionally determines that the translation component of the first input has stopped changing and reevaluates if object rotation should occur. By detecting a pause to determine that the translation component of the first input has stopped changing, the computer system prevents prematurely ending the translation component of the first input.

In some embodiments, in response to detecting the first input, in accordance with a determination that more than a first threshold amount of rotation (e.g., 5 degrees, 10 degrees, and/or 20 degrees) is detected in the rotation component of the first input, the computer system translates the virtual object within the three-dimensional environment in accordance with the translation component of the first input, and the computer system rotates the virtual object within the three-dimensional environment in accordance with the rotation component of the first input, such as shown in FIG. 8E. When the computer system determines that the rotation component and the translation component, corresponding to the movements of the input element (e.g., hand of the user), meets or exceeds the first threshold amount of rotation, the computer system rotates the virtual object and translates the virtual object in accordance with the input element. Rotating the virtual object in accordance with the rotation component, and translating the virtual object in accordance with the translation component, share one or more characteristics with rotating the virtual object in accordance with the rotation component, and translating the virtual object in accordance with the translation component respectively as described herein.

In some embodiments, after detecting termination of the first input, such as shown in FIG. 8Q wherein the hand 806 ceases to perform the gesture 808 (shown in FIG. 8A), the computer system detects, via the one or more input devices, a second input (e.g., second pinch-and-hold, a touch and drag input at a location of the virtual object, or a mouse click and drag input when the cursor is located at a position corresponding to the virtual object) directed to the virtual object that includes a translation component and a rotation component (such as if the gesture 808 FIG. 8B corresponded to a second input), and in response to detecting the second input (e.g., detecting a pinch-and-hold gesture following the termination of the first input), in accordance with a determination that more than the first threshold amount of translation (e.g., 5 pixels, 10 pixels, and/or 20 pixels) is detected in the translation component of the second input prior to detecting the rotation component of the second input, the computer system translates the virtual object within the three-dimensional environment in accordance with the translation component of the second input without rotating the virtual object in accordance with the rotation component of the second input, such as if FIG. 8B corresponded to a second input. Termination of the first input optionally includes a release of a gesture (e.g., pinch-and-hold) performed by the input element (e.g., hand of the user), the input element moving outside the viewpoint of the user, the input element moving slower than the threshold amount of movement for more than the threshold amount of time, and/or the input element being stopped for at least the threshold amount of time. In some embodiments, the second input (e.g., second pinch-and-hold) is detected following the termination of the first input (e.g., first pinch-and-hold). However, in some embodiments the computer system optionally terminates the first input when the computer system detects a second input (e.g., second-pinch-and-hold) directed to the virtual object. In some embodiments the termination of the first input corresponds with a second input element (e.g., second hand of the user) performing a gesture (e.g., pinch-and-hold) and/or a gesture corresponding to a separate functionality (e.g., resizing as described with respect to method 1100). In some embodiments, when the computer system detects that the hand of the user releases a first pinch-and-hold gesture, which was detected by the computer system in accordance with the initiation of the first input, the computer system terminates the first input. When the computer system detects the hand of the user performing a second pinch-and-hold gesture directed to a virtual object (e.g., the same virtual object corresponding to the first input, and/or a different virtual object than the virtual object corresponding to the first input) and while holding the second pinch-and-hold gesture, the computer system optionally detects the hand of the user moving in a translative manner in one or more directions, and the computer system detects the hand of the user moving in a rotative manner about one or more axes of rotation, and/or one or more points of rotation. A second input optionally corresponds to further movement (e.g., translation, and/or rotation) of a virtual object which was initially moved during the first input, and/or optionally corresponds to a virtual object which is different than the virtual object which was moved during the first input. For instance, in some embodiments a first input and a second input are detected toward the same virtual object (e.g., a representation of an airplane). Additionally or alternatively, in some embodiments the first input and second input correspond to different virtual objects (e.g., game pieces of a board game). A second input shares one or more characteristics with the first input as described herein. The computer system continues to rotate and translate the virtual object accordingly until the first input has ended. For instance, while the computer system is rotating and translating the virtual object while the user is maintaining a first pinch-and-hold gestures, the computer system optionally continues to do so until the pinch- and hold gesture is released. After the first input has ended, the computer system reverts and/or resets aspects related to the object translation and/or object rotation of the virtual object wherein the translation in accordance with the translation component of the second input and rotation component of the second input are independent of the translation component of the first input and the rotation component of the first input. In some embodiments, the computer system reverts and/or resets aspects (e.g., the rotation component, and/or the translation component) related to the detecting of the translation component and/or the rotation component of the first input. By resetting the translation component and/or the rotation component for instance, establishes a baseline position and baseline orientation of the hand of the user such that any input element translation and/or any input element rotation of the hand of the user is measured from the baseline position and orientation, such that the baseline position and baseline orientation correspond to a rotation component and translation component value of zero. When the computer system reverts and/or resets aspects related to the detecting of the translation component and/or or the rotation component of the first input, wherein translating the virtual object in accordance with any translation component and/or rotating the virtual object in accordance the second input are optionally independent of translations and/or rotations of the virtual object in accordance with the first input. By keeping the movement components (e.g., corresponding to input element rotation, and/or input element translation) of corresponding inputs (e.g., first input, and second input) independent of each other, the computer system allows the user to make successive yet independent movements allowing for the user to make successive yet unrelated modifications to the location and/or orientation of the virtual object.

In some embodiments, in response to detecting the first input, in accordance with a determination that the virtual object is a first type of object (e.g., virtual objects, and/or representation of a physical object) and that the translation component includes a first amount of movement in a first depth direction (e.g., away from the viewpoint of the user, or toward the viewpoint of the user), the computer system translates the virtual object of the first type by a second amount in the first depth direction, corresponding to the first amount of movement, within the three-dimensional environment, such as illustrated by the first model 852 in FIG. 8S.

In some embodiments, in response to detecting the first input, in accordance with a determination that the virtual object is a first type of object (e.g., virtual objects, and/or representation of a physical object) and that the translation component includes the first amount of movement in a second depth direction, opposite the first depth direction (e.g., toward the viewpoint of the user, or away from the viewpoint of the user), the computer system translates the virtual object of the first type by the second amount in the second depth direction within the three-dimensional environment, such as illustrated by the second model 854 in FIG. 8S wherein the first model is the same as the second model 852. When the computer system detects a translation component of a first input providing a translation movement directed to a first type of virtual object (e.g., representation of a physical object in the environment of the user, and/or a virtual object generated by the computer system), translational movements in the depth direction away from the viewpoint user and toward the viewpoint of the user, are optionally applied equally. For instance, when the translation component of the first input includes a translation amount X1 away from the user, the computer system optionally moves the virtual object of the first type a virtual distance Y1 away from the viewpoint of the user. Additionally or alternatively, when the translation component of the first input includes the translation amount X1 toward the user, the computer system moves the virtual object of the first type the virtual distance Y1 toward the user.

In some embodiments, in response to detecting the first input, in accordance with a determination that the virtual object is a second type of virtual object, different from the first type of object (e.g., application window) and that the translation component includes a third amount of movement in the first depth direction, the computer system translates the virtual object of the second type by a fourth amount in the first depth direction within the three-dimensional environment, such as illustrated by third model 856 as shown in FIG. 8U.

In some embodiments, in response to detecting the first input, in accordance with a determination that the virtual object is a second type of virtual object, different from the first type of object (e.g., application window) and that the translation component includes the third amount of movement in the second depth direction, the computer system translates the virtual object of the second type by a fifth amount, different than the fourth amount, in the second depth direction within the three-dimensional environment, as illustrated by model 858 in FIG. 8U, wherein the fourth model is different than the third model 856. Additionally or alternatively, when the computer system detects a translation component of the first input providing a translation movement (e.g., input element translation) directed to a second type of virtual object (e.g., content window, and/or application window), translational movements in the depth direction away from the user and toward the user, are optionally applied differently. For instance, when the translation component of the first input includes an input element translation amount X1 away from the user, the computer system optionally moves the virtual object of the second type a virtual distance Y2 away from the viewpoint of the user. Additionally or alternatively, when the translation component of the first input includes the input element translation amount X1 toward the user, the computer system moves the virtual object of the second type a virtual distance Y3 toward the user, wherein Y3≠Y2. In certain embodiments, input element translation movements away from the user applied to virtual objects of the second type have an increased object translation effect over input element translation movements toward the user (e.g., Y2>Y3), and in certain embodiments, the input element translation movements toward the user applied to virtual objects of the second type have an increased object translation effect over input element translation movements away from the user (e.g., Y3>Y2). By applying translational inputs (e.g., translation component) in the depth direction to different types of objects differently, the computer system enables the user to maintain a more realistic effect when moving virtual objects corresponding to a first type of object (e.g., representation of a physical object in the environment of the user, and/or a virtual object generated by the computer system), while enabling efficient movements of a second type of object (e.g., content windows).

It should be understood that the particular order in which the operations in method 900 have been described is merely exemplary and is not intended to indicate that the described order is the only order in which the operations could be performed. One of ordinary skill in the art would recognize various ways to reorder the operations described herein. In some embodiments, aspects/operations of method 900 may be interchanged, substituted, and/or added between these methods. For example, various object manipulation techniques and/or object movement techniques of method 900 is optionally interchanged, substituted, and/or added between these methods. For brevity, these details are not repeated here.

FIG. 10A-10W illustrate exemplary ways in which a computer system facilitates user interaction with a virtual object in a manner which allows the user to resize the virtual object. Although exemplary figures presented include the hand of a user, embodiments are not restricted thereto.

FIG. 10A illustrates a computer system 101 (e.g., an electronic device) displaying, via a display generation component 120 (e.g., display generation components 1-122a and 1-122b of FIG. 1), a three-dimensional environment 1000 from a viewpoint of a user of the computer system 101. In FIG. 10A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 10A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 1000. For example, three-dimensional environment 1000 includes representations of the rear and side walls of the room in which the computer system 101 is located.

As discussed in more detail below, in FIG. 10A, display generation component 120 is illustrated as displaying one or more virtual representations of physical objects in the three-dimensional environment 1000. In some embodiments, the one or more representations are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 10A-10W.

In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to methods 700, 900, 1100, and/or 1300), or via a trackpad from hand 406, and inputs described herein are optionally received via the trackpad or via air gestures/attention.

As illustrated in FIG. 10A, the computer system detects a gaze 1014 of the user directed toward a virtual object (e.g., cube 1004) which is displayed within the three-dimensional environment, and detects a hand 1006 of the user. The hand 1006 of the user has not provided a gesture or input while the gaze 1014 is directed toward the cube 1004. It is understood that in some embodiments, gestures (e.g., pinch, and/or pinch-and-hold) performed by one or more portions of the user (e.g., hand of the user) with respect to the current method correspond to air gestures.

As illustrated in FIG. 10B, the computer system 101 detects that the hand 1006 of the user performs a pinch and hold 1008 gesture while the gaze 1014 of the user is directed toward the cube 1004. The pinch-and-hold gesture corresponds to an indication to translate and/or rotate the cube as described with respect to FIG. 8A-8Y and with respect to method 900, such that following a pinch-and-hold gesture, translations of the hand 1006 of the user correspond to an indication to translate the cube 1004, and rotations of the hand 1006 of the user correspond to an indication to rotate the cube 1004. Positional diagram 1016 represents that the hand 1006 of the user has not moved from the current location 1018a at which the pinch-and-hold 1008 was detected by the computer system 101.

As illustrated in FIG. 10C, the computer system has detected that the user has performed a pinch-and-hold 1008 (in FIG. 10B) followed by a translation of the hand 1006 of the user while the gaze 1014 of the user is directed toward the cube. Accordingly, the computer system 101 optionally translates the cube 1004 by an amount corresponding to the translation of the hand of the user as described with respect FIG. 8A-8Y and with respect to method 900. Positional diagram 1016 represents that the hand 1006 of the user has translated to the right, to the current location 1018a, from the previous location 1018b shown in FIG. 10B.

In order to initiate a resizing operation, the computer system requires an indication to resize as related to the input element such as a gesture performed by a hand of the user which is different than the gesture required to initiate the rotation/translation operation(s). FIG. 10D illustrates the computer system 101 detecting a series of actions performed by the hand 1006 of the user which correspond to an indication to resize an object (e.g., cube 1004). At time 1011a, a finger 1015 and thumb 1017 of the hand 1006 of the user are shown as separated prior to performing a first pinch 1008a gesture as shown at time 1011b. Following the first pinch 1008a gesture, the finger 1015 and thumb are separated (e.g., at time 1011c) to release the first pinch 1008a gesture. Following the release of the first pinch gesture (e.g., at time 1011c), the computer system further detects the finger 1015 and thumb 1017 coming together in a second pinch 1008b gesture in which the second pinch 1008b is held, which indicates to the computer system 101 to initiate a resizing operation of the object to which the gaze 1014 of the user is directed. When the computer system detects that the second pinch 1008b (e.g., at time 1011d) gesture occurs within a threshold of time (e.g., under 0.5 seconds) from the detection of the first pinch 1008a gesture, the detection of the holding of the second pinch followed by movements of the hand of the user correspond with resizing the virtual object. However, when the computer system determines that the time elapsed between the first pinch 1008a and the second pinch 1008b exceeds the threshold of time (e.g., in excess of 0.1, 0.2, 0.5, 1, or 2 seconds), the detection of the holding of the second pinch followed by movements of the hand of the user correspond to translational and/or rotational movements such as described in relation to method 900.

As illustrated in FIG. 10E, the user has performed the first gesture (e.g., first pinch 1008a) and second gesture (e.g., second pinch 1008b) as discussed in relation to FIG. 10D, while the gaze 1014 of the user is directed to cube 1004. While the computer system detects that the gestures performed by the right hand 1006a of the user correspond to the resizing operation, the computer system detects movements 1010 of the right hand of the user in one or more directions, wherein the movements 1010 correspond to indications from the user to modify the dimensions 1012 (e.g., height 1012a, and/or width 1012b) of the cube 1004. Diagram 1016 includes reference axes corresponding to movements in the vertical direction (e.g., along a Y-axis) and movement in the horizontal direction (e.g., along an X-axis), from the current location 1018a of the right hand 1006a. For instance, as shown in FIG. 10E, the location of the right hand 1006a of the user has not been detected as having moved since the detection of the invocation (e.g., as shown in FIG. 10D) of the resizing operation as illustrated by positional diagram 1016.

Movements associated with the input element in the vertical direction optionally correspond to an increase in size when moving upward, and optionally correspond with a decrease in size when the input element is detected as moving downward. As illustrated in FIG. 10F, the computer system 101 detects that the right hand 1006a of the user has moved upward (e.g., along a vertical axis) while holding the second gesture (e.g., second pinch 1008b) to the current location 1018a, from the previous location 1018b (e.g., as shown in FIG. 10E). Accordingly, the computer system 101 has increased the dimensions 1012 of the cube in accordance with the movement of the right hand 1006a, in a manner such that the resizing occurs about the center 1020 of the cube.

When the resizing operation is initiated, greater magnitude movements of the input element correspond to greater magnitude resizing (e.g., a greater increase in size, or a greater decrease in size). As illustrated in FIG. 10G, the computer system 101 detects that the right hand of the user 1006a has moved further upward (e.g., along a vertical axis) from the previous location 1018b (e.g., as shown in FIG. 10F) while holding the second gesture (e.g., second pinch 1008b) to the current location 1018a. Accordingly, the computer system 101 has further increased the dimensions 1012 of the cube in accordance with the movement of the right hand 1006a in relation to the size of the cube shown in FIG. 10F, in a manner such that the resizing occurs about the center 1020 of the cube.

As illustrated in FIG. 10H, the computer system 101 detects that the right hand of the user 1006a has moved downward (e.g., along a vertical axis) while holding the second gesture (e.g., second pinch 1008b) to the current location 1018a, from the previous location 1018b (e.g., as shown in FIG. 10E). In accordance with detecting that the movement of the hand being in a downward direction, an indication to decrease the size of the cube, the computer system 101 has decreased the dimensions 1012 of the cube in accordance with the movement of the right hand 1006a, in a manner such that the resizing occurs about the center 1020 of the cube.

When resizing a virtual object in accordance with a movement of the input element (e.g., hand of the user) laterally (e.g., along a horizontal axis), the directions which correspond to an increase and/or decrease in size is dependent upon the input element which is detected by the computer system. For instance, the computer system detecting the right hand of the user moving rightward during a resizing operation indicates an increase in size of the virtual object, and the computer system detecting the right hand of the user moving leftward during the resizing operation indicates a decrease in size of the virtual object. In contrast, the computer system detecting the left hand of the user moving leftward during a resizing operation indicates an increase in size of the virtual object, and the computer system detecting the left hand of the user moving rightward during the resizing operation indicates a decrease in size of the virtual object. In some embodiments, while detecting the first input, when the computer system detects that the hand of the user is moving away from the virtual object, the computer system increases the size of the virtual object. Additionally or alternatively, when the computer system detects that the hand of the user is moving toward the virtual object, the computer system decreases the size of the virtual object. As illustrated in FIG. 10I, the computer system 101 detects that the right hand 1006a of the user has moved to the right (e.g., along a horizontal axis) while holding the second gesture (e.g., second pinch 1008b) to the current location 1018a, from the previous location 1018b (e.g., as shown in FIG. 10E). Accordingly, the computer system 101 has increased the dimensions 1012 of the cube in accordance with the movement of the right hand 1006a, in a manner such that the resizing occurs about the center 1020 of the cube.

As illustrated in FIG. 10J, the computer system 101 detects that the right hand of the user 1006a has moved to the left (e.g., along the horizontal axis) while holding the second gesture (e.g., second pinch 1008b) to the current location 1018a, from the previous location 1018b (e.g., as shown in FIG. 10E). Accordingly, the computer system 101 has decreased the dimensions 1012 of the cube in accordance with the movement of the right hand 1006a, in a manner such that the resizing occurs about the center 1020 of the cube.

As illustrated in FIG. 10K, the user has performed the first gesture (e.g., first pinch 1008a) and second gesture (e.g., second pinch 1008b) as discussed in relation to FIG. 10D, while the gaze 1014 of the user is directed to cube 1004 using their left hand 1006b. While the computer system detects that the gestures performed by the left hand 1006b of the user correspond to the resizing operation, the computer system detects for movements 1010 of the left hand of the user in one or more directions, wherein the movements 1010 correspond to indications from the user to modify the dimensions 1012 (e.g., height 1012a, and/or width 1012b) of the cube 1004. Diagram 1016 includes reference axes corresponding to movements in the vertical direction (e.g., along a Y-axis) and movement in the horizontal direction (e.g., along an X-axis), indicating to the current location 1018a of the left hand 1006b. For instance, as shown in FIG. 10K, the location of the left hand 1006b of the user has not been detected as having moved since the detection of the invocation of the resizing operation such as shown in FIG. 10D.

As illustrated in FIG. 10L, the computer system 101 detects that the left hand 1006b of the user has moved upward (e.g., along a vertical axis) while holding the second gesture (e.g., second pinch 1008b) to the current location 1018a, from the previous location 1018b (e.g., as shown in FIG. 10K). Accordingly, the computer system 101 has increased the dimensions 1012 of the cube in accordance with the movement of the left hand 1006b, in a manner such that the resizing occurs about the center 1020 of the cube.

As illustrated in FIG. 10M, the computer system 101 detects that the left hand of the user 1006b has moved downward (e.g., along a vertical axis) while holding the second gesture (e.g., second pinch 1008b) to the current location 1018a, from the previous location 1018b (e.g., as shown in FIG. 10E). Accordingly, the computer system 101 has decreased the dimensions 1012 of the cube in accordance with the movement of the left hand 1006b, in a manner such that the resizing occurs about the center 1020 of the cube.

As illustrated in FIG. 10N, the computer system 101 detects that the left hand 1006b of the user has moved to the left (e.g., along a horizontal axis) while holding the second gesture (e.g., second pinch 1008b) to the current location 1018a, from the previous location 1018b at which the computer system 101 detected the invocation of the resizing operation. Although, the movement 1010 of the left hand 1006b begins from the right of the viewpoint of the user (e.g., from the right side of the cube 1004 relative to the viewpoint of the user, and moving towards the cube 1004), the computer system determines that the left hand 1006b of the user is moving in the left direction along the horizontal axis thus indicating an increase in size of the cube 1004. Accordingly, the computer system 101 has increased the dimensions 1012 of the cube in accordance with the movement of the left hand 1006b, in a manner such that the resizing occurs about the center 1020 of the cube, in contrast to the resizing operation corresponding to the right hand 1014b of the user moving to the left, resulting in the computer system decreasing the size of the cube as shown in FIG. 10J.

As illustrated in FIG. 10O, the computer system 101 detects that the left hand of the user 1006b has moved downward (e.g., along a vertical axis) while holding the second gesture (e.g., second pinch 1008b) to the current location 1018a, from the previous location 1018b (e.g., as shown in FIG. 10E). Accordingly, the computer system 101 has decreased the dimensions 1012 of the cube in accordance with the movement of the left hand 1006b, in a manner such that the resizing occurs about the center 1020 of the cube. Again, although, the movement 1010 of the left hand 1006b begins from the right of the viewpoint of the user, the computer system determines that the left hand 1006b of the user is moving in the right direction along the horizontal axis thus indicating a decrease in size of the cube 1004.

When the computer system detects movements of the input corresponding to contrasting indications to resize (e.g., increase vs decrease) a virtual object, the computer system optionally determines the resizing operation based on the magnitude of the components of the resizing indications. For instance, as illustrated in FIG. 10P, the computer system 101 detects that the left hand of the user 1006b has moved diagonally upward and to the right from the previous location 1018b of the left hand with a vertical component (y1) and a horizontal component (x1), such that the vertical component is greater than the horizontal component. The movement by the left hand of the user upward indicates an increase in size of the cube 1004, and the movement by the left hand of the user rightward indicates a decrease in size of the cube 1004. In accordance with the vertical component of the movement 1010 of the left hand being greater than the horizontal component of the left hand, the computer system resizes (e.g., increases the scale of) the cube 1004 according to the vertical component, and forgoes resizing (e.g., decreasing the scale of) the cube 1004 in accordance with the horizontal component. Furthermore, in the event that the movements of the user correspond to conflicting resizing operations (e.g., indication to increase vs. indication to decrease), the computer system 101 resizes the cube 1004 in accordance with the component (e.g., vertical or horizontal) which exhibits a greater magnitude (e.g., absolute value).

Once the computer system 101 initiates resizing the virtual object in accordance with movements of the input element along a first axis, the computer system optionally forgoes resizing the virtual object in accordance with movements of the input element along a second axis. As illustrated in FIG. 10Q, while the computer system detects the first input (e.g., the hand 1006 of the user maintains the gesture 1008 (e.g., an air pinch) following the invocation of the resizing operation (e.g., as shown in FIG. 10D)), the computer system 101 resizes the cube 1004 in accordance with movements along a single axis. Accordingly, following a movement of the hand 1006 of the user vertically upward (e.g., as shown in FIG. 10F) to a current location 1018a (e.g., as shown in FIG. 10Q), which results in increasing the one or more dimensions 1012 of the cube 1004, when the computer system 101 detects that the hand 1006 of the user moves horizontally to the right to a current location 1018a (e.g., as shown in FIG. 10Q), the computer system 101 forgoes resizing the cube 1004 in accordance with the movement 1010 of the hand along the second axis (e.g., horizontal axis).

While resizing operations described and illustrated herein are performed about a center of the virtual object, in some embodiments the computer system resizes virtual objects about a point which the attention of the user is directed toward. As illustrated in FIG. 10R, in some embodiments, when the computer system detects that the gaze 1014 of the user is detected as directed to a first point 1022a on the cube 1004 when the computer system detects that the second gesture (e.g., second pinch 1008b) has been performed by the hand 1006 of the user, the computer system establishes the center of scaling (e.g., increasing, and/or decreasing) as the first point 1022a on the cube which the gaze of the user is directed to.

As illustrated in FIG. 10S, after establishing a center of scaling at the first point 1022a where the gaze 1014 of the user is directed to, when the computer system detects that the hand 1006 of the user moves to the right from the previous location 1018b, the computer system increases the scale of the cube 1004 in accordance with a center of scaling at the first point 1022, wherein the first point 1022a of the cube remains static as the rest of the cube 1004 is resized according to the movements 1010 of the hand 1006 of the user. Accordingly, in accordance with the right hand 1006a of the user moving rightward while the gaze of the user is directed toward the first point 1022a on the cube, the computer system increases the size of the cube with a center of scaling about the first point 1022a on the cube.

As illustrated in FIG. 10T, in some embodiments, when the computer system detects that the gaze 1014 of the user is detected as directed to a second point 1022b (e.g., different from the first point 1022a) on the cube 1004, when the computer system detects that the second gesture (e.g., second pinch 1008b) has been performed by the hand 1006 of the user, the computer system establishes the center of scaling (e.g., increasing, and/or decreasing) as the second point 1022b on the cube which the gaze of the user is directed to.

As illustrated in FIG. 10U, after establishing a center of scaling at the second point 1022b where the gaze 1014 of the user is directed to, when the computer system detects that the left hand 1006b of the user moves to the left from the previous location 1018b, the computer system increases the scale of the cube 1004 with a center of scaling at the second point 1022b, wherein the second point 1022b of the cube remains static as the rest of the cube 1004 is resized about the second point 1022b according to the movements 1010 of the hand 1006 of the user.

As illustrated in FIG. 10V, when the computer system 101 detects that the object (e.g., cube 1004) is oriented in a manner in which axes 1024 of the object, such as those which are parallel to the edges of the cube 1004 as shown, are not aligned with axes corresponding with the real world (e.g., vertical, horizontal, and/or in a depth direction), the axes corresponding to the resizing of the object (e.g., x-axis, and/or y-axis) are optionally aligned with the axes 1024 of the cube.

As illustrated in FIG. 10W, the axes of resizing of the cube 1004 are aligned with the axes 1024 of the cube, and when the computer system detects that the movement 1010 of the hand 1006 in association with the axes 1024 of the cube, the computer system resizes the cube in accordance with movements of the hand of the user in reference to the axes of resizing as aligned with the orientation of the cube. Accordingly, when the computer system 101 detects that the right hand 1006a of the user moves diagonally up and to the left to current location 1018a from previous location 1018b (e.g., with reference to real-world axes), the computer system increases the size of the cube 1004 in accordance with the movement 1010 of the hand of the user as if the movement of the hand only included vertical movement and no horizontal movement, because relative to the axes of the cube 1004, the movement of the hand only included vertical movement and no horizontal movement.

FIG. 11 is a flowchart illustrating a method of resizing virtual objects corresponding to an input received from an input element directed to the virtual object, wherein the manner of resizing is dependent upon the type of input element, the direction in which the input element is detected as moving following detection of the input, and/or the attention of the user, in accordance with some embodiments. In some embodiments, the method 1100 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1100 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1100 are, optionally, combined and/or the order of some operations is, optionally, changed.

In some embodiments, method 1100 is performed at a computer system in communication with one or more display generation components, and one or more input devices. For example, a computer system, the one or more input devices, and/or the display generation component have one or more characteristics of the computer system(s), the one or more input devices, and/or the display generation component(s) described with respect to methods 700, 900, and/or 1300. In some embodiments the computer system is configured to provide a view of a physical environment surrounding a user, however the embodiments discussed herein are not limited thereto.

In some embodiments, while displaying, via the one or more display generation components, a virtual object in a three-dimensional environment, the computer system detects (1102) a first input directed to the virtual object, which includes a selection input portion corresponding to an input element (such as the pinch/release/pinch- and hold sequence as illustrated in FIG. 10D, for example a selection input portion of an input element such as one or more portions of a user or a remote controller) followed by a movement input portion (such as movement 1010 of the right hand 1006a of the user in FIG. 10F) that includes movement of the input element through a physical environment (e.g., movement of the one or more portions of the user or the remote controller).

In some embodiments, displaying of a virtual object in a three-dimensional environment, the three-dimensional environment the display generation component, and/or the virtual object share one or more characteristics with displaying of the virtual object in a three-dimensional environment, the three-dimensional environment, the display generation component, and the virtual object described with respect to methods 700, 900, and/or 1300.

In some embodiments, the computer system detects a first input directed to the virtual object. The first input optionally includes a selection input performed by the input element (e.g., one or more portions of the user, or remote controller) corresponding to an indication to resize the virtual object based on subsequent movement of the input element. In some embodiments, the input element shares one or more characteristics with the input element with respect to methods 700, 900, and/or 1300. A selection input optionally includes an air gesture performed by the input element (e.g., an air-pinch). For instance, the first input optionally includes the user performing the selection input (e.g., an air-pinch followed by an air-pinch-and-hold directed) with a first hand, followed by the first hand moving in a first direction. Additionally or alternatively, the first input optionally includes the first input element (e.g., a first finger, or remote controller) performing a touch-and-drag input on a touch-sensitive surface directed to the virtual object. In some embodiments, a user input (e.g., first input) is directed to the virtual object when the representation of the hand of the user is in near proximity to the virtual object, is detected as moving toward the virtual object, obscures one or more portions of the virtual object, and/or the gaze of the user is directed to the virtual object when the selection input is detected.

In some embodiments, in response to detecting the first input directed to the virtual object (such as based on gaze 1014 in FIG. 10D), and in accordance with a determination that the selection input portion satisfies one or more criteria, including a criterion that is satisfied when the selection input portion includes a selection event (e.g., first pinch 1008a in FIG. 10D) followed by a select and hold event (such as second pinch 1008b and hold in FIG. 10D) (1104), the computer system resizes (1106) the virtual object within the three-dimensional environment in accordance with the movement of the input element (e.g., while the one or more portions of the user are maintaining the selection event such as the air pinch-and-hold gesture. In some embodiments, the selection event followed by the select and hold event is an air-pinch gesture from a hand of the user followed by an air-pinch-and-hold gesture from the hand of the user.

In some embodiments, when the computer system detects that the user has performed a selection input including a first air-pinch followed by a second air-pinch which is held (e.g., for a threshold hold time period), the computer system determines that the one or more criteria are satisfied. A threshold hold time period optionally includes lengths of time including: less than 1 ms, 50 ms, 100 ms, 250 ms, 0.5 s, 1 s, and more than 1 s. For instance, when the first hand of the user is detected as performing an air-pinch motion between a thumb and finger (e.g., forefinger), followed by a separation of the thumb and finger (e.g., air-pinch-and-release), followed by a repetition of the air-pinch motion, the computer system determines that a selection input that satisfies the one or more criteria has been received. In some embodiments, the second air-pinch is an air-pinch-and-hold, which includes the user touching a first finger to a second finger (e.g., thumb to forefinger) for longer than the above-described threshold hold time period. In some embodiments the repetition of the second air-pinch must be performed within a threshold gesture time period measured between the two or more interrelated gestures (e.g., between the release of the first air-pinch-and-release and the second air-pinch). In some embodiments the threshold gesture time period shares one or more characteristics with the threshold hold time period as described herein. A threshold gesture time period optionally includes lengths of time including: less than 1 ms, 50 ms, 100 ms, 250 ms, 0.5 s, 1 s, and more than 1 s.

In some embodiments, the one or more criteria include a criterion that is satisfied when a gaze of the user is detected (e.g., via the eye tracking device) as being directed to the virtual object. Accordingly, when the selection input directed to the virtual object is detected while the gaze of the user is not detected as directed to the virtual object, the computer system optionally determines that the one or more criteria have not been satisfied. In some embodiments the eye tracking device shares one or more characteristics with the eye tracking device described with respect to method 900. Furthermore, when the computer system detects that a first portion of the user (e.g., first hand) performs a pinch-and-release, and a second portion of the user (e.g., a second hand) performs a pinch-and-hold, the computer system optionally determines that the one or more criteria have not been satisfied.

In some embodiments, when the input element is detected performing the selection event (e.g., an air-pinch-and-release followed by an air-pinch-and-hold) corresponding to the selection input directed to the virtual object, and the select and hold event (e.g., air-pinch-and-hold) is released prior to the movement of the input element (e.g., first hand), the computer system optionally forgoes resizing the virtual object.

In some embodiments, resizing the virtual object within the three-dimensional environment in accordance with the movement of the input element includes changing (1108) a size of the virtual object by a first size amount, corresponding to the first movement amount. For instance, as shown in FIG. 10F, the hand of the user moves a first amount from the previous position 1018b to the current position 1018a by a first amount, and the computer system resizes the cube 1004 dimensions (e.g., height 1012a, and/or width 1012b) by a first amount (e.g., H+1, and/or W+1).

In some embodiments, resizing the virtual object within the three-dimensional environment in accordance with the movement of the input element includes, in accordance with a determination that the input element moves by a second movement amount, different from the first movement amount, changing (1112) the size of the virtual object by a second size amount, different from the first size amount, corresponding to the second movement amount. For instance, as shown in FIG. 10G, the hand of the user moves a first amount from the previous position 1018b (1018a in FIG. 10F) to the current position 1018a by a second amount, resulting in a total hand movement of more than the first amount illustrated in FIG. 10F, and the computer system resizes the cube 1004 dimensions (e.g., height 1012a, and/or width 1012b) by a second amount (e.g., H+2, and/or W+2), which results in a cube size which is different than (e.g., greater than) the cube size in relation to the movement of the hand by the first amount.

When the selection event corresponds to the selection input received from the input element directed to the virtual object s (e.g., one or more portions of the user, and/or one or more remote controllers) satisfies the one or more criteria, and the input element moves a first movement amount, the computer system optionally changes the size (e.g., stretches, scales, and/or skews) of the virtual object by a first size amount. When the selection input received from input element satisfies the one or more criteria, and the input element moves a second movement amount (e.g., more than the first movement amount, or less than the first movement amount) the computer system optionally changes the size (e.g., stretches, scales, and/or skews) of the virtual object by a second size amount (e.g., more than the first size amount, or less than the second size amount). The amount by which the virtual object is resized optionally relates to a resizing of one or more visual characteristics (e.g., scale, height, and/or width) in proportion to the one or more visual characteristics prior to the resizing operation. The relationship between the movement amount of the input element and the amount by which the virtual object is resized optionally includes: a linear model, and/or a non-linear model (such as an exponential model).

In some embodiments, following the selection input, when the first hand of the user moves a movement amount X1, the virtual object (e.g., an application window, a three-dimensional virtual object, or other virtual object) is optionally resized by an amount Y1. However, when the first hand of the user moves a movement amount X2, the application window is optionally resized by an amount Y2. In certain embodiments, when X1<X2, then Y1<Y2.

For instance, when using a linear model for the relationship between the movement amount and the size amount by which the virtual object is changed, following the selection input, when X1=2X2, then optionally Y1=2Y2, meaning that a second movement (e.g., X1) having twice the movement amount, will result in twice the amount (e.g., Y1) of resizing. For instance, when using a first resizing model (e.g., linear resizing model), if the first user of hand moves 50 pixels during a first selection input (e.g., first air-pinch, then air-pinch-and-hold) directed to a first content window, the size of the first application window is optionally increased by 10%, and when the first hand of the user moves 100 pixels during a second selection input, the size of the content window is optionally increased by 20%.

In some embodiments, when using an exponential model for the relationship between the movement amount and the size amount by which the virtual object is changed, when X1=2X2, then optionally Y1=4Y2, meaning that a second movement (e.g., X1) having twice the movement amount, will result in four times the amount (e.g., Y1) of resizing. In some embodiments, between the movement amount and the size amount by which the virtual object is changed is dictated by a predetermined algorithm.

In some embodiments, the size change of the virtual object is applied universally such that the visual appearance, other than scale of the virtual object, is not altered. However, in some embodiments the size change applied to a virtual object is applied to one or more characteristics of the virtual object (e.g., x-axis, y-axis, and/or z-axis) which results in a stretching or skewing effect.

In some embodiments the movement amount is measured in virtual units (e.g., pixels) as related to the representation of the input element. In some embodiments the movement amount is measured in physical units (e.g., mm, cm, or m) as related to the physical movements of the input element in the real physical world. In some embodiments the movement of the input element as described herein relates to the measurement of displacement, velocity, and/or acceleration of the input element. For instance, a larger movement amount of displacement in relation to the movement of the first hand of a user, the larger the amount of the resizing. The movement amount shares one or more characteristics with the translation threshold and/or the rotation threshold as described with respect to method 900. By changing the size of a virtual object following a selection input such as an air-pinch followed by an air-pinch-and-hold, the computer system enables a user to resize virtual content with a single handed gesture without requiring the use of two-hands, or a secondary input device (e.g., mouse, stylus, or keyboard), thereby conserving computer resources that would otherwise be necessary to process two handed gestures for resizing virtual content. Furthermore, by changing the size of the virtual object only after a selection input is detected, the computer system prevents unintentional resizing of virtual objects.

In some embodiments, the one or more criteria include a criterion that is satisfied when the select and hold event follows the selection event within a threshold amount of time, such as if times 1011a-1011d as illustrated in FIG. 10D occur within a period of time (e.g., 1 second). In some embodiments the computer system initiates the resizing operation when a criterion is satisfied which requires detecting that the select and hold (e.g., an air-pinch-and-hold, or click-and-hold) event occurs within a threshold amount of time (e.g., less than 50 milliseconds, 50 milliseconds, 150 milliseconds, 0.5 seconds, 1 second, 3 seconds, 5 seconds, 10 seconds, or more than 10 seconds) following the selection event. When the select and hold does not follow the selection event within the threshold amount of time following the selection event, or only a select and hold event is detected, the computer system optionally forgoes initiating the resizing operation, and/or initiates a translation and/or rotation operation which shares one or more characteristics with the translation and/or rotation operations as described with respect to method 900. The threshold amount of time with respect to time between the selection event and the select and hold event optionally shares one or more characteristics with the predetermined time period described with respect to method 900. For instance, when the threshold amount of time as related to the time between the selection event and the select and hold event is 0.5 seconds, when the computer system detects a hand of the user performing an air-pinch followed by an air-pinch-and-hold within 0.4 seconds, the computer system optionally initiates the resizing operation. Additionally or alternatively, when the computer system detects a hand of the user performing an air-pinch followed by an air-pinch-and-hold within 2.5 seconds, the computer system optionally forgoes initiating the resizing operation. By requiring the select and hold event to follow the selection event within a threshold amount of time prior to initiating the resizing operation, the computer system is able to differentiate events (e.g., selection event, and/or selection and hold event) which correspond to separate inputs (e.g., first input, or second input) or a single input and mitigate unintended initiation of the resizing operation.

In some embodiments, the one or more criteria include a criterion that is satisfied when the select and hold event is maintained for at least a threshold amount of time (e.g., 150 milliseconds, 0.3 seconds, 0.5 seconds, 1 second, or more than 1 second), such as if the second pinch 1008b in FIG. 10D is held for at least a period of time (e.g., 1 second). The threshold amount of time with respect to the length of time which the select and hold event is maintained shares one or more characteristics with the threshold amount of time as described with respect to the time between a select event and a select and hold event as described herein. In some embodiments, the computer system initiates the resizing operation only upon satisfying a criterion which requires detecting that the select and hold (e.g., air-pinch-and-hold, or click-and-hold) event is maintained for at least a threshold amount of time. For instance, a pinch- and hold is optionally considered to be maintained when the thumb and finger are held together after contacting each other. Additionally or alternatively, a select-and-hold involving an input element (e.g., game controller) optionally includes the press-and-hold of a button on the game controller. A threshold amount of time as related to the length of time that the select and hold event is maintained optionally shares one or more characteristics with the predetermined time period described with respect to method 900. For instance, when the threshold amount of time as related to the time that the select and hold event is maintained is 0.5 seconds, when the computer system detects that a selection and hold event (e.g., air-pinch-and-hold) following a selection event (e.g., air-pinch) is held for 0.6 seconds, the computer system optionally initiates the resizing operation. Additionally or alternatively, when the computer systems detects that a selection and hold event (e.g., air-pinch-and-hold) following a selection event (e.g., air-pinch) is maintained for 0.25 seconds prior to releasing the select and hold event, the computer system optionally forgoes initiating the resizing operation. Additionally or alternatively, when the input element begins moving before the select-and-hold event is maintained for the threshold amount of time, the computer system forgoes resizing the virtual object until the criteria has been satisfied. When the one or more criteria is satisfied during the movement of the input element, the computer system optionally resizes the virtual object from the time at which the one or more criteria has been satisfied. By requiring that the select and hold event to be maintained for at least a threshold amount of time, the computer system is able to differentiate between separate individual selection events and select and hold events to mitigate unintended initiation of the resizing operation.

In some embodiments, in response to detecting the first input directed to the virtual object, in accordance with a determination that the selection input portion does not satisfy the one or more criteria because the selection input portion includes a selection event that is not followed by a select and hold event, the computer system moves the virtual object within the three-dimensional environment in accordance with the movement of the input element without resizing the virtual object within the three-dimensional environment in accordance with the movement of the input element, such as illustrated with respect to FIG. 10A-10B wherein the right hand 1006a of the user is detected by the computer system as only performing a pinch and hold 1008b followed by movement 1010 of the hand, corresponding to movements of virtual objects as related to method 900 for instance. In some embodiments, when the computer system detects that a selection event includes a selection event without a subsequent select and hold event, the computer system optionally moves (e.g., translates, and/or rotates) the virtual object in accordance with the one or more movements of the input element, without resizing the virtual object. In some embodiments, in response to a selection event that is not followed by a select and hold event, the virtual object comes under control of the movement input element that performed the selection event such that while the computer system detects that the pinch is maintained (e.g., the selection event), the computer system moves the virtual object by an amount (e.g., 5 pixels, 15 pixels, 30 pixels, 50 pixels, 100 pixels, or 250 pixels) in accordance with the movement of the input element. Movement of the virtual object in accordance with the movement of the input element optionally corresponds to the amount of movement (e.g., 5 cm, 10 cm, 20 cm, or 40 cm) and/or the direction (e.g., up, down, left, and/or right) of movement of the input element. For instance, when the input element (e.g., right hand of the user) is detected by the computer system as moving left by 20 cm, the computer system optionally translates the virtual object to the left by 35 pixels, and detecting the movement of the input element to the right by 20 cm optionally translates the virtual object to the right by 35 pixels. Additionally or alternatively, when the computer system detects the movement of the input element by 20 cm upward or downward, the computer system optionally translates the virtual object with respect to the direction of the input element by 35 pixels, or optionally translates the virtual object by an amount incongruent with translations made in the left or right direction, such that translations detected by the computer system in the vertical direction are optionally greater or less than counterpart translations in the horizontal direction. For instance, while translations of the input element detected by the computer system to the right by 20 cm optionally results in the computer system translating the virtual object to the right by 35 pixels, a translation of the input element upward by 20 pixels detected by the computer system, optionally results in the computer system translating the virtual object upward by 20 pixels or 50 pixels. Moving the virtual object optionally shares one or more characteristics with translating and/or rotating the virtual object as described with respect to method 900. By requiring a select event prior to the select and hold event to initiate the resizing operation, the computer system optionally distinguishes between separate functionalities with respect to modifying the virtual object such as distinguishing between a movement operation (e.g., rotating, and/or translating) a resizing operation as related to the virtual object within the three-dimensional environment.

In some embodiments, changing the size of the virtual object by the first size amount includes, in accordance with a determination that the input element moves in a first direction relative to a frame of reference (e.g., leftward, or rightward), increasing the size of the virtual object, such as illustrated in FIG. 10F wherein a movement 1010 of the hand 1006 of the user upwards results in the computer system increasing the size of the cube 1004. In some embodiments, when the computer system detects the movement of the input element (e.g., hand of the user, and/or remote controller) in the first direction (e.g., toward the right from the viewpoint of the user), the computer system optionally increases the size of the virtual object in a manner which corresponds to the movements of the input element in the first direction. The frame of reference optionally corresponds to a reference plane which bifurcates the viewpoint of the user, wherein the plane is configured to intersect a portion of the user (e.g., between the eyes of the user, coincident with the nose of the user, and/or perpendicular to an axis which extends between a first eye of the user and a second eye of the user). In some embodiments, the frame of reference corresponds with a vertical plane based on a vertical direction in the physical world, additionally or alternatively the frame of reference is updated dependent upon the orientation of the head of the user. For instance, when the frame of reference corresponds a reference plane, the frame of reference optionally updates with movements of the head of the user, such that when the head of the user tilts to the left, the reference plane optionally rotates clockwise, and when the head of the user tilts to the right, the reference plane optionally rotates counterclockwise.

In some embodiments, changing the size of the virtual object by the first size amount includes, in accordance with a determination that the input element moves in a second direction, different from the first direction, relative to the frame of reference, decreasing the size of the virtual object, such as illustrated in FIG. 10H wherein a movement 1010 of the hand 1006 of the user downwards results in the computer system decreasing the size of the cube 1004. In some embodiments, when the computer system detects the movement of the input element (e.g., hand of the user, and/or remote controller) in the second direction (e.g., toward the right from the viewpoint of the user), which is optionally in the opposite direction of the first direction, the computer system optionally decreases the size of the virtual object in a manner which corresponds to the movements of the input element. In some embodiments the first direction corresponds to a direction which is toward virtual object, such that when the movement of the input element is toward the virtual object, the computer system optionally increases the size of the virtual object. Additionally or alternatively, the second direction optionally corresponds with a direction which is away from the virtual object, the computer system optionally decreases the size of the virtual object. By interpreting the movements of the input element in the first direction as corresponding to increasing the size of the virtual object and movements of the input element in the second direction as corresponding to decreasing the size of the virtual object, the computer system allows the user to resize the virtual object (e.g., increase, and/or decrease) without any further input beyond the direction of movement, and allows the user to refine the resizing of the virtual object within the same input.

In some embodiments, changing the size of the virtual object by the first size amount includes, in accordance with a determination that the input element is a first hand of the user that moves in the first direction (e.g., leftward, or rightward), increasing the size of the virtual object. For instance, as illustrated in FIG. 10I, the computer system detects the right hand 1006a of the user moving 1010 to the right, resulting in the computer system increasing of the size of the cube.

In some embodiments, changing the size of the virtual object by the first size amount includes, in accordance with a determination that the input element is the first hand of the user that moves in the second direction, different from the first direction, decreasing the size of the virtual object. For instance, as illustrated in FIG. 10J, the computer system detects the right hand 1006a of the user moving 1010 to the left, resulting in the computer system decreasing of the size of the cube.

In some embodiments, changing the size of the virtual object by the first size amount includes, in accordance with detecting that the input element is a second hand of the user, different from the first hand, and in accordance with a determination that the input element is a second hand of the user, different from the first hand of the user that moves in the first direction (e.g., leftward, or rightward), decreasing the size of the virtual object. For instance, as illustrated in FIG. 10O, the computer system detects the left hand 1006b of the user moving 1010 to the right, resulting in the computer system decreasing of the size of the cube.

In some embodiments, changing the size of the virtual object by the first size amount includes, in accordance with detecting that the input element is a second hand of the user, different from the first hand, and in accordance with a determination that the input element is the second hand of the user that moves in the second direction, different from the first direction, increasing the size of the virtual object. For instance, as illustrated in FIG. 10N, the computer system detects the left hand 1006b of the user moving 1010 to the left, resulting in the computer system increasing of the size of the cube.

In some embodiments, when the first hand of the user (e.g., right hand, or left hand) is detected as performing the first input directed toward the virtual object, and the first hand moves in the first direction (e.g., left or right), the computer system increases the size of the virtual object in accordance with the first movement amount of the first hand in the first direction. In some embodiments, the first hand corresponds with the first direction (e.g., right hand moving to the right, or left hand moving to the left), while the opposite is within the spirit and scope of the present disclosure. In some embodiments, when the second hand of the user (e.g., opposite of the first hand) is detected as performing the first input directed toward the virtual object, and the first hand moves in the second direction (e.g., left or right), the computer system increases the size of the virtual object in accordance with the first movement amount of the second hand in the second direction. In some embodiments, the second hand corresponds with the second direction (e.g., right hand moving to the right, or left hand moving to the left), while the opposite is within the spirit and scope of the present disclosure. In some embodiments, when the computer system detects the movement of the first hand or the second hand, a reference plane (e.g., median plane of the user) provides a neutral location wherein movements on the opposite side of the reference plane from hand of the user correspond to a reduction in size, and movements on the same side of the reference plane correspond to an increase in size. For instance, when the computer system detects that the right hand of the user has initiated the resizing operation, a location of the right hand of the user to the right of the median plane optionally corresponds to an increase in size of the virtual object, a location of the right hand of the user to the left of the median plane of the user optionally corresponds to a reduction in size of the virtual object, and a location of the right hand of the user coinciding with the median plane corresponds with no change in in size of the virtual object. In some embodiments the first direction corresponds to a direction which is toward virtual object, when the movement is performed by a first hand, and the first direction corresponds to a direction which is away from the virtual object when the movements is performed by a second hand. By applying resizing of the virtual object according to which hand of the user is used to initiate the resizing operation, the computer system allows the user to use a preferred hand (e.g., dominant hand) to resize the virtual object wherein the increase and decrease of the size of the virtual object is related to which hand of the user is used to modify the size of the virtual object.

In some embodiments, resizing the virtual object in accordance with the movement of the input element includes, in accordance with detecting movement of the input element along a first axis (e.g., vertical axis) in a first direction (e.g., up, or down), increasing the size of the virtual object in accordance with the movement of the input element in the first direction, such as illustrated in 10F, wherein the computer system detects the right hand 1006a of the user moving upward, and in response, increasing the size of the cube 1004.

In some embodiments the resizing of an object is related to the direction of the first movement amount performed by the input element (e.g., hand of the user, and/or remote controller).

In some embodiments, resizing the virtual object in accordance with the movement of the input element includes, in accordance with detecting movement of the input element along the first axis (e.g., vertical axis) in a second direction (e.g., down, or up), different than the first direction (e.g., opposite), decreasing the size of the virtual object in accordance with the movement of the input element in the second direction, such as illustrated in 10H, wherein the computer system detects the right hand 1006a of the user moving downward, and in response, decreasing the size of the cube 1004. For instance, when the first movement amount is in a second direction along the first axis, opposite the first direction (e.g., downward), the computer system decreases the size of the virtual object corresponding to the first movement amount.

In some embodiments, resizing the virtual object in accordance with the movement of the input element includes, in accordance with detecting the movement of the input element along a second axis (e.g., horizontal axis), different from the first axis (e.g., orthogonal, or diagonal to the first axis in a third direction (e.g., right, or left), increasing the size of the virtual object, in accordance with the movement of the input element in the third direction, such as illustrated in 10I, wherein the computer system detects the right hand 1006a of the user moving rightward, and in response, increasing the size of the cube 1004.

In some embodiments, resizing the virtual object in accordance with the movement of the input element includes, in accordance with detecting the movement of the input element along the second axis (e.g., horizontal axis), different from the first axis (e.g., orthogonal, or diagonal to the first axis in a fourth direction (e.g., left, or right), different than the third direction (e.g., opposite), decreasing the size of the virtual object in accordance with the movement of the input element in the fourth direction, such as illustrated in 10J, wherein the computer system detects the right hand 1006a of the user moving leftward, and in response, decreasing the size of the cube 1004. For instance, when the input element corresponds to a hand of the user, and the first movement amount is in an upward direction along a vertical axis, the computer system optionally increases the size of the virtual object corresponding to the first movement amount. In contrast, movement of the hand in a downward direction along the vertical axis optionally results in the computer system decreasing the size of the virtual object. However, movement in the upward direction optionally corresponds to a decrease in size of the virtual object, and movement in the downward direction optionally corresponds to an increase in size of the virtual object. Movement in a rightward direction along a horizontal axis optionally results in the computer system increasing the size of the virtual object. In contrast, movement in a leftward direction along the horizontal axis optionally results in the computer system decreasing the size of the virtual object. However, movement in the rightward direction optionally corresponds to a decrease in size of the virtual object, and movement in the leftward direction optionally corresponds to an increase in size of the virtual object. By increasing and/or decreasing the size of the virtual object in accordance with movements across two axes, the computer system is able to resize the virtual object according to natural movements of the user which do not require the movements of the user to be restricted to a single axis.

In some embodiments, resizing the virtual object in accordance with the movement of the input element includes, in accordance with detecting movement of the input element in a third direction (e.g., right, or left) along a second axis, and in accordance with detecting that the input element is a first hand (e.g., right hand, or left hand) of the user, increasing the size of the virtual object in accordance with the movement of the input element in the third direction, such as illustrated in 10I, wherein the computer system detects the right hand 1006a of the user moving rightward, and in response, increasing the size of the cube 1004.

In some embodiments, resizing the virtual object in accordance with the movement of the input element includes, in accordance with detecting movement of the input element in a fourth direction (e.g., left, or right)), different than the third direction (e.g., different than, and/or opposite), along the second axis, and in accordance with detecting that the input element is the first hand of the user, decreasing the size of the virtual object in accordance with the movement of the input element in the fourth direction, such as illustrated in 10J, wherein the computer system detects the right hand 1006a of the user moving leftward, and in response, decreasing the size of the cube 1004.

In some embodiments, resizing the virtual object in accordance with the movement of the input element includes, in accordance with detecting movement of the input element along the second axis in the third direction, and in accordance with detecting that the input element is a second hand (e.g., left hand, or right hand) of the user, different from the first hand (e.g., opposite of the first hand), decreasing the size of the virtual object in accordance with the movement of the input element in the third direction, such as illustrated in 10O, wherein the computer system detects the left hand 1006b of the user moving rightward, and in response, decreasing the size of the cube 1004. In some embodiments, the manner of resizing (e.g., increasing, or decreasing) is optionally dependent upon which hand is detected in accordance with the first input. For instance, when the computer system detects the left hand of the user in accordance with the first input, the computer system increases the size of the virtual object in accordance with a movement of the left hand of the user in a leftward direction, and reduces the size of the virtual object in accordance with a movement of the left hand in a rightward direction. Additionally or alternatively, when the computer system detects the right hand of the user in accordance with the first input, the computer system increases the size of the virtual object in accordance with a movement of the right hand of the user in a rightward direction, and reduces the size of the virtual object in accordance with a movement of the right hand in a leftward direction.

In some embodiments, resizing the virtual object in accordance with the movement of the input element includes, in accordance with detecting movement of the input element in the fourth direction along the second axis, and in accordance with detecting that the input element is the second hand of the user, increasing the size of the virtual in accordance with the movement of the input element in the fourth direction, such as illustrated in 10N, wherein the computer system detects the left hand 1006b of the user moving leftward, and in response, increasing the size of the cube 1004.

In some embodiments, resizing the virtual object in accordance with the movement of the input element includes, in accordance with detecting movement of the input element in the first direction along a first axis (e.g., up, or down), increasing the size of the virtual object in accordance with the movement of the input element in the first direction. For instance, as illustrated in FIG. 10F and FIG. 10L, the computer system detects the hand (e.g., right hand 1006a, or left hand 1006b) of the user moving 1010 upward, resulting in the computer system increasing the size of the cube 1004.

In some embodiments, resizing the virtual object in accordance with the movement of the input element includes, in accordance with detecting movement of the input element in a second direction (e.g., down, or up), different than the first direction (e.g., opposite), along the first axis, decreasing the size of the virtual object in accordance with the movement of the input element in the second direction. For instance, as illustrated in FIG. 10H and FIG. 10M, the computer system detects the hand (e.g., right hand 1006a, or left hand 1006b) of the user moving 1010 downward, resulting in the computer system decreasing the size of the cube 1004. In some embodiments, the direction(s) which correspond to an increase of size or a reduction in size during the resizing operation is independent of which hand (e.g., left hand, or right hand) of the user is detected during the first input. For instance, in some embodiments when the hand of the user is detected moving along a first axis (e.g., vertical axis), the computer system optionally increases the size of the virtual object when the movement amount is in an upward direction along the vertical axis, and optionally decreases the size of the virtual object when the movement amount is in a downward direction along the vertical axis agnostic to which hand of the user is detected. By resizing the virtual object based on movement along a first axis in a manner which is agnostic to which hand of the user is detected in accordance with the first input, and resizing the object along a second axis in a manner which is dependent on which hand of the user is detected in accordance with the first input, allows the computer system to accommodate users with left-hand dominance or right-hand dominance.

In some embodiments, in response to detecting the first input directed to the virtual object, in accordance with a determination that the movement of the input element includes movement along the first axis (e.g., vertical and/or horizontal) followed by movement of the input element along the second axis after detecting movement of the input element along the first axis (and/or after resizing the virtual object in accordance with movement of the input element along the first axis), the computer system resizes the virtual object in accordance with the movement of the input element along the first axis without resizing the virtual object in accordance with the movement of the input element along the second axis, such as illustrated in FIG. 10Q wherein the computer system detects movements along the vertical axis (e.g., made prior in relation to FIG. 10F) followed by movements along the horizontal axis (e.g., FIG. 10Q) wherein the computer system does not increase the size of the cube 1004 in response to the movements along the horizontal axis. In some embodiments, once the resizing operation is initiated, the computer system allows resizing along a single axis (e.g., horizontal, and/or vertical) and forgoes resizing of the virtual object according to movements along alternate axes. For instance, when the computer system detects movement of the input element along a vertical axis (e.g., upward, and/or downward) prior to detecting movement of the input element along a horizontal axis (e.g., rightward, and/or leftward), the computer system resizes the virtual object in accordance with the movements of the input element along the vertical axis without resizing the virtual object in accordance with the movements along the horizontal axis. Additionally or alternatively, when the computer system detects movement of the input element along the horizontal axis prior to detecting some movement along the horizontal axis, the computer system resizes the virtual object in accordance with the movements of the input element along the horizontal axis without resizing the virtual object in accordance with the movements along the horizontal axis. In some embodiments, the computer system resizes the virtual object along a selected axis (e.g., the first axis, or the second axis) without resizing along an other axis (e.g., the opposite axis) when the computer system detects a threshold amount of movement (e.g., 5 pixels, 10 pixels, 20 pixels, 50 pixels, more than 50 pixels, 3 cm, 6 cm, 15 cm, 30 cm, 50 cm, and/or more than 50 cm) along the selected axis. For instance, when the computer system detects that the input element (e.g., right hand of the user) moves 50 pixels upward along the vertical axis before it moves 50 pixels leftward along the horizontal axis, the computer system optionally resizes the virtual object in accordance with the movement of the right hand of the user along the vertical axis, without resizing the virtual object in accordance with movement of the right hand of the user along the horizontal axis. When the computer system detects that movement along both axes are below the threshold amount of movement, the computer system optionally resizes the virtual object in accordance with the movement along both the first axis and the second axis. By resizing the virtual object in accordance with the movements along one axis while forgoing resizing the virtual object in accordance with movement along alternate axes, the computer system reduces possibility of conflicting inputs resulting from unintentional movements performed by the user.

In some embodiments, the movement of the input element of the user includes a first component of movement along the first axis (e.g., vertical and/or horizontal), and a second component of movement along the second axis, and in accordance with a determination that the first component of movement is greater than the second component of movement, the computer system resizes the virtual object in accordance with the first component along the first axis without resizing the virtual object in accordance with the second component along the second axis. For instance, as shown in FIG. 10P, the computer system detects movements of the left hand with a vertical component (y1) and a horizontal component (x1) which conflict, however the computer system increases the size of the cube 1004 as a result of (y1) being greater than (x1).

In some embodiments, the movement of the input element of the user includes a first component of movement along the first axis (e.g., vertical and/or horizontal), and a second component of movement along the second axis, and in accordance with a determination that the second component of movement is greater than the first component of movement, the computer system resizes the virtual object in accordance with the second component along the second axis without resizing the virtual object in accordance with the first component along the first axis, such as if (y1) was less than (x1), which would result in the computer system decreasing the size of the cube 1004. In some embodiments, the computer system determines which axis to base the resizing operations of the virtual object on dependent upon the amount of movement exhibited along each axis. When the computer system detects that the movement of the first input includes a first component associated with a first axis, and a second component associated with a second axis (e.g., that is orthogonal to the first axis), the computer system optionally resizes the virtual object based on which component is larger (e.g., has the maximum amount of movement in terms of distance). For instance when the movement of the input element detected in an upward direction along a vertical axis is an amount X, and the movement of the input element detected in a leftward direction along a horizontal axis is an amount 0.5×, the computer system optionally resizes the virtual object in accordance with the movement along the vertical axis and forgoes resizing the virtual object in accordance with the movement along the horizontal axis. Additionally or alternatively, when the movement of the input element detected in a leftward direction along the horizontal axis is an amount X, and the movement of the input element detected in a vertical direction along the vertical axis is an amount 0.5×, the computer system optionally resizes the virtual object in accordance with the movement along the horizontal axis and forgoes resizing the virtual object in accordance with the movement along the vertical axis. By resizing the virtual object in accordance with the axis having maximum amount of movement along whichever axis has the maximum amount of movement associated with the first input while forgoing resizing the virtual object in accordance with movement along alternate axes, the computer system reduces possibility of conflicting inputs resulting from unintentional movements performed by the user.

In some embodiments, resizing the virtual object in accordance with the movement of the input element includes, in accordance with a determination that the virtual object is in a first orientation relative to the three-dimensional environment, the first axis corresponds to a first spatial direction relative to the three-dimensional environment, and the second axis corresponds to a second spatial direction, different from the first spatial direction, within the three-dimensional environment. For instance, as shown in FIG. 10F, the computer system detecting movement 1010 of the hand 1006 of the user in the upward direction in relation to the physical world of the user, corresponds with movement along the vertical axis (Y), resulting in the computer system increasing the size of the cube 1004. In some embodiments, the axes along which the movement(s) corresponding to the input element are detected (e.g., hand of the user, and/or input controller) are dependent upon real world axes such that a first axis corresponds with a vertical axis, a second axis corresponds with a horizontal axis, and a third axis corresponds with a depth axis in relation to a location corresponding the computer system and/or a location corresponding to the user.

In some embodiments, resizing the virtual object in accordance with the movement of the input element includes, in accordance with a determination that the virtual object is in a second orientation, different from the first orientation, relative to the three-dimensional environment, the first axis corresponds to a third spatial direction, different than the first spatial direction, relative to the three-dimensional environment, and the second axis corresponds to a fourth spatial direction, different than the second spatial direction, relative to the three-dimensional environment. For instance, as shown in FIG. 10V-10W, the axes 1024 of the cube are not aligned with the axes of the real world (e.g., vertical, horizontal, and depth direction orthogonal to the vertical and horizontal directions). Accordingly, when the computer system detects a movement 1010 of the right hand 1006a of the user aligned with the Y-axis, which is parallel to one of the axes 1024 of the cube, the computer system increases the size of the cube 1004.

Additionally or alternatively, the axes (e.g., first axis, and second axis) along which the movement(s) corresponding to the input element are detected are optionally dependent upon the virtual object to which the first input is directed. For instance, when a virtual object comprises a cube with orthogonal axes which are parallel to the edges of the cube, and the axes of the cube are angularly offset from rear world axes, the computer system optionally detects movements of the input element along the axes of the cube, and not the real world axes. Additionally or alternatively, the axes (e.g., first axis, and second axis) correspond to faces of the virtual object such that the axes are perpendicular to faces of the virtual object. While examples of virtual object (e.g., a cube) are provided which include all faces which are perpendicular to each other, such that axes which are perpendicular to the faces of the virtual object result in axes which are perpendicular to each other, embodiments wherein the faces of the virtual object are non-perpendicular to each other (e.g., a tetrahedron) would optionally result in non-perpendicular axes for resizing operations. Additionally or alternatively, when the virtual object comprises a globe representing the Earth, at least one axis of rotation of the globe corresponds with the axis of rotation of the earth (e.g., an axis extending from the North Pole to South Pole, and/or a true axis of rotation of the Earth). By detecting movements of the input element corresponding to the first input along axes corresponding to the virtual object, the computer system allows the user to provide movement inputs which are intuitively aligned with one or more perceived axes of the virtual object.

In some embodiments, in response to detecting the first input directed to the virtual object, in accordance with a determination that attention of the user (e.g., based on gaze) was directed to a first portion (e.g., first point 1022a) of the virtual object when the first input was detected (such as shown in FIG. 10R with respect to the gaze 1014 of the user), the computer system resizes the virtual object about a first pivot point (e.g., corresponding with first point 1022a) within the three-dimensional environment in accordance with the movement 1010 of the input element, such as shown in FIG. 10S.

In some embodiments, in response to detecting the first input directed to the virtual object, in accordance with a determination that the attention of the user (e.g., based on gaze) was directed to a second portion (e.g., second point 1022b) of the virtual object when the first input was detected, such as shown in FIG. 10T, different from the first portion of the virtual object, the computer system resizes the virtual object about a second pivot point (e.g., corresponding with the second point 1022b) within the three-dimensional environment in accordance with the movement of the input element, wherein the second pivot point is different from the first pivot point. In some embodiments, when the computer system initiates the resizing operation in relation to the virtual object, the computer system resizes the virtual object in relation to a predefined location (e.g., the center) corresponding to the virtual object. The predefined location optionally corresponds to a location coincident with the virtual object, but not limited thereto. In some embodiments, resizing about a predefined location is independent of the location which the attention of the user is directed to. In some embodiments the center of the virtual object shares one or more characteristics with the center of the virtual object as described with respect to method 900. Additionally or alternatively, in some embodiments, when the computer system initiates the resizing operation in relation to the virtual object, the computer system detects the location of the attention of the user. When the virtual object corresponds to a cube and the attention of the user is directed toward a first portion of the cube, in response to receiving an indication to resize the cube, the computer system optionally resizes the cube in a manner which is centered about a first pivot point corresponding to the first portion of the cube rather than the center of the cube. Additionally or alternatively, when the attention of the user is directed toward a portion of the three-dimensional environment which does not correspond to a portion of the cube, and the computer system receives an indication to resize the cube, the computer system optionally resizes the cube in a manner which is centered about a pivot point within the three-dimensional environment corresponding to the portion of the three-dimensional environment which the attention of the user is directed to. When a virtual object is resized about a pivot point which corresponds to a portion of the virtual object, the pivot point corresponding to the portion of the virtual object optionally remains static while the virtual object is resized about the pivot point on the virtual object. For instance, when the virtual object corresponds to a cube, and the first portion corresponds to a first corner of the cube, the first corner of the cube remains static while the rest of the cube is resized. In some embodiments, when the first pivot point does not correspond to a portion of the virtual object and instead corresponds to a point and/or portion of the virtual environment to which the attention (e.g., based on gaze) is directed to, the virtual object moves toward the first pivot point and away from the first point as the virtual object is respectively decreased in size or increased in size. When resizing the virtual object about a first pivot point which is not on the virtual object, the virtual object is optionally resized as if the pivot point is in fact a point on the virtual object which is invisibly connected to the virtual object, such that the first point is held static while the virtual object is resized about the first pivot point. By resizing the virtual object in relation a first portion of the virtual object to which the attention of the user is directed, the computer system allows the user to adjust the center of resizing in accordance without further input beyond the direction of their attention.

It should be understood that the particular order in which the operations in method 1100 have been described is merely exemplary and is not intended to indicate that the described order is the only order in which the operations could be performed. One of ordinary skill in the art would recognize various ways to reorder the operations described herein. In some embodiments, aspects/operations of method 1100 may be interchanged, substituted, and/or added between these methods. For example, various object manipulation techniques and/or object movement techniques of method 1100 is optionally interchanged, substituted, and/or added between these methods. For brevity, these details are not repeated here.

FIGS. 12A-12AA illustrate exemplary ways in which a computer system disambiguates a selection input from a scroll input based on movement characteristics of the input element providing the input.

FIG. 12A illustrates a computer system 101 (e.g., an electronic device) displaying, via a display generation component 120 (e.g., display generation components 1-122a and 1-122b of FIG. 1), a three-dimensional environment 1200 from a viewpoint of a user of the computer system 101.

In FIG. 12A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 12A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 1200. For example, three-dimensional environment 1200 includes representations of the rear and side walls of the room in which the computer system 101 is located.

As discussed in more detail below, in FIG. 12A, display generation component 120 is illustrated as displaying one or more virtual representations of physical objects in the three-dimensional environment 1200. In some embodiments, the one or more representations are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 12A-12AB.

In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to methods 700, 900, 1100, and/or 1300), or via a trackpad from hand 406, and inputs described herein are optionally received via the trackpad or via air gestures/attention.

In the example of FIG. 12A, a user interface 1202 is displayed by computer system 101 within three dimensional-environment 1200 (which includes representations of physical objects found in the real-word physical environment of the user of computer system 101). In some embodiments, user interface 1202 includes scrollable content 1204, and one or more selectable content items such as virtual octopus 1206 and text field 1208 (described in further detail below). In some embodiments, hand 1212 of the user performs an input gesture that is initiated by a pre-selection movement 1220 which includes the hand of the user moving prior to performing a selection input (described in further detail below). In some embodiments, computer system 101 detects the magnitude of pre-selection movement 1216 of hand 1212 (e.g., the velocity, acceleration, and/or the distance associated with the pre-selection movement 1220 of the hand 1212 of the user).

In some embodiments, in response to detecting hand 1212 performing a selection input, the computer system determines whether to select a selectable object of the user interface or scroll the content of the user interface as illustrated in FIG. 12B. In the example of FIG. 12B, computer system 101 detects that the hand 1212 of the user performs a selection input 1224. As illustrated in the example of FIG. 12B, selection input 1224 includes the hand 1212 of the user performing an air pinch (e.g., by bring the thumb and index finger of hand 1212 together). In response to detecting selection input 1224, the computer system determines whether to select virtual octopus 1206 or scroll scrollable content 1204 based on the motion characteristics of hand 1212 prior to detection of the selection input. For instance, as illustrated in FIG. 12B, the computer system 101 detects that the magnitude of the pre-selection movement 1216 is below a threshold 1226, and in accordance with detecting that the attention of the user (e.g., based on gaze 1230) is directed to the virtual octopus 1206, computer system 101 selects virtual object 1206 (e.g., rather than scrolling the scrollable content of user interface 1204).

In some embodiments, in accordance with selecting virtual octopus 1206, in response to movement of hand 1212 that occurs after the selection input is detected, computer system 101 moves the virtual octopus within the user interface as illustrated in FIG. 12C. In the example of FIG. 12C, since the magnitude of the pre-selection movement 1214 was below threshold 1226 prior to detection of the selection input, computer system 101 moves the virtual octopus 1206 in accordance with movement of hand 1212 that occurs after the selection input 1224 was detected. For as shown in FIG. 12C, computer system 101 moves virtual octopus 1206 in an upwards direction within user interface 1202 in accordance with the movement 1222 of the and as indicated by after selection movement 1218. As illustrated in FIG. 12D, virtual octopus 1206 continues to move up as hand 1212 continues to move up as indicated by the increase in after selection movement 1218.

In some embodiments, if the magnitude of the pre-selection movement is above the threshold when the selection input is detected, the computer system scrolls the scrollable content of the user interface as illustrated in the examples of FIG. 12E-12H. In the example of FIG. 12E, computer system 101 detects hand 1212 moving in an upwards direction without detecting that hand 1212 has performed a selection input. As indicated in FIG. 12E, computer system 101 also detects the magnitude of the pre-selection movement 1216, but also detects that pre-selection movement 1216 is below threshold 1226.

In the example of FIG. 12F, computer system detects hand 1212 performing selection input 1224 (e.g., an air pinch) while also detecting that the magnitude of the pre-selection movement was above threshold 1226 when (e.g., at the moment when) selection input 1224 was detected. In response to detecting that the magnitude of the pre-selection movement was above threshold 1226 when (e.g., at the moment when) selection input 1224 was detected, computer system 101 initiates a scrolling operation of scrollable content 1204 on user interface 1202 as illustrated in FIG. 12G. As illustrated in FIG. 12G, computer system 101 scrolls scrollable content 1204 in response to detecting the selection input 1224, and in response to the magnitude of the pre-selection input 1216 being above threshold 1226. Thus, when compared to the example of FIG. 12C where the virtual octopus 1206 moves (e.g., without the other portions of user interface 1202 moving), in the example of FIG. 12G, the entirety of the scrollable content 1204 (e.g., including virtual octopus 1206) moves (e.g., scrolls) in accordance with after selection movement 1218. As illustrated in the example of FIG. 12H, computer system 101 continues to scroll scrollable content 1204 in accordance with the after selection movement 1218 of hand 1212.

In some embodiments, computer system 101 detects the user selecting virtual content items other than virtual objects (e.g., such as virtual octopus 1206) and performs a corresponding operation based on the item selected as illustrated in the example of FIG. 12I-12L. In the example of FIG. 12I, and similar to the example of FIG. 12A, computer system 101 detects hand 1212 of the user performing an input gesture that is initiated by a pre-selection movement 1220 which includes the hand of the user moving prior to performing a selection input. In some embodiments, computer system 101 detects the magnitude of pre-selection movement 1216 of hand 1212 (e.g., the velocity, acceleration, and/or the distance associated with the pre-selection movement 1220 of the hand 1212 of the user). In the example of FIG. 12J, computer system 101 detects the hand performing selection input 1224 (e.g., similar to the example of FIG. 12B), while also detecting that the gaze of the user 1230 directed to text field 1208. In some embodiments, text field 1208 is a selectable text field that when selected, allows the user to initiate a text input operation. In the example of FIG. 12J, in response to detecting selection input 1224, gaze 1230 directed to text field 1208, and determining that the magnitude of pre-selection 1216 is below threshold 1226, computer system 101 selects text field 1208 and initiates a text entry operation as shown in FIG. 12K.

In the example of FIG. 12K, in response to selecting text field 1208, computer system 101 initiates a text entry input session, by displaying virtual keyboard 1232 such that the user is able to enter text into text field 1208. Since initiating a text entry input session does not require moving the text field in accordance with the after-selection movement, computer system 101 does not determine the after-selection movement of hand 1212 as illustrated in the example of FIG. 12K (alternatively, the computer system 101 determines the after selection movement but does not use it as part of the process of initiating a text entry input session). As illustrated in FIG. 12L, computer system 101 receives text entry from one or more hands of the user providing input at virtual keyboard 1232, and in response, enters the inputted text at text field 1208.

In some embodiments, even if the magnitude of the pre-selection movement is above the threshold, the computer system performs an operation on a selectable object rather than scroll the scrollable content of the user interface in instances where a duration of the selection input is above a threshold amount of time as illustrated in the examples of FIG. 12M-12Q. In the example of FIG. 12M, in response to detecting a selection input 1224, in accordance with detecting that the magnitude of the pre-selection movement 1216 is above threshold 1226 (e.g., the pre-selection movement having occurred in part in the example of FIG. 12E), computer system 101 initiates a scrolling operation scrollable content 1204 of user interface 1202. In some embodiments, computer system 101 upon detecting selection input 1224 initiates a selection input duration timer to track the amount of time that the selection input (e.g., the pinch of the user's finger) is maintained. In some embodiments, selection input duration 1214 begins once the computer system 101 determines that a selection input 1224 has occurred and is terminated once the computer system 101 determines that the selection input 1224 has been terminated (e.g., the fingers of the user that were pinched together, become un-pinched).

However, as illustrated in the example of FIG. 12N, as computer system 101 detects that the selection input 1224 continues without being terminated, the selection input duration 1214 continues to increase, until eventually the section input duration 1214 becomes greater than threshold duration 1228. In some embodiments, in response to determining that selection input duration 1214 is above threshold duration 1228, computer system 101 terminates the initiation of the scrolling operation (and/or alternatively forgoes initiating the scrolling operation) and instead causes selection of virtual octopus 1206 in accordance with determining that the gaze 1230 of the user is directed to virtual octopus 1206. In this way, when selection input duration 1214 goes above threshold 1228, the computer system 101 causes selection of a selectable virtual content item, regardless of whether the magnitude of pre-selection movement 1216 is above or below threshold 1226. As computer system 101 selects virtual octopus 1206 in the example of FIG. 12N, in accordance with after selection movement 1218, computer system 101 moves virtual octopus 1206 within user interface 1202 as illustrated in FIG. 12O and similar to the examples described above.

In some embodiments, the selection input duration threshold is based on the magnitude of the pre-selection movement detected prior to the computer system detecting the selection input as illustrated in FIG. 12P-12Q. For instance, in the example of FIG. 12P which is similar to the example of FIG. 12N except that the magnitude of the pre-selection movement 1216 is greater in FIG. 12P, the selection input duration threshold 1228 is larger than in the example of FIG. 12N. Thus, as illustrated in the example of FIG. 12P, computer system 101 uses the magnitude of the pre-selection movement 1216 to determine selection input duration threshold 1228. In the example of FIG. 12Q, computer system 101 detects that the magnitude of pre-selection movement 1216 is even greater than the examples of FIG. 12P and FIG. 12N and in accordance with detecting a greater magnitude of pre-selection movement 1216, selection input duration threshold 1228 is higher than in the examples of FIG. 12P and FIG. 12N.

In some embodiment threshold magnitude of pre-selection movement that the computer system uses to determine whether to perform a scroll operation on the scrollable content or select a selectable virtual object to perform an operation on is based on one or more characteristics of the pre-selection movement as illustrated in the examples of FIG. 12R-12AA. In the example of FIG. 12R, computer system 101 detects that hand 1212 performs a selection input 1224 (e.g., after having performed pre-selection movement as described above). In response to detecting selection input 1224, computer system 101 first determines the value of pre-selection movement threshold 1226 and then compares the determined magnitude of the pre-selection movement 1216 to the determined threshold 1226. In some embodiments, computer system determines the value of pre-selection movement threshold 1226 based on the velocity of pre-selection movement. Thus, in the example of FIG. 12R, threshold 1226 is determined based on the velocity 1236 of the pre-selection movement and then is used to determine whether to scroll or select based on a comparison between the determined threshold 1226 and the magnitude of the pre-selection movement 1216. In the example of FIG. 12R, since the magnitude of the pre-selection input 1216 is greater than the threshold 1226 (e.g., and since selection input duration 1214 is less than threshold 1228), computer system scrolls the scrollable content 1204 of user interface 1202 as illustrated in FIG. 12S.

In some embodiments, the threshold of the magnitude of the pre-selection movement is proportion to the determined velocity of the pre-selection movement as illustrated in the example of FIG. 12T. In the example of FIG. 12T, the velocity 1236 of the pre-selection movement is higher than in the example of 12R. Accordingly, the value of threshold 1226 is higher than in the example of 12R. In the example of 12T, since the threshold 1226 is now higher, the computer system determines that the magnitude of the pre-selection movement 1216 is below threshold 1226 and thus selects virtual octopus 1206 (e.g., rather than scroll scrollable content 1204 of user interface 1202). As illustrated in FIG. 12U, computer system 101 in accordance with selecting virtual octopus 1206, moves virtual octopus 1206 in accordance with the after selection movement 1218 of hand 1212. As another example of the relationship between the velocity of the pre-selection movement and the threshold used to determine whether to scroll or select an object, FIG. 12V illustrates a higher threshold 1226 that is based on the velocity 1236 being higher than in the examples of FIGS. 12R and 12T.

In some embodiments, and in addition to alternatively to the examples of FIG. 12R-12T, the threshold associated with determining whether to scroll or select is based on the acceleration of the pre-selection movement as illustrated in the examples of FIG. 12W-12AA. In the example of FIG. 12W, computer system 101 detects that hand 1212 performs a selection input 1224 (e.g., after having performed pre-selection movement as described above). In response to detecting selection input 1224, computer system 101 first determines the value of pre-selection movement threshold 1226 and then compares the determined magnitude of the pre-selection movement 1216 to the determined threshold 1226. In some embodiments, computer system determines the value of pre-selection movement threshold 1226 based on the acceleration of the pre-selection movement 1234. Thus, in the example of FIG. 12W, threshold 1226 is determined based on the acceleration 1234 of the pre-selection movement and then is used to determine whether to scroll or select based on a comparison between the determined threshold 1226 and the magnitude of the pre-selection movement 1216. In the example of FIG. 12W, since the magnitude of the pre-selection input 1216 is less than the threshold 1226 (e.g., and since selection input duration 1214 is less than threshold 1228), computer system selects virtual octopus 1206 in accordance with detecting the gaze 1230 of the user being directed to virtual octopus 1206 and in accordance with the after selection movement of the hand 1218 as illustrated in FIG. 12X. In some embodiments, the threshold 1226 of the magnitude of the pre-selection movement 1216 is inversely proportional to the acceleration such that when acceleration decreases, threshold 1226 increases (e.g., making it harder to scroll a user interface, if the computer system determines that the hand was slowing down prior to performing the selection input).

In the example of FIG. 12Y, the acceleration of the pre-selection movement 1234 is positive (e.g., greater than the acceleration of the movement in FIG. 12V). Accordingly, computer system 101 sets threshold 1226 to be lower than the threshold shown in the example of FIG. 12W (e.g., thereby making it easier to initiate a scroll operation if the hand was speeding up prior to the detection of the selection input). In the example of FIG. 12Y, the magnitude of the pre-selection movement 1216 is above threshold 1226, and thus in response computer system 101 initiates a scroll operation and scrolls scrollable content 1204 in accordance with after selection movement 1218 as illustrated in FIG. 12Z. In the example of FIG. 12AA, in response to detecting that the acceleration of the pre-selection movement 1234 is even greater than in the examples of FIGS. 12W and 12Y, computer system 101 sets the threshold 1226 to be lower (e.g., easier to initiate a scroll operation) in accordance with the higher acceleration.

FIG. 13 is a flowchart illustrating a method for disambiguating object selection from scroll operations on user interfaces, in accordance with some embodiments. In some embodiments, the method 1300 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1300 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1300 are, optionally, combined and/or the order of some operations is, optionally, changed.

In some embodiments, method 1300 is performed at a computer system in communication with one or more display generation components and one or more input devices. In some embodiments, the computer system, display generation component, and the one or more input devices share one or more characteristics with the computer system, display generation component, and the one or more input device described with respect to methods 900 and/or 1100.

In some embodiments, while displaying, via the one or more display generation components, a first virtual object in a first user interface, (e.g., wherein the first virtual object is selectable independently of the first user interface) wherein the first user interface is scrollable, the computer system detects (1302), via the one or more input devices, a first input including a selection input corresponding to an input element (e.g., such as the selection input performed with hand 1212 in FIG. 12B). In some embodiments, the first visual object shares one or more characteristics of the virtual object(s) described with respect to methods 900 and/or 1100. In some embodiments, the first virtual object is displayed in a three-dimensional environment that shares one or more characteristics with the three-dimensional environments described with respect to methods 900 and/or 1100. In some embodiments, the first virtual object includes one or more virtual objects and/or representations of physical objects in the physical environment of the user of the computer system. In some embodiments, the first user interface includes a virtual content board and/or other content window upon which the first object is displayed. For instance, in the example of the first user interface being a virtual content board, the first object is an object that is part of the content board. In some examples, the user of the content system can interact with the first object. For instance, the computer system (by optionally detecting an air gesture or other input method from the user) selects the first object and perform operations on the first object, such as but not limited to: moving the first object to another location on the content board, resizing the first object, and/or changing one or properties of the first object. In some embodiments, the computer system performs one or more operations on the user interface in response to detecting a user input. For instance, in the example of the content board, if the entirety of the content board is not visible (for instance because the content board is displayed in a zoomed in state), the computer system scrolls the content board in response to detecting a user input that is directed to the first user interface. In some embodiments, the user input (that can optionally control one or more of the first object and/or the first user interface) is received from a portion of the user of the computer system. For instance, the first object includes but is not limited to a hand of the user and/or one or more fingers of the hand of the user. In some embodiments, the selection input includes detecting an air pinch (or optionally other air gesture) followed by movement of the first object (e.g., hand of the user) providing the selection input while the first object is maintaining the air pinch gesture. In some embodiments, the first input includes a touch and drag input such as on a touch surface or other touch input device.

In some embodiments, in response to detecting the first input (1304), in accordance with a determination that one or more criteria are satisfied, including a criterion that is satisfied when an amount of movement of the input element prior to detecting the selection input is above a first threshold amount of movement (e.g., as described in more detail later), the computer system performs (1206) a scroll operation in the first user interface, such as performing the scroll operation performed with respect to user interface 1204 in FIGS. 12F-H in response to detecting that pre-selection movement 1216 is above threshold 1226 in FIG. 12F (optionally in accordance with movement of the first portion of the user after the selection input, and without performing the second operation described below).

In some embodiments, in response to detecting the first input (1304), in accordance with a determination that the one or more criteria are not satisfied because the selection input is detected without detecting more than the first threshold amount of movement prior to detecting the selection input (e.g., because the amount of movement of the first portion of the user prior to detecting the selection input is below the first movement threshold), the computer system performs (1208) a respective operation (optionally in accordance with movement of the first portion of the user after the selection input), different from the scrolling operation, corresponding to selection of the first object, such as moving virtual octopus 1206 in FIGS. 12B-12D in response to pre-selection movement 1216 being below threshold 1226 in FIG. 12B (and optionally not directed to the first user interface, and without performing the scrolling operation on the first user interface). In some embodiments, an amount of movement refers to one or more characteristics of the movement of the input element including but not limited to the velocity of the movement, the distance of the movement, and/or the acceleration of the movement. In some embodiments, the computer system detects the amount of movement of the portion of the user prior to detecting the selection input. The time period (e.g., prior to the selection input) is based on when the selection input is detected and optionally includes the movement at a pre-defined time prior to detecting the input selection (e.g., 0.01, 0.05, 0.1, 0.5, or 1 second). In some embodiments, in the event that the computer system determines that the amount of movement is above the first movement threshold, the computer system determines that the selection input corresponds to the first user interface and thus performs a first operation on the first user interface (e.g., rather than performing an operation on the first object in particular). For instance, in response to the movement of the first portion of the user after the selection input is received and in the example of the first user interface being a content board, the computer system scrolls the content board (e.g., including the first object) in accordance with the movement of the hand of the user after the selection input is received (e.g., with a magnitude and/or direction corresponding to a magnitude and/or direction of the movement of the first object after the selection input). In some embodiments, in the event that the computer system determines that the amount of movement is below the first movement threshold, the computer system determines that the selection input corresponds to the first virtual object and in response to the movement of the first portion of the user after the selection input, the computer system performs an operation on the first virtual object (and optionally not the first user interface as a whole) such as moving the first virtual object from a first location on the content board (e.g., the first user interface) to a second location on the content board (e.g., with a magnitude and/or direction corresponding to a magnitude and/or direction of the movement of the first object after the selection input). Performing an operation on a first user interface or a virtual object that is displayed on the first user interface based on an amount of movement of an object prior to detecting a selection input allows for quick access to the first user interface and/or the first virtual object based on the characteristics of the movement of the object and reduces the likelihood of the computer system performing a first operation on an item that was not intended by the user, thereby reducing the need for additional inputs required to correct erroneous operations performed due to misinterpreting a selection input and thereby conserving computer resources associated with the additional inputs including but not limited to processing resources and/or battery resources.

In some embodiments, while displaying, via the one or more display generation components, a second virtual object in the first user interface, the computer system detects, via the one or more input devices, a second input including a second selection input corresponding to the input element, such as if the hand 1212 in FIG. 12A performed a second selection input directed to a second object other than octopus 1206. In some embodiments, the second selection input shares one or more characteristics with the first selection input (e.g., an air pinch gesture and/or a touch and drag input).

In some embodiments, in response to detecting the second selection input, in accordance with a determination that one or more criteria are satisfied, including a criterion that is satisfied when an amount of movement of the input element prior to detecting the second selection input is above the first threshold amount of movement, the computer system performs a scroll operation in the first user interface, such as the scroll operation illustrated in FIGS. 12F-12H.

In some embodiments, in response to detecting the second selection input, in accordance with a determination that the one or more criteria are not satisfied, the computer system performs a second respective operation, different than the respective operation, corresponding to selection of the second object, such as if the input caused an object other than octopus 1206 in FIG. 12A to be selected because the pre-selection movement 1216 of the hand was below threshold 1226. In some embodiments, the first user interface includes multiple virtual objects (optionally including a second virtual object different from the first virtual object) that are each independently selectable. In some embodiments, the second input is determined by the computer system to directed to the second virtual object, while the first input is determined by the computer system to be directed to the first virtual object. In some embodiments, the computer system determines which virtual object of the multiple virtual objects a selection input is directed to based on the detected location of the gaze of the user. Additionally and/or alternatively, in some embodiments, the computer system determines which virtual object of the multiple virtual objects a selection input is directed to based on proximity of the selection input to a particular object (e.g., the computer system determines that the selection input is directed to the virtual object that is in closest proximity to the location within the three-dimensional environment where the selection input was detected as occurring). In some embodiments, the first threshold amount of movement is proportional to and/or based on one or more characteristics of the virtual objects that the amounts are associated with. For instance, the first threshold amount of movement is based on the size of the respective virtual object. In some embodiments, the respective operation associated with selection of the second virtual object shares one or more characteristics with the selection operation described herein. In some embodiments, the second selection operation is different from the first selection operation. For instance, the first selection operation performed on the first virtual object, while the second selection operation performs and operation associated with selecting a selectable option (e.g., the second virtual object is a selectable option) such as opening a menu or initiating display of another content window. Allowing virtual objects to be selected from a user interface allows for quick access to the first user interface and/or the objects based on the characteristics of the movement of the selection input and its location and reduces the likelihood of the computer system performing a first operation on an item that was not intended by the user, thereby reducing the need for additional inputs required to correct erroneous operations performed due to misinterpreting a selection input and thereby conserving computer resources associated with the additional inputs including but not limited to processing resources and/or battery resources.

In some embodiments, the respective operation corresponding to selection of the first object includes performing an operation in response to selection of the first object, such as initiating an active text entry session in text field 1208 as illustrated in FIGS. 121-12L. In some embodiments, the computer system performs an operation in response to detecting selection of an object (e.g., the first object). For instance, in an example where the first object is a virtual button or virtual mechanical input, in response to detecting selection of the first object, the computer system performs an operation that is associated with the virtual button being pushed (e.g., selected). In some embodiments, the first object is a selectable affordance such that when the computer system detects that the first object has been selected, the computer system performs an operation that corresponds to the selectable affordance. As an example, the first object is a button that when selected initiates display of another content window. As another example, the first object is a home button that when selected causes the content board to revert to an initial display state. Allowing virtual objects to be selected from a user interface that contains multiple virtual objects allows for quick access to the first user interface and/or the objects based on the characteristics of the movement of the selection input and its location and reduces the likelihood of the computer system performing a first operation on an item that was not intended by the user, thereby reducing the need for additional inputs required to correct erroneous operations performed due to misinterpreting a selection input and thereby conserving computer resources associated with the additional inputs including but not limited to processing resources and/or battery resources.

In some embodiments, the respective operation includes modifying a selection state of the first object, for instance, in response to the input by hand 1212 in FIG. 12A, the virtual octopus 1206 is selected in FIG. 12B. In some embodiments, in response to detecting a selection input directed to the first object (thereby optionally selecting the object), the computer system modifies a selection state of the first object from a non-selected stated to a selected stated. For instance, in an example where the first object includes an input field for receiving text inputs (optionally from a virtual keyboard or other input device), in response to detecting the selection input directed to the first object, the computer system changes the selection state of the input field to be a selected state and initiates an input session at the input field of the first object, thus allowing for the user of the computer system to enter input into the input field using an input device. Changing the selection state of virtual object in response to receiving a selection input directed to the virtual object allows for quick access to virtual objects based on the characteristics of the movement of the selection input and its location and reduces the likelihood of the computer system performing a first operation on an item that was not intended by the user, thereby reducing the need for additional inputs required to correct erroneous operations performed due to misinterpreting a selection input and thereby conserving computer resources associated with the additional inputs including but not limited to processing resources and/or battery resources.

In some embodiments, the respective operation includes resizing the first object, such as the resizing operation illustrated in FIG. 10F. In some embodiments, in response to detecting a selection input directed to the first object, the computer system resizes the first virtual object (e.g., modifies a size of the virtual object) based on movement of the input element that is detected as having occurred after the detection of the selection input. In some embodiments, the amount of resizing (e.g., the change in the size of the virtual object) is proportional to the amount of movement of the input element detected as occurring after and/or before the selection input is detected. In some embodiments, the resizing is also based upon the direction of the movement of the input element. For instance, if the direction of the movement is away from a center of the virtual object, the computer system increases the size of the virtual object. Additionally, if the movement is toward the center of the virtual object, the computer system decreases the size of the virtual object. Changing the size of the virtual object in response to receiving a selection input directed to the virtual object allows for quick access to virtual objects based on the characteristics of the movement of the selection input and its location and reduces the amount of inputs required to resize a virtual object thereby conserving computer resources associated with the additional inputs including but not limited to processing resources and/or battery resources.

In some embodiments, the respective operation includes performing a grabbing operation directed to the first object, such as hand 806 moving airplane 804 in FIG. 8B. In some embodiments, a grabbing operation refers to an operation that causes the virtual object to be selected in preparation for being moved within the three-dimensional environment in accordance with movement of the input element that performed the selection input (and optionally occurred after the selection input was detected). In some embodiments, upon detecting the selection input of the first input (and optionally in accordance with the determination that the one or more criteria are not satisfied), the computer system performs the grabbing operation and moves the virtual object in response to subsequent movement of the input element made while the input element is holding/performing the selection input. In some embodiments, the computer system moves the virtual object in accordance with a direction and/or magnitude corresponding to the direction and/or magnitude movement of the input element after the selection input. Moving the virtual object in response to receiving a selection input directed to the virtual object allows for quick access to virtual objects based on the characteristics of the movement of the selection input and its location and reduces the amount of inputs required to move a virtual object in the three-dimensional environment thereby conserving computer resources associated with the additional inputs including but not limited to processing resources and/or battery resources.

In some embodiments, in response to the first input, in accordance with detecting movement of the input element after the selection input in the first input, and in accordance with the determination that the one or more criteria are satisfied, the computer system performs the scroll operation in the first user interface in accordance with the movement of the input element after the selection input, such as user interface 1204 scrolling in accordance with the after selection movement 1218 in FIGS. 12G-12H. In some embodiments, the scrolling performed during the scrolling operation is in a direction and/or magnitude corresponding to the direction and/or magnitude of movement of the hand. In some embodiments the relationship between the direction and/or magnitude of the movement of the hand is linear. Additionally and/or alternatively, the relationship between the direction and/or magnitude of the movement of the hand is non-linear (e.g., exponential and/or logarithmic).

In some embodiments, in response to the first input, in accordance with detecting movement of the input element after the selection input in the first input, and in accordance with the determination that the one or more criteria are not satisfied, the computer system moves the first object within the three-dimensional environment in accordance with the movement of the input element after the selection input, such as virtual octopus 1206 moving in accordance with the after selection movement 1218 in FIGS. 12B-12D. In some embodiments, detecting movement of the input element after the selection input in the first input refers to detecting that the input element (e.g., the hand of the user) moves while the hand of the user is still engaged in the selection input and/or after the selection input has been completed. For instance, if the selection input is an air pinch of the fingers of the hand of the user, the movement of the input element comprises the movement of the hand while engaged in the air pinch and/or after having released the pinch. In some embodiments, the computer system moves the first object within the three-dimensional environment proportionally to the amount of movement of the input element after the selection input. The amount of movement of the input element after the selection input refers to but is not limited to the distance of the movement, the velocity of the movement, and/or the acceleration of the movement. In some embodiments, the relationship between the amount of the movement of the input element after the selection input and the movement of the first object within the three-dimensional environment has a non-linear relationship. Moving the virtual object in response to receiving a selection input directed to the virtual object allows for quick access to virtual objects based on the characteristics of the movement of the selection input and its location and reduces the amount of inputs required to move a virtual object in the three-dimensional environment thereby conserving computer resources associated with the additional inputs including but not limited to processing resources and/or battery resources.

In some embodiments, the one or more criteria include a criterion that is satisfied when a duration of the selection input is less than a first time threshold. In some embodiments, in response to detecting the first input, in accordance with a determination that the one or more criteria are not satisfied because the duration of the selection input is greater than the first time threshold while the amount of movement of the input element is above the first threshold amount of movement, the computer system moves the first object within the three-dimensional environment in accordance with the movement of the input element after the selection input, such as the movement of virtual octopus 1206 in FIGS. 12N-12O. In some embodiments, detecting movement of the input element before the selection input in the first input refers to detecting that the input element (e.g., the hand the of the user) moves prior to the selection input. For instance, if the selection input is a pinch of the fingers of the hand of the user, the movement of the input element comprises the movement of the hand before the fingers are engaged in the pinch. In some embodiments, the computer system selects the virtual object despite the amount of movement being above the first threshold, if the duration of the selection input exceeds a time threshold (e.g., 0.01, 0.1, 0.5, 1, 2, or 5 seconds). In some embodiments, the duration of the selection input is measured from the time the selection input is initiated until the time when the selection input is released. For instance, in the example where the selection input is an air pinch, the duration of the selection of the air pinch would be measured from when the fingers of the user were first detected as coming together (e.g., to form the pinch) until the fingers were detected as coming apart (e.g., thereby releasing the air pinch). In some embodiments, in the event that the computer system detects that the duration of the selection input is above the first time threshold, the computer system determines which virtual object that is part of the first user interface, the selection input was directed to in accordance with the methods described herein. In some embodiment, the duration of the selection input refers to the duration before of the movement of the input element begins to when the selection input is detected as being terminated. Optionally, the duration refers to the time after the movement of the input element end and the selection input is detected as being terminated. Optionally, the duration of the selection input is independent of when the movement of the input element happens. Selecting virtual object when a selection input duration exceeds a time threshold allows for quick access to virtual objects based on the characteristics of the movement of the selection input and its location and reduces the amount of inputs required to interact with a virtual object in the three-dimensional environment thereby conserving computer resources associated with the additional inputs including but not limited to processing resources and/or battery resources.

In some embodiments, the one or more criteria include a criterion that is satisfied when the duration of the selection input is less than the first time threshold while the amount of movement of the input element is above the first threshold amount of movement, such as the computer system scrolling user interface 1204 in FIGS. 12F-12H. In some embodiments, a scroll operation is performed when the amount of movement of the input element is above the first threshold amount and when the device also detects that the duration of the selection input was also below the first time threshold. Thus, in some embodiments, in response to the first input, a selection of the virtual object is performed in two circumstances: (1) the amount of movement of the input element is above the first threshold amount of movement and the duration of the selection input is above the first time threshold; or (2) the amount of movement of the input element is below the first threshold amount of movement. Scrolling a first user interface in response to a movement of an input element that is above a threshold amount of movement and when the duration of a selection input is below a time threshold, minimizes errors associated with erroneous selection of a virtual object and/or erroneous scrolling of the first user interface and reduces the amount of inputs required to interact with a virtual object or user interface in the three-dimensional environment thereby conserving computer resources associated with the additional inputs including but not limited to processing resources and/or battery resources.

In some embodiments, in accordance with a determination that a velocity of the input element prior to detecting the first input (and/or the selection input) is a first velocity, the first threshold amount of movement is a first respective threshold. In some embodiments, in accordance with a determination that the velocity of the input element prior to detecting the first input (and/or the selection input) is a second velocity, different from the first velocity, the first threshold amount of movement is a second respective threshold, different from the first respective threshold (such as illustrated by comparing threshold 1226 in FIGS. 12S and 12T in response to varied velocities of hand 1212). In some embodiments, the threshold amount of movement is based on the velocity of the input element prior to detection of the input element performing the first input (optionally including the selection input). In some embodiments, a set of movement characteristics included in the threshold amount of movement includes but is not limited to direction of the input, velocity of the input, and/or acceleration of the input. In some embodiments, the set of characteristics included in the first respective threshold and the second respective threshold include different combinations of the movement characteristics described above and/or different values of the same movement characteristics. As an example, the first set of movement characteristics includes a velocity threshold of 0.01 m/s and an acceleration that is negative. Thus, in such an example, an amount of movement is below the first threshold amount if the velocity of the input element prior to detection of the first input was below 0.01 m/s and the acceleration was negative. If either of the velocity or acceleration thresholds are crossed (e.g., exceeded), the amount of movement is determined to be above the threshold amount of movement. In continuance of the example, the second set of movement characteristics includes a different set of characteristics such as a velocity threshold below 0.02 m/s (optionally without any other movement characteristics). Setting an amount of movement threshold based on the velocity of the input element prior to detection of the first input, minimizes errors associated with erroneous selection of a virtual object and/or erroneous scrolling of the first user interface and reduces the amount of inputs required to interact with a virtual object or user interface in the three-dimensional environment thereby conserving computer resources associated with the additional inputs including but not limited to processing resources and/or battery resources.

In some embodiments, the amount of movement of the input element prior to detecting the selection input includes an acceleration of the input element prior to detecting the selection input, and wherein the first threshold amount of movement corresponds to a first acceleration threshold (e.g., 0.1, 0.5, 1, 5, or 10 m/s2), such as illustrated by the comparison of threshold 1226 in FIGS. 12X and 12Y in response to varying accelerations. In some embodiments, the amount of movement of the input element refers to the acceleration of the input element prior to the computer system detecting that the input element has performed (or optionally has begun to perform) the selection input. In some embodiments, the computer system determines the acceleration of the input element (e.g., the hand of the user) and compares the determined acceleration against the first acceleration threshold to determine if the acceleration of the input element is greater than or less than the first acceleration threshold. In some embodiments, the computer system decides what operation to perform in response to the selection input based on the comparison of the determined acceleration and the first acceleration threshold. For instance, in response to the acceleration being greater than the acceleration threshold, the computer system scrolls the first user interface, and in response to the acceleration being less than the acceleration threshold, the computer system selects a virtual object that is displayed on the first user interface (e.g., the first object). In some embodiments, the acceleration of the input element is determined at a predetermined time before the selection input was detected (e.g., 0.1, 0,5, 1, 2, 3, or 5 seconds). Performing operations on a user interface or a virtual object displayed on the user interface based on the acceleration of the input element prior to detecting the input element performing a selection input, minimizes errors associated with erroneous selection of a virtual object and/or erroneous scrolling of the first user interface and reduces the amount of inputs required to interact with a virtual object or user interface in the three-dimensional environment thereby conserving computer resources associated with the additional inputs including but not limited to processing resources and/or battery resources.

In some embodiments, the determination that the one or more criteria are satisfied includes a determination that the acceleration of the input element was positive prior to detecting the selection input, such as illustrated by user interface 1204 scrolling in FIGS. 12Y-12Z. In some embodiments, the first acceleration threshold is 0 m/s2 such that if the acceleration of the input element is positive, the computer system scrolls the first user interface in response to detecting the selection input. In some embodiments, a positive acceleration (e.g., the velocity of the input element was increasing prior to detection of the selection input) serves as an indication that it is more likely the selection input was directed to scrolling the user interface (rather than selection a particular virtual object displayed on the user interface) and thus in response to the determination of a positive acceleration, the computer system scrolls the user interface in response to detection of the selection input (and, optionally, subsequent movement of input element after the selection input is detected). In some embodiments, the scrolling in response to the determination of the positive acceleration is performed regardless of the velocity and/or magnitude of the input element prior to detecting the selection input. Performing operations on a user interface or a virtual object displayed on the user interface based on the acceleration of the input element prior to detecting the input element performing a selection input, minimizes errors associated with erroneous selection of a virtual object and/or erroneous scrolling of the first user interface and reduces the amount of inputs required to interact with a virtual object or user interface in the three-dimensional environment thereby conserving computer resources associated with the additional inputs including but not limited to processing resources and/or battery resources.

In some embodiments, the determination that the one or more criteria are satisfied includes a determination that the acceleration of the input element was positive prior to detecting the selection input. In some embodiments, in accordance with a determination that the one or more criteria are not satisfied because the acceleration of the input element was negative prior to detecting the selection input, the computer system performs the respective operation, different from the scrolling operation, corresponding to selection of the first object, such as computer system 101 selecting virtual octopus 1206 in FIGS. 12X-W. In some embodiments, the first acceleration threshold is 0 m/s2 such that if the acceleration of the input element is negative, the computer system selects the first virtual object in response to detecting the selection input. In some embodiments, a negative acceleration (e.g., the velocity of the input element was decreasing prior to detection of the selection input) serves as an indication that it is more likely the selection input was directed to selecting the virtual object (e.g., rather than scrolling the user interface) and thus in response to the determination of a negative acceleration, the computer system selects the virtual object in response to detection of the selection input (and, optionally, subsequent movement of input element after the selection input is detected). In some embodiment the selection determination in response to detecting negative acceleration is performed independent of the velocity and/or magnitude of the input element prior to the selection input. Performing operations on a user interface or a virtual object displayed on the user interface based on the acceleration of the input element prior to detecting the input element performing a selection input, minimizes errors associated with erroneous selection of a virtual object and/or erroneous scrolling of the first user interface and reduces the amount of inputs required to interact with a virtual object or user interface in the three-dimensional environment thereby conserving computer resources associated with the additional inputs including but not limited to processing resources and/or battery resources.

In some embodiments, the one or more criteria include a criterion that is satisfied when a duration of the selection input is shorter than a threshold amount of time (e.g., 0.1, 0.5, 1, or 5 seconds). In some embodiments, in response to detecting the first input, in accordance with a determination that the one or more criteria are not satisfied because the amount of movement of the input element prior to detecting the selection input is above the first threshold amount of movement and the duration of the selection input is greater than the threshold amount of time, the computer system performs the respective operation corresponding to selection of the first object, such as illustrated by the selection of virtual octopus 1206 in the example of FIG. 12N. In some embodiments, the virtual object is selected when one of two conditions are met: (1) the amount of movement is below the first threshold amount of movement; or (2) the amount of movement is above the first threshold amount of movement and the duration of the selection input is greater than a threshold amount of time. In some embodiments, if neither of the above two conditions are satisfied, then the computer system determines that the first input was directed to scrolling the first user interface, and correspondingly performs a scroll operation in response to the first input. In some embodiments, while a determination the amount of movement of the input element is above a threshold is indicative of a scroll operation on the first user interface, that indication is overridden when the duration of the selection input is above a time threshold, since a long selection input indicates that a virtual object is being selected. In some embodiment, the duration of the selection input refers to the duration before of the movement of the input element begins to when the selection input is detected as being terminated. Optionally, the duration refers to the time after the movement of the input element end and the selection input is detected as being terminated. Optionally, the duration of the selection input is independent of when the movement of the input element happens. Allowing an object to be selected when a duration of a selection input is greater than a time threshold even if the amount of movement of the input element is above a threshold amount of movement, minimizes errors associated with erroneous selection of a virtual object and/or erroneous scrolling of the first user interface and reduces the amount of inputs required to interact with a virtual object or user interface in the three-dimensional environment thereby conserving computer resources associated with the additional inputs including but not limited to processing resources and/or battery resources.

In some embodiments, in accordance with a determination that the amount of movement is a first amount of movement, the threshold amount of time is a first threshold amount of time. In some embodiments, in accordance with a determination that the amount of movement is a second amount of movement, different from the first amount of movement, the threshold amount of time is a second threshold amount of time, different from the first threshold amount of time, such as illustrated by the comparison of threshold 1228 in response to varying levels of the magnitude of pre-selection movement 1216 in FIGS. 12O-12P. In some embodiments, the first threshold amount of time is based on the amount of movement of the input element prior to detection of the first input and/or prior to detection of the selection input. For instance, the relationship between the first threshold amount of time and the first amount of movement is positively correlated, such that an increased amount of movement yields a higher first threshold amount of time. Alternatively, the relationship between the first threshold amount of time and the first amount of movement is negatively correlated, such that an increased amount of movement yields a lower first threshold amount of time. In some embodiments, example values of the threshold amount of time are from 0 seconds to 0.01, 0.05, 0.1, 0.5, 1, 2, 5, or 10 seconds, and the computer system selects from amongst such values (or, optionally, an intermediate value between two of these values) for the threshold amount of time based on the movement of the input element, as described above with respect to positive and negative correlation. In some embodiments, the computer system determines the amount of hand movement and then compares the duration of the first input to a threshold amount of time that is determined in response to the determination of the amount of hand movement. Allow the threshold amount of time to be based on the detected amount of movement of the first input, minimizes errors associated with erroneous selection of a virtual object and/or erroneous scrolling of the first user interface and reduces the amount of inputs required to interact with a virtual object or user interface in the three-dimensional environment thereby conserving computer resources associated with the additional inputs including but not limited to processing resources and/or battery resources.

It should be understood that the particular order in which the operations in method 1300 have been described is merely exemplary and is not intended to indicate that the described order is the only order in which the operations could be performed. One of ordinary skill in the art would recognize various ways to reorder the operations described herein. In some embodiments, aspects/operations of method 1300 may be interchanged, substituted, and/or added between these methods. For example, various object manipulation techniques and/or object movement techniques of method 1300 is optionally interchanged, substituted, and/or added between these methods. For brevity, these details are not repeated here.

In some embodiments, aspects/operations of methods 700, 900, 1100, and/or 1300 may be interchanged, substituted, and/or added between these methods. For example, the virtual objects of methods 700, 900, 1100, and/or 1300, the three-dimensional environments of methods 700, 900, 1100, and/or 1300, the scrolling of user interfaces of methods 700, 900, 1100, and/or 1300, the selection inputs of methods 1100 and 1300, and/or the selection and moving of virtual objects of methods 700, 900, 1100, and/or 1300, are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1.-43. (canceled)

44. A method comprising:
at a computer system in communication with one or more display generation components and one or more input devices:
while displaying, via the one or more display generation components, a first virtual object in a first user interface, wherein the first user interface is scrollable, detecting, via the one or more input devices, a first input including a selection input corresponding to an input element; and
in response to detecting the first input:
in accordance with a determination that one or more criteria are satisfied, including a criterion that is satisfied when an amount of movement of the input element prior to detecting the selection input is above a first threshold amount of movement, performing a scroll operation in the first user interface; and
in accordance with a determination that the one or more criteria are not satisfied because the selection input is detected without detecting more than the first threshold amount of movement prior to detecting the selection input, performing a respective operation, different from the scrolling operation, corresponding to selection of the first virtual object.

45. The method of claim 44, further comprising:
while displaying, via the one or more display generation components, a second virtual object in the first user interface, detecting, via the one or more input devices, a second input including a second selection input corresponding to the input element; and
in response to detecting the second selection input: in accordance with a determination that one or more criteria are satisfied, including a criterion that is satisfied when an amount of movement of the input element prior to detecting the second selection input is above the first threshold amount of movement, performing a scroll operation in the first user interface; and
in accordance with a determination that the one or more criteria are not satisfied, performing a second respective operation, different than the respective operation, corresponding to selection of the second virtual object.

46. The method of claim 44, wherein the respective operation corresponding to selection of the first virtual object includes performing an operation in response to selection of the first virtual object.

47. The method of claim 44, wherein the respective operation includes modifying a selection state of the first virtual object.

48. The method of claim 44, wherein the respective operation includes resizing the first virtual object.

49. The method of claim 44, wherein the respective operation includes performing a grabbing operation directed to the first virtual object.

50. The method of claim 49, the method further comprising:
in response to the first input:
in accordance with detecting movement of the input element after the selection input in the first input:
in accordance with the determination that the one or more criteria are satisfied, performing the scroll operation in the first user interface in accordance with the movement of the input element after the selection input;
in accordance with the determination that the one or more criteria are not satisfied, moving the first virtual object within a three-dimensional environment in accordance with the movement of the input element after the selection input.

51. The method of claim 44, wherein the one or more criteria include a criterion that is satisfied when a duration of the selection input is less than a first time threshold, and wherein the method further comprises:
in response to detecting the first input:
in accordance with a determination that the one or more criteria are not satisfied because the duration of the selection input is greater than the first time threshold while the amount of movement of the input element is above the first threshold amount of movement, moving the first virtual object within a three-dimensional environment in accordance with the movement of the input element after the selection input.

52. The method of claim 51, wherein the one or more criteria include a criterion that is satisfied when the duration of the selection input is less than the first time threshold while the amount of movement of the input element is above the first threshold amount of movement.

53. The method of claim 44, wherein
in accordance with a determination that a velocity of the input element prior to detecting the first input is a first velocity, the first threshold amount of movement is a first respective threshold; and
in accordance with a determination that the velocity of the input element prior to detecting the first input is a second velocity, different from the first velocity, the first threshold amount of movement is a second respective threshold, different from the first respective threshold.

54. The method of claim 44, wherein the amount of movement of the input element prior to detecting the selection input includes an acceleration of the input element prior to detecting the selection input, and wherein the first threshold amount of movement corresponds to a first acceleration threshold.

55. The method of claim 54, wherein the determination that the one or more criteria are satisfied includes a determination that the acceleration of the input element was positive prior to detecting the selection input.

56. The method of claim 54, wherein the determination that the one or more criteria are satisfied includes a determination that the acceleration of the input element was positive prior to detecting the selection input, and wherein the method further comprises:
in accordance with a determination that the one or more criteria are not satisfied because the acceleration of the input element was negative prior to detecting the selection input, performing the respective operation, different from the scrolling operation, corresponding to selection of the first virtual object.

57. The method of any one of claim 44, wherein the one or more criteria include a criterion that is satisfied when a duration of the selection input is shorter than a threshold amount of time, and wherein the method further comprises:
in response to detecting the first input:
in accordance with a determination that the one or more criteria are not satisfied because the amount of movement of the input element prior to detecting the selection input is above the first threshold amount of movement and the duration of the selection input is greater than the threshold amount of time, performing the respective operation corresponding to selection of the first virtual object.

58. The method of claim 57, wherein:
in accordance with a determination that the amount of movement is a first amount of movement, the threshold amount of time is a first threshold amount of time; and
in accordance with a determination that the amount of movement is a second amount of movement, different from the first amount of movement, the threshold amount of time is a second threshold amount of time, different from the first threshold amount of time.

59. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while displaying, via the one or more display generation components, a first virtual object in a first user interface, wherein the first user interface is scrollable, detecting, via the one or more input devices, a first input including a selection input corresponding to an input element; and
in response to detecting the first input:
in accordance with a determination that one or more criteria are satisfied, including a criterion that is satisfied when an amount of movement of the input element prior to detecting the selection input is above a first threshold amount of movement, performing a scroll operation in the first user interface; and
in accordance with a determination that the one or more criteria are not satisfied because the selection input is detected without detecting more than the first threshold amount of movement prior to detecting the selection input, performing a respective operation, different from the scrolling operation, corresponding to selection of the first virtual object.

60. A non-transitory computer readable storage medium storing one or more programs, the one or more programs comprising instructions, which when executed by one or more processors of a computer system that is in communication with a display generation component and one or more input devices, cause the computer system to perform a method comprising:
while displaying, via the one or more display generation components, a first virtual object in a first user interface, wherein the first user interface is scrollable, detecting, via the one or more input devices, a first input including a selection input corresponding to an input element; and
in response to detecting the first input:
in accordance with a determination that one or more criteria are satisfied, including a criterion that is satisfied when an amount of movement of the input element prior to detecting the selection input is above a first threshold amount of movement, performing a scroll operation in the first user interface; and
in accordance with a determination that the one or more criteria are not satisfied because the selection input is detected without detecting more than the first threshold amount of movement prior to detecting the selection input, performing a respective operation, different from the scrolling operation, corresponding to selection of the first virtual object.
